(19) United States
(12) Patent Application Publication
(10) Pub. No.: US 2009/0025887 A1
(43) Pub. Date: Jan. 29, 2009

(54) MOVABLE AWNING DEVICE AND WINDING ROLLER FOR PROJECTED CORNER CANVAS

(76) Inventor: Osamu Ito, Nagoya-shi (JP)

Correspondence Address: CANTOR COLBURN, LLP, 20 Church Street, 22nd Floor, Hartford, CT, 06103, US

(21) Appl. No.: 12/100,464

(22) Filed: Apr. 10, 2008

Related U.S. Application Data
(63) Continuation-in-part of application No. PCT/JP2005/018997, filed on Oct. 11, 2005.

(51) Int. Cl. E04F 10/06; E06B 9/08

(52) U.S. Cl. 160/25; 160/85

(57) ABSTRACT

A movable awning device where a slider which allows a spread projected corner canvas to freely slide transversely is incorporated in a winding roller for a projected corner canvas, and the front bar of the projected corner canvas is supportedly engaged in a transverse guide rail which moves in parallel by means of foldable arms or the front bar of a rectangular awning which moves in parallel in the same manner is provided. As a result, the appearance of the outside of a building which includes a corner space portion in a projected corner portion can be greatly enhanced.

### CROSS REFERENCE TO RELATED APPLICATIONS

This is a Continuation-In-Part Application of International Application No. PCT/JP2005/018997, filed on 11 Oct. 2005, the disclosure of which is incorporated herein by reference in its entirety.

### TECHNICAL FIELD

The present invention relates to a single and complex type movable awning devices having a transversely sliding structure of a projected corner canvas and a winding roller for a projected corner canvas which forms the main portion of the movable awning device. The movable awning devices and the winding roller are used to cover a corner space portion of a projected corner portion of various types of buildings and the outside of buildings having a projected corner portion and a recessed corner portion which include such a corner space portion so as to provide a good appearance.

### BACKGROUND OF THE INVENTION

Conventional movable awning devices wind and unwind a rectangular canvas which generally spreads to the front and diagonally downward around a winding roller supported with a bearing in a portion close to the wall of the building by means of a manually operable handle or an electric motor, etc. A front bar to which the bottom hem of the above described canvas is attached is supported in such a manner as to extend in a tense state by means of arms which are foldable in two or y-shaped arms in a y shape which are freely foldable in the approximate horizontal direction (foldable arm type), or the two end portions of the front bar of the spread rectangular canvas which are supported by means of folding arms which can be operated to rise and lower in an approximate vertical direction or expandable links having a pantograph structure (lateral arm type). Many of these are provided as a sun shield or rain shield around the outer periphery of terraces and shops, or portions for decorating buildings and shops (see for example the following Non-Patent Documents 1 and 2, hereinafter referred to as “the former”).

Meanwhile, conventional movable awning devices having the following configurations (a) to (d) have been proposed in order to cover corner space portions of projected corner portions of buildings (see for example the following Patent Document 1, hereinafter referred to as “the latter”).

(a) An awning support frame in which the entirety of the device is incorporated is supported by a fixed bracket in a corner end portion so as to be projected diagonally to the front, and two winding rollers for winding or unwinding a canvas by means of an electric motor in an approximate right angled triangle form along the long side are supported with a bearing in the two end portions, front and rear, of the awning support frame.

(b) In addition, the base portion of the folding arm which is pressed in the direction which it extends is attached to a portion in the vicinity of the middle of the base pipe and the top hem of the triangular canvas is attached to the arm holder in the front end portion.

(c) A cosmetic panel is also provided in the front end portion of the awning support frame so as to be freely spreadable, and an arm holder is supported in such a manner as to be freely slidable along a trench in a rear portion of this cosmetic panel.

(d) Furthermore, a portion close to the front end of the awning support frame is hung and supported by a wire rope and lifted upward to the rear of a corner end portion by means of a winding machine so that the entirety of the device is stored in an upside-down state.

### LIST OF DOCUMENT INFORMATION ON PRIOR ART

Patent Document 1: Japanese Examined Utility Model Publication No. H4

Patent Document 2: Japanese Unexamined Patent Publication No. 2002-356969

Non-Patent Document 1: “Awning Sales Manual,” Japan Awning Association, January 2004, pp. 9-15

Non-Patent Document 2: “Awning-Sunshield-Japan Awning Association-JAA” [online], Japan Awning Association, searched on the Internet, Aug. 17, 2004<URL: http//www.awning.org/index.html>

### DISCLOSURE OF THE INVENTION

### Problem to be Solved by the Invention

The former awning devices are used in linear sections around the outside of buildings, and cannot cover corner space portions of projected corner portions. In the case where these awning devices are used to cover such portions, the winding roller is attached so as to protrude from the projected corner portion to the corner space portion.

In many cases, projected corner portions of a building face a sidewalk or a street in two directions, or an intersection, and thus are located in such a place as to be seen by the general public. Such places are blessed with good business conditions for shops and provide excellent effects for advertisement.

In the case where an awning device which is incorporated in such a conspicuous place must wind a rectangular canvas in such a state as to be projected from the projected corner portion and stored, the awning device is technically uninteresting, and the appearance is not good.

Meanwhile, in the latter awning device, a triangular canvas which spreads in a corner space portion is supported at one end by a corner end portion of a projected corner portion, and therefore, the load of the entirety of the device is concentrated on the fixed bracket, which is projected to the corner end portion. In addition, the awning support frame is hung by a wire rope, and therefore, the entirety of the device easily moves to the left and right when the canvas is spread, in particular, the system is easily subjected to the effects of wind, and thus unstable. In addition, the entirety of the device is hung by a wire rope and pulled up to the corner end portion so as to be stored upside-down in a vertical position, and therefore, there is a concern that the device might fall on somebody's head, taking in the possibility of the wire rope deteriorating into consideration. In addition, the rear of the whole device is exposed to the surface of the corner end portion at the time of upside-down storage, and thus, the appearance at the time of storage is poor.

Therefore, the present inventors have proposed a foldable arm type and a single type movable awning device where a corner canvas in a projected corner portion (hereinafter referred to as projected corner canvas) is pushed out diagonally forward and in parallel to the corner space portion so as to spread while being unwound, or conversely, the spread projected corner canvas is drawn in diagonally backward and in parallel so as to be wound and stored while being wound, and thus, the above described technical problems can be addressed (see International Patent Application 1 below).

In addition, the inventors have proposed a foldable arm type and a complex type movable awning device gained by further developing and technically improving the above described prior art invention, and furthermore, it is made possible for the projected corner portion of a building and a linear section adjacent to the projected corner portion, a projected corner portion and a recessed corner portion, or the outside of a building, including two projected corner portions, to be efficiently covered with a projected corner canvas, a rectangular canvas and a recessed corner canvas, so that a better appearance can be provided (see International Patent Application 2 below).

### LIST OF PRIOR ART APPLICATIONS

International Patent Application 1: PCT/JP2004/9751 (Jan. 7, 2004)

International Patent Application 2: PCT/JP2005/4843 (Oct. 3, 2005)

Different ideas from those for the above described single type and complex type movable awning devices are provided, and the present invention provides a single type and a complex type movable awning device having a transversely slidable structure where a projected corner canvas that has been spread to the front from a portion close to a wall moves forward so as to be projected in a corner space portion and moves backward, and then is wound and stored when the canvas is stored.

In addition, a winding roller for a projected corner canvas which forms a main portion of the movable awning device and is useful as a compatible single product is also provided.

In addition, an accompanying device for addressing various related technical problems which might arise in order to implement the present invention is also provided.

In the following, single types are referred to as single device or single awning device, and complex types are referred to as complex device or complex awning device.

Here, an embodiment is disclosed under an idea where conventional independent movable tent devices where a beam crosses at the top end of a pole which stands vertically and folding arms for spreading a rectangular canvas of a wedged roof type are provided in the two side portions of the beam are formed as an awning device having a sliding structure, and the entirety of the movable tent moves transversely along the above described beam, and thus, the range of the sun shield can be freely changed (see for example the above described Patent Document 2).

However, no relevance in a specific structure which might solve the above described problems of the present invention can be found in the above configuration, and in addition, there are no perceptions that a corner space portion of a building should be covered so as to provide a good appearance.

### Means for Solving Problem

An invention concerning single type movable awning devices S1a to S1d (hereinafter referred to as first invention) as well as the effects thereof are described in the following.

The first invention is characterized by being formed in such a manner that (1) a slider 12 which makes a spread projected corner canvas G1 or G2 become transversely and freely slidable is supportedly inserted into winding roller J1 to J7 for winding or unwinding the projected corner canvas G1 or G2, the front bar F1 of the above described projected corner canvas G1 or G2 is supportedly inserted into a transverse guide rail R1 so that the guide rail R1 can move in parallel by means of foldable arms V1 and V2, Y1 and Y2, or I1 and I2.

As a result, the corner space portion in the projected corner portion N1 can be covered so as to provide a good appearance, or the canvas can be stored compactly without protruding from the projected corner portion N1 and with good appearance in the vicinity of the corner.

In addition, during the process of operation according to the first invention, (2) the projected corner canvas G1 or G2 that has been wound around a winding roller J1 to J7 is unwound so as to spread, and after that transversely slid along the winding roller J1 to J7 and the transverse guide rail R1 so as to be projected in the corner space portion.

Conversely, (3) the projected corner canvas G1 or G2 which is projected in the corner space portion may be transversely slid to the rear along the winding roller J1 to J7 and the transverse guide rail R1 while keeping the canvas in a spread state, and after that wound around the winding roller J1 to J7.

The above described (2) and (3) allow the projected corner canvas G1 or G2 which is projected in the space portion to move forward to the corner space portion or move backward stably, smoothly and without fail.

Thus, various dependent inventions in terms of the concrete configuration of the first invention are listed in the following. Here, the symbols attached at the end of each item within brackets indicate the disclosed embodiment and a single device or a complex device in the drawings.

(4) The foldable arms are V-shaped arms in V shape V1 and V2 which have such connections so as to be freely foldable in two, and the base portions of the arms V1 and V2 are attached to lower portions in the vicinity of the front end of the winding roller J1 to J8 and in the vicinity of the middle of the winding rollers J1 to J8, and the front end portions of the arms are attached to portions in the vicinity of the two ends, front and rear, of the transverse guide rail R1 (S1a).
(5) A synchronizing belt 391 runs between a front end portion of the winding roller J1 to J8 and a front end portion of the transverse guide rail R1 so that the synchronizing belt 391 and the projected corner canvas G1 or G2 are wound or unwound around the above described winding roller J1 to J8 (S1b).

As a result, the projected corner canvas G1 or R2 can be wound or unwound with good balance.

(6) The folding arms are Y-shaped arms Y1 and Y2 formed of a main link 291 and a sub-link 292 linked in reverse y shape, and front end portions of the above described sub-links 292 are attached to portions in the vicinity of the two ends, front and rear, of the transverse guide rail R1, while front end portions of the main links 291 are supported in such a manner so as to be freely slidable along the guide rail R1 (S1c).
(7) The V-shaped arm V1 in the front end portion of the device, from among the V-shaped arms V1 and V2, is replaced with a Y-shaped arm Y1 formed of a main link 291 and a sub-link 292 linked in a reverse y shape, the front end portion of the above described sub-link 292 is attached to a portion in the vicinity of the front end of the transverse guide rail R1, while the front end portion of the main link 291 is supported in such a manner as to be freely slidable along the transverse guide rail R1 (S1c).
(8) The folding arms are I-shaped arms I1 and I1 in the form of a straight line which are formed in parallel at a distance from each other in such a manner that the base portion of one I-shaped arm I1 is attached to a portion in the vicinity of the corner of the projected corner portion N1 and a front end portion of the arm is attached to a portion in the vicinity of the middle of the transverse guide rail R1, while the base portion of the other I-shaped arm I2 is attached to a portion in the vicinity of the middle at an appropriate distance from a portion in the vicinity of the above described corner, and the front end portion is attached to a portion in the vicinity of the rear of the transverse guide rail R1, and the I-shaped arms I1 and I2 are constructed so as to make the transverse guide Rail R1 freely move in parallel in a diagonal direction (S1d).

In addition, dependent inventions according to which the front bar F1 of the projected corner canvas G1 or G2 is smoothly and transversely slid are listed in the following.

(9) The front bar F1 of the projected corner canvas G1 or G2 is supportedly inserted into the transverse guide rail R1 so as to be freely rotatable.
(10) The transverse guide rail R1 is made of a rear plate portion 231 and a rail portion 232 which protrudes to the front from the rear plate portion, and small wheels 234 and 235 are attached in locations above and below the rail portion 232 at a distance from each other.
(11) Two single type movable awning devices S1a to S1d are attached to two corner portions in a projected corner portion N1 in such a manner as to face each other, a top hem 1 and a bottom hem 2 of the projected corner canvas G1 in trapezoid form with approximately right angles are respectively attached to the winding roller J1 to J7 and the front bar F1, and a connection member, such as a wire 193 or 194, and a belt runs between the top hem 1 and the bottom hem 2.

As a result, the appearance of the outside of a building including a corner space portion in the projected corner portion N1 is covered and provided with a good appearance, and in addition, the canvas can be stored in the wall compactly in the corner portion without being projected from the projected corner portion.

(12) A manually operable device and a gear device for linking two winding rollers J1 to J8 are incorporated into corner portions where the front end portions of the winding rollers J1 to J8 face each other.

As a result, the operation of the two projected corner canvases G1 and G2 can be linked, so that one electrically-driven device becomes unnecessary, and the manually operable device can be simplified.

Next, dependent inventions in the case where a movable awning device Q for a rectangular canvas P1 is combined with the single devices S1a to S1d according to the first invention are listed.

(13) When a winding roller 30 for winding or unwinding a rectangular canvas P1, a front bar 31 for attaching the bottom hem 6 of the rectangular canvas P1 and a movable awning device Q made of foldable arms V3 and V4 for supporting the front bar 31 so that the front bar moves in parallel are combined with the single type movable awning device S1a to S1d, the invention is characterized in that a front half portion of the winding roller 30 for a rectangular canvas P1 overlaps with the rear half portion of the winding roller J1 to J8 for a projected corner canvas G1 or G2 in the up-down direction at a distance from each other.

As a result, a corner space portion in a projected corner portion N1 and the outside of the straight line section which continues to the corner space portion can be covered as if they were integrated with a good appearance.

(14) The projected corner canvas G1 or G2 is wound by one winding roller J1 to J8 from below, and the rectangular canvas P1 is wound around the other winding roller 30 from above.
(15) The projected corner canvas G1 or G2 is wound by one winding roller J1 to J8 from above, and the rectangular canvas P1 is wound around the other winding roller 30 from below.

Measures are taken in the above described (14) and (15) so that the step in the vicinity of the border between the two spread canvases G1 and P1 is as inconspicuous as possible.

The invention concerning a complex device in the first group (hereinafter referred to as second invention) and the effects thereof are described in the following.

The second invention provides (16) a movable awning device where an awning device S1 or S2 for a projected corner having a winding device for winding or unwinding a projected corner canvas G1 or G2 and a rectangular awning device Q1 or Q2 having a winding device for winding or unwinding a rectangular canvas P1 or P2 are combined, and the invention is characterized in that a winding roller J1 to J7 for a projected corner canvas G1 or G2 and a front bar F2 or F3 are provided in the above described awning device S1 or S2 for a projected corner. A slider 12 for transversely and freely sliding the spread projected corner canvas G1 or G2 transversely in the direction of the axial line is supportedly inserted into the winding roller J1 to J7, the above described rectangular awning device Q1 or Q2 is provided with a winding roller 30 or 30a for a rectangular canvas P1 or P2 and a front bar R2 or R3, the front bar R2 or R3 is supported by foldable arms V1 and V2, Y1 and Y2, Z1 and Z2 or Z3 and Z4, and the front bar F2 or F3 for the above described projected corner canvas G1 or G2 is supportedly inserted into the front bar.

As a result, a corner space portion in the projected corner portion N1 and the outer periphery of a building, including a straight line section which continues to the corner space portion is integrally covered so as to provide a good appearance.

In addition, during the process of operation of the second invention, (17) a projected corner canvas G1 or G2 and a rectangular canvas P1 or P2 which are respectively wound around the winding roller J1 to J7 for a projected corner canvas G1 or G2 and around the winding roller 30 or 30a for a rectangular canvas P1 or P2 are unwound in sync so that the canvases spread, and thus, the spread projected corner canvas G1 or G2 is transversely slid along the winding roller J1 to J7 and the front bar R2 or R3 so as to be projected in the corner space portion.

In contrast, (18) the projected corner canvas G1 or G2 that has been projected in the corner space portion is transversely slid to the rear along the winding roller J1 to J7 and the front bar R2 or R3 while the projected corner canvas is kept in a spread state, and after that, the projected corner canvas G1 or G2 and the rectangular canvas P1 or P2 are respectively wound around the winding roller J1 to J7 and 30 or 30a in sync so as to be stored.

It can be understood from the above described (17) and (18) that the operation of spreading the projected corner canvas G1 or G2 and the rectangular canvas P1 or P2 and the forward movement of the spread projected corner canvas G1 or G2 to the corner space portion are carried out oppositely and the receding movement of the projected corner canvas G1 or G2 that is projected in the corner space portion and the operation for winding the two canvases G1 or G2 and P1 or P2 is carried out smoothly.

Thus, various dependent inventions concerning the concrete configuration of the second invention are listed in the following.

(19) The rear half portion of the winding roller J1 to J8 for the projected corner canvas G1 or G2 and a front half portion of the winding roller 30 for a rectangular canvas P1 are supported in such a manner as to overlap in the up-down direction at a distance from each other, the front bar R2 or R3 of the rectangular canvas P1 is formed so as to have approximately the same length as the distance between a portion in the vicinity of the front end of one winding roller J1 to J7 and a portion in the vicinity of the rear end of the other winding roller 30, the base portions of the V-shaped arms V1 and V2 have such connections so as to be freely foldable in two are attached to portions in the vicinity of the front end of the above described winding roller J1 to J7 and in the vicinity of the rear end of the winding roller 30, and the front end portions of the V-shaped arms V1 and V2 are attached to portions in the vicinity of the two ends, front and rear, of the above described front bar R2 or R3 (SQII1·2·5).
(20) A synchronizing belt 391 runs between a front end portion of the winding roller J1 to J8 and the front end portion of the front bar R2 or R3 so that the synchronizing belt 391 and the projected corner canvas G1 or G2 are wound and unwound around the above described winding roller J1 to J7 (SQII2).
(21) The winding roller for the rectangular canvas P1 is a long winding roller 30a which extends from the rear portion of the device to a portion in the vicinity of the front end of the winding roller J1 to J8 and a synchronizing belt 393 runs between the front end portion of the winding roller 30a and the front end portion of the front bar R2 or R3 of the rectangular canvas P1, and thus, the synchronizing belt 393 is wound or unwound around the front end portion of the winding roller 30a (SQII3).

It can be understood from the above described (20) and (21) that an imbalanced load can be prevented from being applied when the projected corner canvas G1 and the rectangular canvas P1 are wound or unwound, and thus, the front bar F2 or R2 smoothly moves in parallel with good balance.

(22) The winding roller J1 to J7 for the projected corner canvas G1 or G2 and the winding roller 30a for the rectangular canvas P2 which extends to a portion in the vicinity of the front end of the winding roller J1 to J7 are supported in such a manner as to overlap in the up-down direction at a distance from each other, the front bar R2 or R3 of the rectangular canvas P2 is formed so as to have approximately the same length as the distance between a portion in the vicinity of the front end of one winding roller J1 to J7 and a portion in the vicinity of the rear end of the other winding roller 30a, a long rectangular canvas P2 runs between the above described long winding roller 30a and the front bar R2 or R3, the base portions of the V-shaped arms V1 and V2 having such connections so as to be freely foldable in two are attached in the vicinity of the front end of the above described winding roller J1 to J7 and a portion in the vicinity of the rear end of the winding roller 30a, and the front end portions of the arms V1 and V2 are attached to portions in the vicinity of the two ends, front and rear, of the above described front bars R2 and R3 (SQII4·SQII6 to 8).
(23) The foldable arms are Y-shaped arms Y1 and Y2 formed of a main link 291 and a sub-link 292 linked in a reverse y shape, the front end portion of the above described sub-link 292 is attached in the vicinity of the two ends, front and rear, of the front bar R2 or R3, and the front end portion of the above described main link 291 is supported in such a manner so as to be freely slidable along the front bars R2 and R3 (SQII9).
(24) The V-shaped arm V1 of the front end portion of the device, from among the V-shaped arms V1 and V2, is replaced with a Y-shaped arm Y1 formed of a main link 291 and a sub-link 292 linked in a reverse y shape, and the front end portion of the above described sub-link 292 is attached to a portion in the vicinity of the two ends, front and rear, of the front bar R2 or R3 so that the front end portion of the above described main link 291 is supported in such a manner as to be freely slidable along the front bars R2 and R3 (SQII1to8).

It can be understood from the above described (23) and (24) that the effects of preventing movement of the parallel moving front bar R2 or R3 increase and the spread projected corner canvas G1 or G2 moves backward smoothly.

Here, dependent inventions in the case where a lateral arm type is used instead of a foldable arm type are listed.

(25) Foldable arms for supporting the front bar R2 or R3 of the rectangular canvas P1 or P2 are used as extending arms Z1 and Z2 which rise and lower in the vertical direction or pushing arms (SQL1).
(26) Foldable arms for supporting the front bar R2 or R3 of the rectangular canvas P1 or P2 are extending links Z3 and Z4 having a pantograph structure for pulling out the foldable arms for supporting the front bar R2 or R3 of the rectangular canvas P1 or P2 to the front or pushing down the foldable arms to the rear (SQL2).

Thus, measures are taken to convert the lateral arm type to a complex awning device.

The invention concerning a complex device in the second group (hereinafter referred to as third invention) and the effects thereof are described below.

The third invention provides (27) a movable awning device where the rectangular awning device Q1 or Q2 described in the above (16) is replaced with an awning device U1 or U2 for a recessed corner having a winding device for winding or unwinding the recessed corner canvas P3 or P4, characterized in that

the awning device U1 or U2 for a recessed corner is provided with a winding roller 30 or 30a for a recessed corner canvas P3 or P4 and a front bar R2 or R3, the front bar R2 or R3 is supported in such a manner so as to be freely move in parallel by means of foldable arms V1 and V2 or Y1 and Y2, and the front bar F2 or F3 of the projected corner canvas G1 or G2 is supportedly inserted into the front bar R2 or R3.

As a result, the outer periphery of a building between a corner space portion in a projected corner portion N1 and a corner space portion in a recessed corner portion L are integrally covered so as to provide a good appearance, and the canvas is compactly stored in a wall without protruding from the projected corner portion N1 at the time of storage.

In addition, during the process of operation according to the third invention, (28) the projected corner canvas G1 or G2 and the recessed corner canvas P3 or P4 that have been respectively wound around the winding roller J1 to J7 for the projected corner canvas G1 or G2 and around the winding roller 30 or 30a for the recessed corner canvas P3 or P4 are unwound in sync so that the canvases are spread, and the spread projected corner canvas G1 or G2 is transversely slid along the winding roller J1 to J7 and the front bar R2, R3 or R5, and thus, the projected corner canvas is projected in the corner space portion in the projected corner portion N1.

In contrast, (29) the projected corner canvas G1 or G2 that has been projected in a corner space portion in the projected corner portion N1 is transversely slid to the rear along the winding roller J1 to J7 and the front bar R2 or R3 while keeping the projected corner canvas in a spread state, and after that, the projected corner canvas G1 or G2 and the recessed corner canvas P3 or P4 are wound around the winding rollers J1 to J7 and 30 or 30a, respectively, in sync so as to be stored.

It can be seen from the above described (28) and (29) that the operation of spreading the projected corner canvas G1 or G2 and the recessed corner canvas P3 or P4 and the forward movement of the spread projected corner canvas G1 or G2 toward the corner space portion are carried out oppositely and the backward movement of the projected corner canvas G1 or G2 that has been projected in the corner space portion and the operation of winding the two canvases G1 or G2 and P3 or P4 are smoothly carried out.

Thus, independent inventions having concrete configurations according to the third invention are listed below.

(30) The rear half portion of the winding roller J1 to J7 for the projected corner canvas G1 or G2 and the front half portion of the winding roller 30 for the recessed corner canvas P3 are supported in such a manner as to overlap in the up-down direction at a distance from each other, the front bar R2 or R3 of the recessed corner canvas P3 is formed so as to have approximately the same length as the distance between portions in the vicinity of the front end of one winding roller J1 to J7 and in the vicinity of the middle of the other winding roller 30, base portions of the V-shaped arms V1 and V2 have such connections so as to be freely foldable in two are attached to portions in the vicinity of the front end of the above described winding roller J1 to J7 and in the vicinity of the middle of the winding roller 30, and the front end portions of the arms V1 and V2 are attached to portions in the vicinity of the two ends, front and rear, of the above described front bar R2 or R3 (SUII1).
(31) The winding roller J1 to J7 for the projected corner canvas G1 or G2 and the winding roller 30a for the recessed corner canvas P4 which extends to a portion in the vicinity of the front end of the winding roller J1 to J7 are supported in such a manner so as to overlap at a distance from each other in the up-down direction, the front bar R2 or R3 of the recessed corner canvas P3 is formed so as to have approximately the same length as the distance between a portion in the vicinity of the front end of one winding roller J1 to J7 and a portion in the vicinity of the middle of the other winding roller 30a, a long recessed corner canvas P2 runs between the above described winding roller 30a and the front bar R2 or R3, base portions of the V-shaped arms V1 and V2 having such connections so as to be freely foldable in two are attached to portions in the vicinity of the front end of said winding roller J1 to J7 and in the vicinity of the middle of the winding roller 30, and the front end portions of the arms V1 and V2 are attached to portions in the vicinity of the two ends, front and rear, of above described front bar R2 or R3 (SUII2).

The invention concerning a complex device in the third group (hereinafter referred to as fourth invention) and the effects thereof are described below.

The fourth invention provides (32) a movable awning device where a rectangular awning device Q1 or Q2 having a winding device for winding or unwinding a rectangular canvas P1 or P2 and two awning devices S1 or S2 and S11 for a projected corner having a winding device for winding or unwinding a projected corner canvas G1 or G2 are combined in front-rear symmetry, so that the two awning devices for a projected corner are located on the two sides, front and rear, of the rectangular awning device Q1 or Q2, characterized in that

the above described awning devices S1 or S2 and S11 for a projected corner are respectively provided with a winding roller J1 to J7 for a projected corner canvas G1 or G2 and a front bar F2 or F3, a slider 12 for transversely and freely sliding a spread projected corner canvas G1 or G2 in the direction of the axial line is incorporated in the winding roller J1 to J7, the above described rectangular awning device Q1 or Q2 is provided with a winding roller 30 or 30a for a rectangular canvas P1 or P2 and a front bar R2 or R3, the front bar R2 or R3 is supported in such a manner as to be freely move in parallel in the front-rear direction by means of foldable arms V1 to V4 or Y1 and Y4, and the front bar F2 or F3 for a projected corner canvas G1 or G2 is supportedly inserted into portions on the two sides, front and rear, of the front bar R2 or R3.

As a result, the outer periphery of the building having projected corner portions N1 and N2 at the two ends, front and rear, and a straight line section having an appropriate length between the projected corner portions N1 and N2 are integrally covered so as to provide a good appearance.

In addition, during the process of operation of the fourth invention, (33) the projected corner canvas G1 or G2 and the rectangular canvas P1 or P2 that have been respectively wound around the winding roller J1 to J7 for a projected corner canvas G1 or G2 and a winding roller 30 or 30a for a rectangular canvas P1 or P2 are unwound in sync so that the canvases are spread to the front, and the spread projected corner canvas G1 or G2 is transversely slid along the winding roller J1 to J7 and the front bar R2 or R3, and thus, the canvases are projected in a corner space portion in two projected corner portions N1 and N2.

In contrast, (34) the projected corner canvases G1 and G2 that have been projected in a corner space portion in the two projected corner portions N1 and N2 are transversely slid to portions in the vicinity of the center of the device along the winding roller J1 to J7 and the front bar R2 ad R3 while keeping the canvases in a spread state, and after that, the projected corner canvas G1 or G2 and the rectangular canvas P1 or P2, which are two canvases located in the front and in the rear, are wound around the respective winding rollers J1 to J7 and 30 or 30a in sync and stored.

It can be understood from the above (33) and (34) that the operation of spreading the projected corner canvases G1 and G2 located in the front and the rear and the rectangular canvas P1 or P2 in the middle portion, which are three canvases, and the movement of the spread projected corner canvases G1 and G2 to the two corner space portions are carried out oppositely and the movement of the two projected corner canvases G1 and G2 that have been projected in the corner space portions to the center of the device, and the operation of winding the three canvases in total, G1, G2 and P1 or P2, can be smoothly carried out.

Thus, dependent inventions having concrete configurations concerning the fourth invention are listed below.

(35) The winding rollers J1 to J7 for projected corner canvases G1 and G2 are attached in a location close to the corner of one projected corner portion N1 and a location close to the corner of the other projected corner portion N2 so that the backs of the winding rollers face each other, the two winding rollers J1 to J7 in the front and in the rear and the winding roller 30 or 30a for a rectangular canvas P1 or P2 are supported in such a manner as to overlap in the up-down direction at a distance from each other, the front bar R2 or R3 of the rectangular canvas P1 or P2 is formed so as to have approximately the same length as the distance between one projected corner portion N1 and the other projected corner portion N2, the base portions of V-shaped arms V1 to V4 having such connections so as to be freely foldable in two are respectively attached to portions in the vicinity of the front end and in the vicinity of the middle of one winding roller J1 to J7, and in the vicinity of the middle and in the vicinity of the rear end of the other winding roller J1 to J7, and the front end portions of the arms V1 to V4 are attached to portions in the vicinity of the two ends, front and rear, of the above described front bar R2 or R3 and a portion corresponding to a portion in the vicinity of the middle of the above described winding roller J1 to J7 (SQSIV1·2).
(36) At least the V-shaped arms V1 and V4 in the vicinity of the two ends, front and rear, from among the V-shaped arms V1 to V4, are replaced with Y-shaped arms Y1 and Y4 formed of a main link 291 and a sub-link 292 linked in a reverse y shape in such a manner that the front end portions of the respective sub-links 292 are attached to portions in the vicinity of the two ends, front and rear, of the front bar R2 or R3 of the rectangular canvas P1 or P2, and the front end portions of the respective main links 291 are attached to the two front bars F2 and F3 of the projected corner canvases G1 and G2 so as to be freely slidable.

The invention concerning a complex device in the fourth group (hereinafter referred to as the fifth invention) and the effects thereof are described below.

The fifth invention provides (37) a movable awning device where two awning devices S1 and S11 for a projected corner have a winding device for winding or unwinding a projected corner canvas G1 are combined in front-rear symmetry, characterized by being formed such that

the respective awning devices S1 and S11 for a projected corner are provided with a winding roller J1 to J7 for a projected corner canvas G1 and a front bar F2 or F3, a slider 12 for transversely and freely sliding the spread projected corner canvas G1 or G2 in the direction of the axial line is incorporated in the winding roller J1 to J7, the two respective front bars F2 and F3 of the above described projected corner canvas G1 are supportedly inserted in the transverse guide rail R4 so as to be freely slidable relative to the transverse guide rail R4, and the guide rail R4 moves in parallel in the front-rear direction by means of foldable arms V1 and V2 or Y1 and Y2.

As a result, the outside periphery of a building where the two end portions, front and rear, are projected corner portions N1 and N2 and the distance between them is a straight line section which is relatively short and can be integrally covered so as to provide a good appearance.

In addition, during the process of the operation of the fifth invention, (38) the projected corner canvas G1 that has been wound around the winding rollers J1 to J7 are unwound in sync and thus spread to the front, and the spread projected corner canvas G1 is transversely slid in the two directions, front and rear, along the winding roller J1 to J7 and the transverse guide rail R4, and thus, projected in corner space portions in the two projected corner portions N1 and N2.

In contrast, (39) the projected corner canvas G1 that has been projected in the corner space portions in the two projected corner portions N1 and N2 is transversely slid in different directions along the winding roller J1 to J7 and the transverse guide rail R4 while keeping the projected corner canvas in a spread state, and after that, wound around the respective winding rollers J1 to J7 in sync so as to be stored.

It can be seen from the above described (38) and (39) that the operation of spreading the two, front and rear, projected corner canvases G1 and G2 and the movement of the spread projected corner canvases G1 and G2 to the two corner space portions are carried out oppositely, and the relative movement of the two projected corner canvases G1 and G2 that have been projected in the corner space portions in different directions and the operation of winding the two canvases G1 and G2 are carried out smoothly.

Thus, the dependent inventions having a concrete configuration concerning the fifth invention are listed below.

(40) Two winding rollers J1 to J7 for a projected corner canvas G1 are supported in front-rear symmetry in the two projected corner portions N1 and N2 so as to overlap in the up-down direction at a distance away from each other, the base portions of V-shaped arms V1 and V2 having such connections so as to be freely foldable in two are respectively attached to portions in the vicinity of the front end of one winding roller J1 to J7 and in the vicinity of the rear end of the other winding roller J1 to J7, and the front end portions of the arms V1 to V4 are attached to the portions in the vicinity of the two sides, front and rear, of the transverse guide rail R4 (SSII).

Next, the dependent inventions concerning the slider 12 or 12a, which are incorporated in the winding roller J1 to J7 of the projected corner canvas G1 or G2, are listed.

(41) A slide guide trench 111 and a slide guide path 112 are created in the winding roller J1 to J7 in the direction of the axial line, and a slider 12 or 12a is supportedly inserted into the guide trench III and the guide path 112.
(42) A canvas engaging trench 121 for attaching a top hem 1 of a projected corner canvas G1 or G2 is created in the center protrusion of the slider 12 or 12a having a cross section in protrusion form, and wing plate portions 123, which are projected from portions on both sides of the slider 12 or 12a, are supportedly inserted into a side wall portion of the slide guide path 112.
(43) Wing plate portions 123 having a slit trench 122 are projected from portions on both sides of a slider 12 or 12a, small wheels 124 are engaged in the slit trenches 122 at appropriate intervals so as to be freely rotatable, and these small wheels 124 are engaged in the rail trenches 113 created in side wall portions of the slide guide path 112.

It can be seen from the above described (41) to (43) that smooth transverse sliding of the spread projected corner canvas G1 or G2 can be secured without fail.

In addition, the dependent inventions concerning a projected corner canvas G1 or G2, a winding roller J1 or J2 and other concrete configurations that form an awning device S1 or S2 for a projected corner in a single device S1a to S1d and a complex device according to the present invention are listed in the following.

(44) The projected corner canvas G1 is formed in trapezoid form having approximate right angles in a spread state made up of a main body portion X1 of a canvas in rectangular form and a projected portion X2 of a canvas which protrudes from one side, a top hem 1 of the projected corner canvas G1 is attached to the slider 12, and a bottom hem 2 of this canvas is attached to the front bar F1 to F3.
(45) A connection member, including a wire 193 or 194 or a belt, runs between the slider 12 and the front bar F1 to F3.
(46) The projected corner canvas G2 is formed in an approximate triangle form in a spread state, a connection wire 541 or 542 is inserted into a diagonal portion 3a or 3b of the triangular canvas G2 and the base portions of this wire are attached to the two end portions, front and rear, of a relatively short slider 12a, and the front end portion of the wire is attached to the front bar F2 or F3 in the vicinity of the end portion, front or rear, of the bottom hem 2a of the canvas.

It can be seen from the above described (44) to (46) that the corner space portion in the projected corner portion N1 is covered with the projected corner canvas G1 in trapezoid form having right angles and a projected corner canvas G2 in triangle form so as to provide a good appearance, and in addition, the projected corner canvas G1 or G2 can be effectively prevented from changing form within the plane when the canvas is wound and when the canvas is transversely slid. In addition, the projected corner canvas G1 or G2 is wound or unwound with good balance, and the spread projected corner canvas G1 or G2 is supported in a tense state.

Next, the means of substituting the slider 12 or 12a according to the present invention while having the same functions and a simplified configuration are listed.

(47) The slider 12 or 12a, to which a top hem 1 of the projected corner canvas G1 or G2 is attached, is replaced with a slide cap 12b which is engaged in the top hem 1 of the projected corner canvas G1 or G2.
(48) A slide guide trench III and a slide guide path 114 are created in the winding roller J8 into which a slide cap 12b is incorporated in the direction of the axial line, and the slide cap 12b is supportedly inserted into the guide trench 111 and the guide path 114.
(49) The projected corner canvas G1 is formed in trapezoid form having approximately right angles in a spread state made up of a main body portion X1 of the canvas in rectangular form and a projected portion X2 of the canvas which is projected from one side, and a connection member, including a wire 193 or 194 or a belt, runs between the slide cap 12b, which is engaged in the top hem 1 of the projected corner canvas G1, and the front bar F1 to F3, to which the bottom hem 2 of the projected corner canvas G1 is attached.
(50) The projected corner canvas G2 is formed in an approximate triangle form in a spread state, a connection wire 541 or 542 is inserted through the diagonal portion 3a or 3b of the triangular canvas G2, and base portions of this wire are attached to the two end portions, front and rear, of the slide cap 12b and the front end portion of the wire is attached to the front bar F2 or F3 in the vicinity of either end, front or rear, of the bottom hem 2a of the canvas.

In the cases of these configurations, as in the above described case, the corner space portion in the projected corner portion N1 is covered with a projected corner canvas G1 in a trapezoid form having right angles and a projected corner canvas G2 in triangle form so as to provide a good appearance, and in addition, the projected corner canvas G1 or G2 can be effectively prevented from changing form in the plane when the canvas is wound and when the canvas is transversely slid. In addition, the projected corner canvas G1 or G2 can be wound or unwound with good balance, and the spread projected corner canvas G1 or G2 is supported in a tense state.

(51) A bulk member of the main body of the roller 11 is attached to the winding roller J1 to J8 for the projected corner canvas G1 or G2.
(52) The bulk member is a bulk ring 331 in helix form, and the outer diameter of the ring increases step by step towards the front end portion of the roller or both end portions, front and rear, from a portion in the vicinity of the middle of the winding roller J1 to J8.
(53) A bulk cloth 32 is attached to the diagonal portion 3, 3a or 3b of the projected corner canvas G1 or G2.

It can be seen from the above described (51) to (53) that the projected corner canvas G1 in a trapezoid form having right angles and a triangular canvas G2 can be wound with good balance.

(54) A manually operable device or an electrically-driven device for winding or unwinding the projected corner canvas G1 or G2 is incorporated in the axial end portion of the winding roller J1 into which a slider 12 or 12a is incorporated.
(55) An electric motor M1 for winding or unwinding the projected corner canvas G1 or G2 is incorporated inside the winding roller J2 into which the slider 12 or 12a is incorporated.
(56) A motor output axis 271 and an axial portion for attachment 272 are provided in the two end portions, front and rear, of the electric motor M1, a movement conveying socket 281, which is engaged with one motor output axis 271, is engaged inside the main body of the roller 11, a rear portion of the above described electric motor M1 is supportedly inserted in the end cap 152 of the main body of the roller 11, and the other axis portion for attachment 272 is engaged in the end cap 142 of the casing K1 for winding the projected corner canvas G1 or G2 so that the canvas is stored.
(57) A coil spring 471 for storing and releasing the force of forward and backward rotation of the winding roller J3 as elastic energy is incorporated inside the winding roller J3 into which the slider 12 or 12a is incorporated.
(58) A fixed axis 491 passes through the coil spring 471, one side of the above described coil spring 471 is engaged with a spring holding socket 481 which is engaged in a front end portion of the fixed axis 491 and the coil spring passes through the main body of the roller 11, the other side of the above described fixed axis 491 passes through the end cap 152 of the main body of the roller 11, and the other side of the above described coil spring 471 is engaged with the end cap 152, and in addition, the coil spring is engaged with the end cap 142 of the casing K1.
(59) An end cap 141 or 142 is engaged in the casing K1 for winding the projected corner canvas G1 or G2 so that the projected corner canvas is stored, and a winding roller J1 to J3 where an end cap 151 or 152 is engaged in two end portions, front and rear, is supported with a bearing by the end cap 141 or 142.

Next, the dependent inventions concerning the rectangular awning device Q1 or Q2 in a complex device, a rectangular canvas P1 or P2 which forms the awning device U1 or U2 for a recessed corner, a recessed canvas P3 or P4 and a winding roller 30 or 30a for the recessed corner canvas, and a drive structure for the winding roller are listed in the following.

(60) An X-shaped or V-shaped through hole in the plane is created in a main body portion P1 or P2 of the rectangular canvas, and one side of a connection wire that penetrates through the hole is connected to the winding roller 30 or 30a and the other side is connected to the front bar R2 or R3.
(61) A recessed corner canvas P3 or P4 is formed in a trapezoid form with approximate right angles in a spread state, a top hem 5a of the recessed corner canvas P3 or P4 is attached to the winding roller 30 or 30a, a bottom hem 6 of the canvas is attached to the front bar R2 or R3, an X-shaped through hole in the plane is created in the rectangular portion of the main body of the recessed corner canvas P3 or P4, and one side of a connection wire that penetrates through the hole is attached to the winding roller 30 or 30a and the other side is attached to the front bar R2 or R3.

It can be seen from the above described (60) and (61) that the canvas P1 to P4 can be prevented from changing form in the plane when the canvas is wound or unwound.

(62) An electric motor M2 is incorporated into a winding roller 30 or 30a, a motor output axis 451 and an axial portion for attachment 452 are provided in two end portions, front and rear, of the electric motor, a movement conveying socket 461 which is engaged in one motor output axis 451, from among the motor output axis 451 and the axial portion for attachment 452, is engaged in the winding roller 30 or 30a, a rear portion of the above described electric motor M2 is supportedly inserted into the end cap 442 of the winding roller 30 or 30a, and the other axial portion for attachment 452 is engaged with the end cap 402 of the casing K2 for winding a rectangular canvas P1 or P2 or a recessed corner canvas P3 or P4 so that the rectangular canvas or the recessed corner canvas is stored.
(63) A coil spring 411 for storing or releasing the force of forward and backward rotation as elastic energy is incorporated in the winding roller 30 or 30a.
(64) A fixed axis 431 passes through the coil spring 411, one side of the above described coil spring 411 is engaged with the spring holding socket 421 which is engaged in a front end portion of the fixed axis 431, and the coil spring passes through the winding roller 30 or 30a, the other side of the above described fixed axis 431 passes through the end cap 442 of the winding roller 30 or 30a, and the other side of the above described coil spring 411 is engaged with the end cap 442 and the coil spring is fixed to the end cap 402 of the casing K2.
(65) An end cap 401 or 402 is engaged in the casing K2 for winding a rectangular canvas P1 or P2 or a recessed corner canvas P3 or P4 so that the rectangular canvas or the recessed corner canvas is stored, and a winding roller 30 or 30a where an end cap 441 or 442 is engaged in two end portions, front and rear, is supported with a bearing by the end cap 401 or 402.

Next, the dependent inventions concerning the configuration for transversely sliding the spread projected corner canvas G1 or G2 to a corner space portion and sliding the canvas to the rear from the corner space portion as well as a transverse device having this configuration are listed in the following.

(66) An engaging portion 241 for transverse operation of the projected corner canvas G1 or G2 is provided with a front bar F1 to F3.
(67) An engagement flap 242 for transverse operation of the projected corner canvas G1 is provided in the vicinity of a top hem 1 of the projected corner canvas G1.
(68) Movement conveying members 561, 562 and 66 including a rope and a wire for transversely sliding the front bar F1 to F3 run between one set of foldable arms V1, Y1, I1 or Z1 and the front bar F1 to F3 of the projected corner canvas G1 or G2.
(69) One of the movement conveying members 561 and 562 is for backward movement and the other for forward movement, and the movement conveying members are hung from portions in the vicinity of base portions of the foldable arms V1, Y1 and I1.
(70) A winding reel 60, 60a or 60b of the movement conveying wire 561 or 562 is incorporated into a front end portion of the winding roller J4 to J7, and the winding reel 60, 60a or 60b rotates forward or backward, and thus, the spread projected corner canvas G1 or G2 is transversely slid.
(71) Movement conveying wires 561 and 562 for backward movement and forward movement which slide the front bar F1 to F3 transversely run between one set of foldable arms V1, Y1 or I1 and the front bar F1 to F3 of the projected corner canvas G1 or G2, and a winding reel 60, 60a or 60b which winds one of the movement conveying wires 561 and 562 and unwinds the other is assembled at a front end portion of the winding roller J4 to J7.
(72) An electric motor M4 for rotating forward and backward a winding reel 60 which winds one of the movement conveying wires 561 and 562 and unwinds the other and an electric motor M1 for rotating forward and backward a winding roller J4 which winds and unwinds the projected corner canvas G1 or G2 are incorporated in the winding roller J4.
(73) A rear half portion of the main body of the electric motor M4 is inserted through a front end portion of the winding roller J4, a winding reel 60 is engaged in and fixed to a front half portion of the main body of the electric motor M4, and the front end axial portion 591 of the electric motor M4 is fixed to the end cap 146 of the casing K1.
(74) One electric motor M5 or M6 or a drive axis 73 for rotating the winding roller J5 to J7 and the winding reel 60, 60a or 60b forward and backward is incorporated in the winding roller J5 to J7, and when the movement of either the above described winding roller J5 to J7 or the winding reel 60, 60a or 60b is restricted from the outside, and thus the rotation is slowed down, the other winding roller J5 to J7 or the winding reel 60, 60a or 60b recoils or rotates backward.
(75) A means for slowing down the rotation of the winding roller J5 to J7 from the outside is formed of a rotation stopper 611 attached to a rear end portion of the winding roller J5 to J7, and a guide protrusion 135 with which the rotation stopper 611 engages, and the guide protrusion 135 is provided in the inner wall portion of the rear surface of the casing K1 for winding the projected corner canvas G1 or G2 so that the projected corner canvas is stored.
(76) A rear half portion of the main body of the electric motor M5 penetrates through a front end portion of the winding roller J5, the rear end output axis 594 of the electric motor M5 is engaged in and fixed to the movement conveying socket 281 which is supportedly inserted into the winding roller J5, the winding reel 60 is engaged in and fixed to a front half portion of the main body of the electric motor M5, and the front end support axis 593 of the electric motor M5 is supported with a bearing by the end cap 146 of the casing K1 for winding the projected corner canvas G1 or G2 so that the projected corner canvas is stored.
(77) A sun gear 70 is engaged in a main body portion of the electric motor M6 or a drive axis 73 which is manually rotated, an internal gear 71 is created in the winding reel 60a or 60b, and a planetary gear 72 which engages with the above described sun gear 70 and the internal gear 71 is attached to a front end portion of the winding roller J6 or J7.
(78) A rear half portion of the main body of the electric motor M6 penetrates through a front end portion of the winding roller J6, a rear portion of the main body of the electric motor M6 is supportedly inserted into the movement conveying socket 283 which is supportedly inserted into the above described winding roller J6, the winding reel 60a is supportedly inserted into a front end portion of the electric motor M6, and the front end axial portion 591 of the electric motor M6 is fixed to the end cap 146 of the casing K1 for winding the projected corner canvas G1 or G2 so that the projected corner canvas is stored.
(79) A rear half portion of the drive axis 73 penetrates through a front end portion of the winding roller J7, a portion in the vicinity of the rear end of the drive axis 73 is supportedly inserted through the movement conveying socket 283 which is supportedly inserted into the winding roller J7, a winding reel 60b is supportedly inserted in a portion close to the front end of the drive axis 73 and a manually operable gear device 161 or 162 is formed, and a front end portion of the above described drive axis 73 is supported with a bearing by the end cap 146 of the casing K1 for winding the projected corner canvas G1 or G2 so that the projected corner canvas is stored.
(80) An end cap 146 which works as a casing for the above described winding reel 60, 60a or 60b is attached in a location at the front end of the casing K1 of the winding roller J4 to J7 in which the winding reel 60, 60a or 60b is incorporated, and a guide long hole 148 or 149 into which a movement conveying wire 561 or 562 of the above described winding reel 60, 60a or 60b is inserted and created so as to have an opening in the bottom portion of the end cap.

Here, simple configurations for preventing the canvas on the upper portion side from being loosened at the time of storage are listed in the following.

(81) A fluctuation flap 62 for pushing up and pressing a bottom hem 2 or 2a of the canvas G1 or G2 is attached to the rear end of an upper portion of the front bar F2 or F3 of the above described projected corner canvas G1 or G2 in the case where a casing K1 having a winding roller J1 to J8 of the projected corner canvas G1 or G2 is attached to the upper portion side of a wall portion and a casing K2 having a winding roller 30 or 30a of a rectangular canvas P1 or P2 is attached to the lower portion side.
(82) A fluctuation flap 62 for pushing up and pressing a bottom hem 6 of the canvas P1 or P2 is attached to the rear end of an upper portion of the front bar R2 or R3 of the rectangular canvas P1 or P2 in the case where a casing K2 having a winding roller 30 or 30a of the rectangular canvas P1 or P2 is attached to the upper portion side of a wall portion and a casing K1 having a winding roller J1 to J8 of the projected corner canvas G1 or G2 is attached to the lower portion side.
(83) A fluctuation flap 62 for pushing up and pressing a bottom hem 2 or 2a of the canvas G1 or G2 is attached to the rear end of an upper portion of the front bar F2 or F3 of the projected corner canvas G1 or G2 in the case where a casing K1 having a winding roller J1 to J8 of the projected corner canvas G1 or G2 is attached to the upper portion side of a wall portion and a casing K2 having a winding roller 30 or 30a of the recessed corner canvas P3 or P4 is attached to the lower portion side.
(84) The fluctuation flap 62 for pushing up and pressing a bottom hem 2 of the canvas G1 is attached to the rear end of an upper portion of the front bar F4 of the projected corner canvas G1 on the upper portion side in the case where two casings K1 having winding rollers J1 to J8 of the projected corner canvas G1 are attached to the upper portion side and the lower portion side of a wall portion in front-rear symmetry.

Next, simple configurations for allowing the canvas on the upper portion side to be supported in a tense form when being spread and absorbing slack at the time of storage are listed in the following.

(85) An expandable net 631 is spanned between the rear end of an upper portion of the front bar F2 or F3 of the above described projected corner canvas G1 or G2 and the rear surface close to a bottom hem 2 or 2a of the projected corner canvas G1 or G2 in the case where a casing K1 having a winding roller J1 to J8 of the projected corner canvas G1 or G2 is attached to the upper portion side of a wall portion and a casing K2 having a winding roller 30 or 30a of a rectangular canvas P1 or P2 is attached to the lower portion side.
(86) An expandable net 631 is spanned between the rear end of an upper portion of the front bar R2 or R3 of the above described rectangular canvas P1 or P2 and the rear surface close to a bottom hem 6 of the rectangular canvas P1 or P2 in the case where a casing K2 having a winding roller 30 or 30a of the rectangular canvas P1 or P2 is attached to the upper portion side of a wall portion and a casing K having a winding roller J1 to J8 of the projected corner canvas G1 or G2 is attached to the lower portion side.
(87) An expandable net 631 is spanned between the rear end of an upper portion of the front bar F2 or F3 of the above described projected corner canvas G1 or G2 and the rear surface close to a bottom hem 2 or 2a of the projected corner canvas G1 or G2 in the case where a casing K1 having a winding roller J1 to J7 of the projected corner canvas G1 or G2 is attached to the upper portion side of a wall portion and a casing K2 having a winding roller 30 or 30a of the recessed corner canvas P3 or P4 is attached to the lower portion side.
(88) An expandable net 631 is spanned between the rear end of an upper portion of the front bar F4 of the projected corner canvas G1 on the upper portion side and the rear surface close to a bottom hem 2 of the projected corner canvas G1 in the case where two casings K1 having winding rollers J1 to J7 of the projected corner canvas G1 are attached to the upper portion side and the lower portion side of a wall portion in front-rear symmetry.

In addition, the dependent inventions for narrowing a gap or a step in the top hem of the canvas are listed below.

(89) A location close to a top hem 1 or 5 of one or two of the projected corner canvases G1 and G2, the rectangular canvases P1 and P2 or the recessed corner canvases P3 and P4 is pushed down or pushed up by a fluctuation flap 961 or 971 attached to a casing K1 to K3 at the final stage when the canvas is spread.
(90) The fluctuation flap 97 is engaged with a protrusion 99 or an engagement hole created in a location close to a top hem 1 or 5 of the canvas so that the above described fluctuation flap 961 or 971 fluctuates when the canvas is further pulled out, and thus, a location close to a top hem of the above described canvas is pushed down or pushed up at the final stage when the canvas is spread.

In addition, the dependent inventions concerning cases where the casing K1 or K2 is integrated and a linking structure of the winding rollers J1 to J7 and 30 or 30a, which are incorporated on the upper portion side and the lower portion side of the casing, are listed below.

(91) The winding roller J1 to J8 for the projected corner canvas G1 or G2 and the winding roller 30 or 30a for the rectangular canvas P1 or P2 or the recessed corner canvas P3 or P4 are incorporated on the upper portion side and on the lower portion side of one casing K3.
(92) The winding roller J1 to J8 which extends to the rear and a rear end portion of the winding roller 30 or 30a are engaged through a spur gear 511 or 512.

Finally, the inventions of the winding roller J1 to J7 for the projected corner canvas G1 or G2 which forms a main portion of the above described present invention and is independent as a single product so as to be replaced with another product are listed in the following.

(93) A slider 12 or 12a which allows a spread projected corner canvas G1 or G2 to transversely and freely slide is supportably inserted into the main body of a roller 11 for winding or unwinding the projected corner canvas G1 or G2 (J1 to J7).
(94) A manually operable device or an electrically-driven device for winding or unwinding the projected corner canvas G1 or G2 is incorporated in an axial end portion of the main body of a roller 11 into which the slider 12 or 12a is incorporated (J1).
(95) An electric motor M1 for winding or unwinding the projected corner canvas G1 or G2 is incorporated inside the main body of the roller 11 into which the slider 12 or 12a is incorporated (J2).
(96) A motor output axis 271 and an axis portion for attachment 272 are provided in the two end portions, front and rear, of the electric motor M1, and a movement conveying socket 281 which is engaged in the motor output axis 271 is engaged inside the main body of the roller 11, a rear portion of the above described electric motor M1 is supportedly inserted into the end cap 152 of the main body of the roller 11, and the axis portion for attachment 182 is engaged into the end cap 142 of the casing K1 for winding the projected corner canvas G1 or G2 so that the projected corner canvas is stored (J2).
(97) A coil spring 471 for storing or releasing the force of forward and backward rotation of the main body of the roller 11 as elastic energy is incorporated inside the main body of the roller 11 into which the slider 12 or 12a is incorporated (J3).
(98) A fixed axis 491 is inserted through the coil spring 471, one side of the above described coil spring 471 is engaged with a spring holding socket 481 which is engaged in a front end portion of the fixed axis 491 and the coil spring penetrates through the main body of the roller 11, the other side of the above described fixed axis 491 penetrates through the end cap 152 of the main body of the roller 11, and the other side of the above described coil spring 471 is engaged with the end cap 152, and after that, the coil spring is engaged with the end cap 142 of the casing K1 (J3).
(99) A winding reel 60, 60a or 60b for a movement conveying wire 561 or 562 is assembled at a front end portion of the main body of the roller 11 into which the slider 12 or 12a is incorporated, and the winding reel 60, 60a or 60b is rotated forward or backward, and thus, a spread projected corner canvas G1 or G2 transversely slides (J4 to J7).
(100) An electric motor M1 for winding or unwinding the projected corner canvas G1 or G2 and an electric motor M4 for rotating forward and backward the winding reel 60 which winds one of the movement conveying wires 561 and 562 and unwinds the other are incorporated inside the main body of the roller 11 into which the slider 12 or 12a is incorporated (J4).
(101) A rear half portion of the main body of the electric motor M4 penetrates through a front end portion of the main body of the roller 11, the winding reel 60 is engaged in and fixed to a front half portion of the main body of the electric motor M4, and a front end axial portion 591 of the electric motor M4 is secured to the end cap 146 of the casing K1 (J4).
(102) A winding roller J5 to J7 is provided with the main body of the roller 11 into which the slider 12 or 12a is incorporated and one electric motor M5 or M6 or a drive axis 73 which rotates forward and backward the winding reel 60, 60a or 60b for a movement conveying wire 561 or 562, and when the operation of either the above described main body of the roller 11 and the winding reel 60, 60a or 60b is restricted from the outside, and thus the rotation is slowed down, the other of the main body of the roller 11 or the winding reel 60, 60a or 60b recoils or rotates backward (J5 to J7).
(103) A rear half portion of the main body of the electric motor M5 penetrates through a front end portion of the main body of the roller 11, the rear end output axis 594 of the electric motor M5 is engaged in and secured to a movement conveying socket which is supportedly inserted into the main body of the roller 11, the winding reel 60 is engaged in and secured to a front half portion of the main body of the electric motor M5, and the front end supporting axis 593 of the electric motor M5 is supported with a bearing by the end cap 146 of the casing K1 (J5).
(104) A sun gear 70 is engaged with the main body portion of the electric motor M6 or the drive axis 73 which is manually rotated, an internal gear 71 is created in the winding reel 60a or 60b, and a planetary gear 72 which engages with the above described sun gear 70 and the internal gear 71 is attached to a front end portion of the main body of the roller 11 (J6 and J7).
(105) A rear half portion of the main body of the electric motor M6 penetrates through a front end portion of the main body of the roller 11, a rear portion of the main body of the electric motor M6 is supportedly inserted through the movement conveying socket 283 which is supportedly inserted into the main body of the above described roller 11, the winding reel 60a is supportedly inserted into a front end portion of the electric motor M6, and a front end axis portion 591 of the electric motor M6 is fixed to the end cap 146 of the casing K1 (J6).
(106) A rear half portion of the drive axis 73 penetrates through a front end portion of the main body of the roller 11, a portion in the vicinity of the rear end of the drive axis 73 is supportedly inserted into the movement conveying socket 283 which is supportedly inserted into the above described main body of the roller 11, the winding reel 60b is supportedly inserted into a portion close to the front end of the drive axis 73 and a manually operable gear device 161 or 162 is formed, and a front end portion of the above described drive axis 73 is supported with a bearing by the end cap 146 of the casing K1 (J7).

### BRIEF DESCRIPTION OF THE DRAWINGS

FIGS. 1 to 22 are diagrams showing the foldable arm type single awning devices and the related configurations according to the first to fourth embodiments.

In the figures, though the canvases are generally opaque, some canvases are shown in a transparent state if necessary in order to show the configuration on the rear side which is hidden. In the same manner, the winding rollers incorporated inside the casing are shown by making the casing transparent if necessary.

Here, many drawings three-dimensionally show the awning devices which are attached to a frame in an L shape, band plate form, crank form, C shape or the like in approximately a horizontal state, but this is for the sake of seeing the drawings simply. Generally, a spread projected corner canvas or a rectangular canvas is attached so as to be fixed or freely changeable in the angle in an appropriately inclined state.

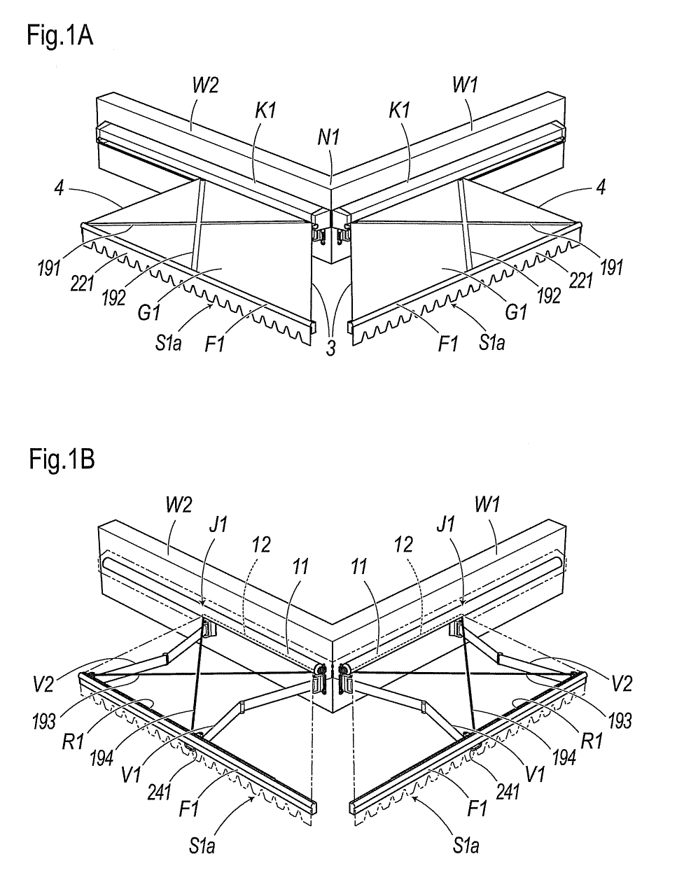

FIGS. 1(A) and 1(B) are perspective diagrams showing single devices on the two sides of a projected corner portion; FIG. 1(B) shows the single devices S1a having foldable arms which are freely foldable in two with transparent canvases;

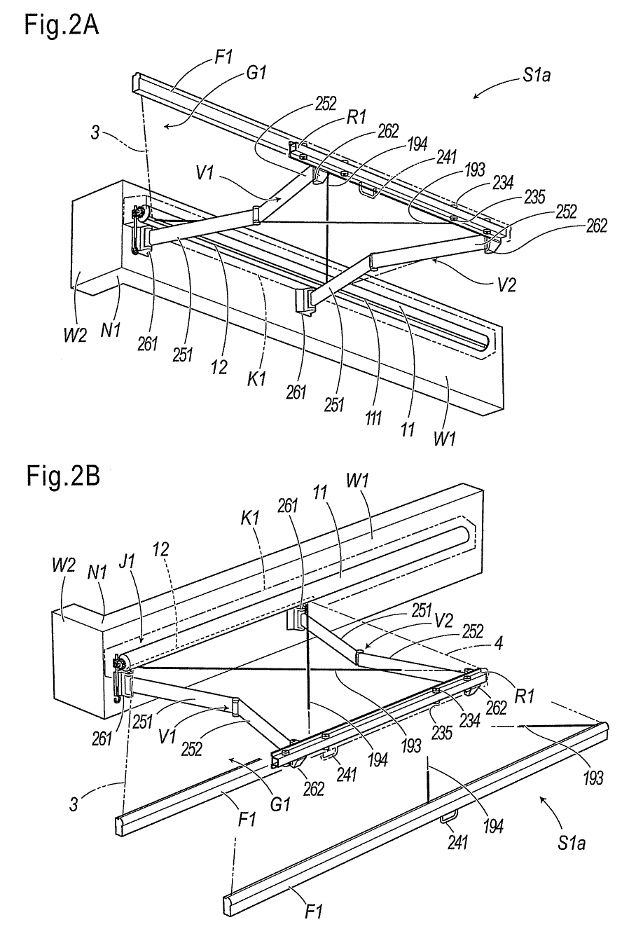

FIGS. 2(A) and 2(B) are perspective diagrams showing the single device S1a in a transparent state; FIG. 2(B) shows a state where the front bar of the projected corner canvas is separated from the transverse guide rail;

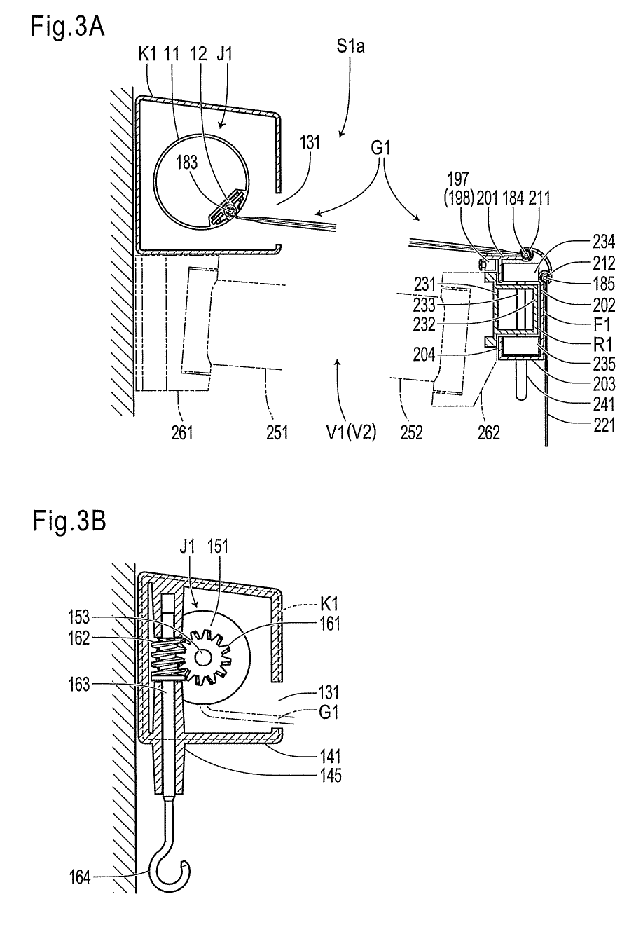

FIGS. 3(A) and 3(B) are longitudinal cross sectional diagrams showing a main portion of a single device S1a; FIG. 3(B) shows a manually operable device for a winding roller;

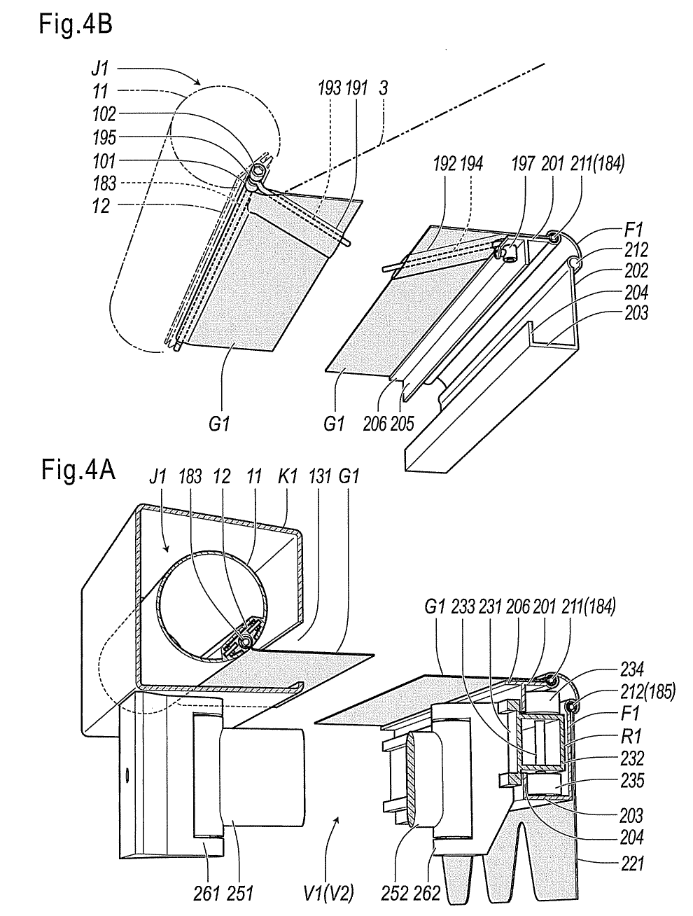

FIGS. 4(A) and 4(B) are perspective diagrams showing a longitudinal cross section of a main portion of a single device S1a; FIG. 4(B) shows the state of attachment of a connection wire for supporting a projected corner canvas in a tense state;

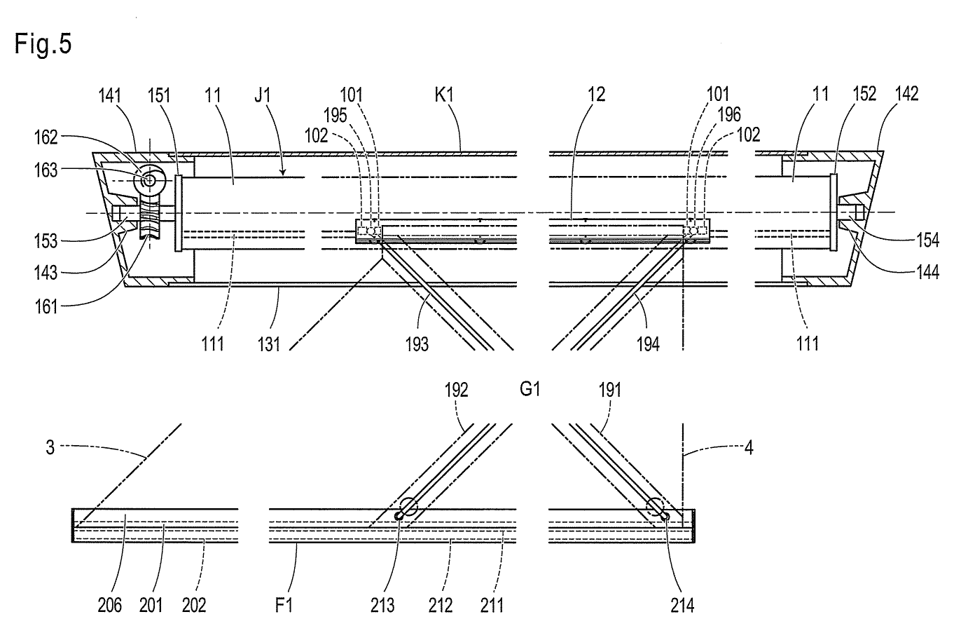

FIG. 5 is a plan diagram showing a lateral cross section of a single device S1a;

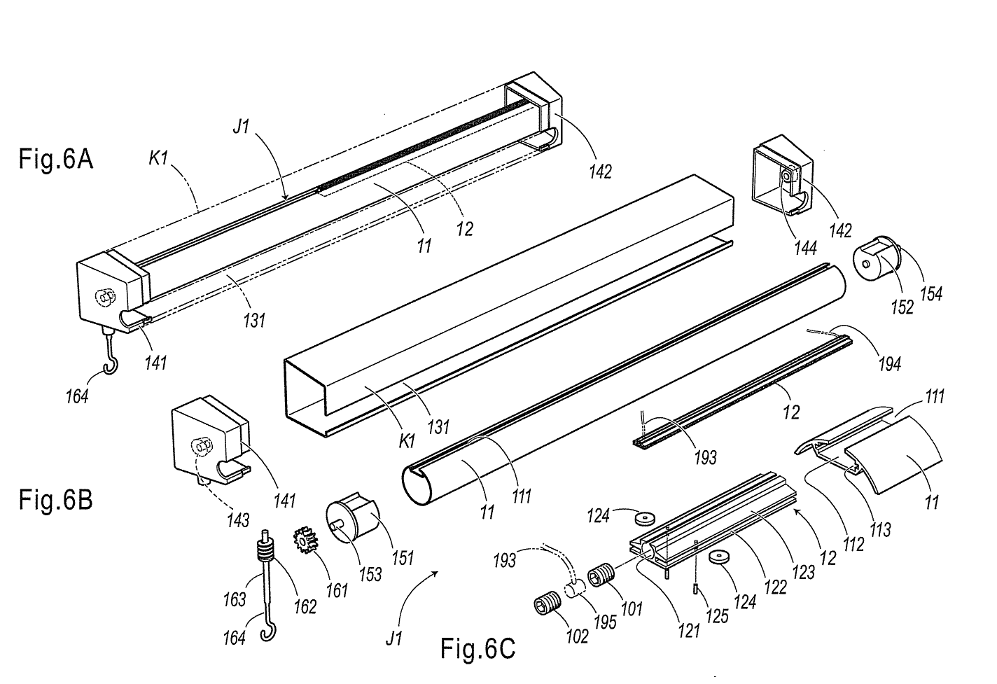

FIGS. 6(A) to 6(C) are perspective diagrams showing a main portion of a canvas winding device in which a manually operable device is incorporated; FIG. 6(B) is an exploded diagram of the components, for example a casing, a winding roller, a slider, a manually operable device and the like; FIG. 6(C) shows a partially expanded main portion of a winding roller and a slider, and screws for securing a base portion of a connection wire from both sides;

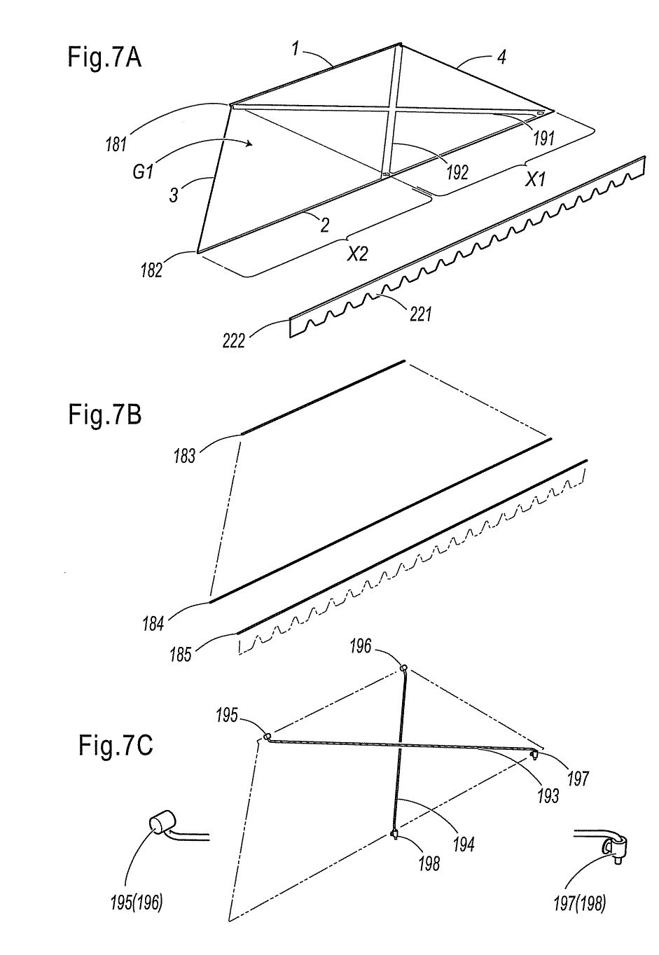

FIGS. 7(A) to 7(C) are exploded perspective diagrams showing a projected corner canvas, the front skirt thereof, and wires; FIG. 7(C) shows two partially enlarged end portions of a connection wire in locations on the left and on the right;

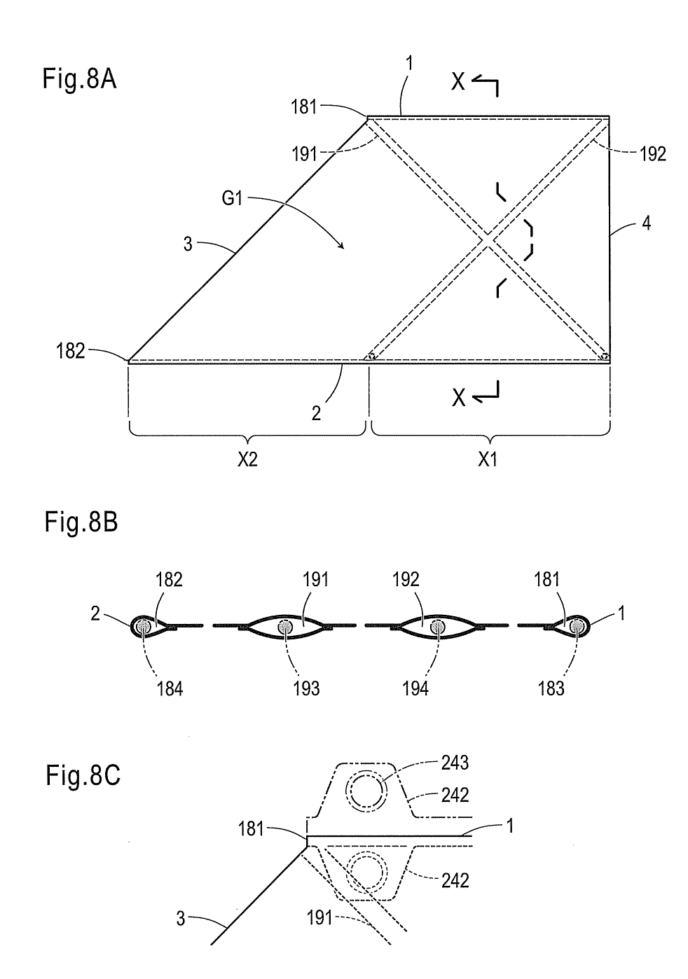

FIGS. 8(A) and 8(B) are a plan diagram showing a projected corner canvas and a cross sectional diagram along line X-X showing an enlarged canvas through which wires penetrate, and FIG. 8(C) is a cross sectional diagram showing the engaging flap formed in the vicinity of the front end of the top hem of a projected corner canvas so as to protrude shown in FIG. 55(A) below with imaginary lines, and the engaging flap in a state where the protrusion is folded and sewn with broken lines;

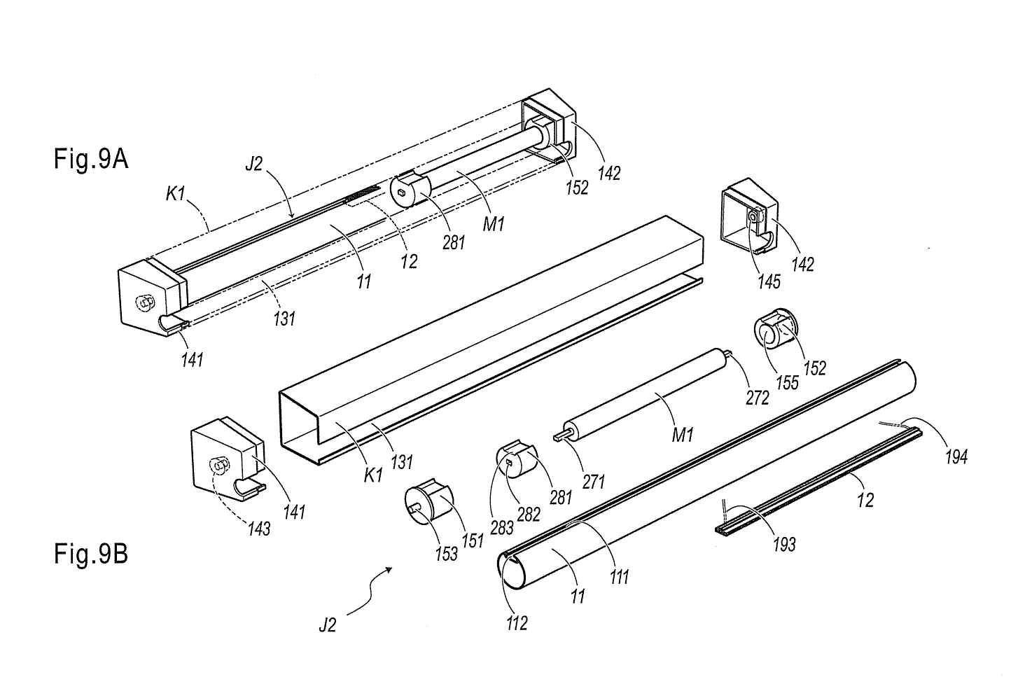

FIGS. 9(A) and 9(B) are perspective diagrams showing a main portion of a canvas winding device in which an electric motor is incorporated, and the components thereof;

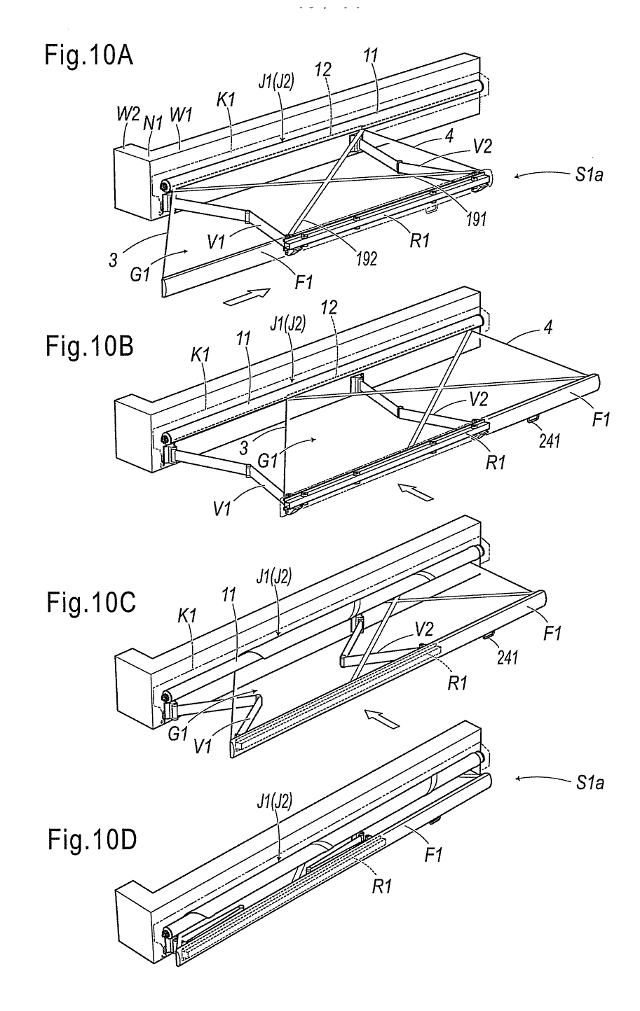

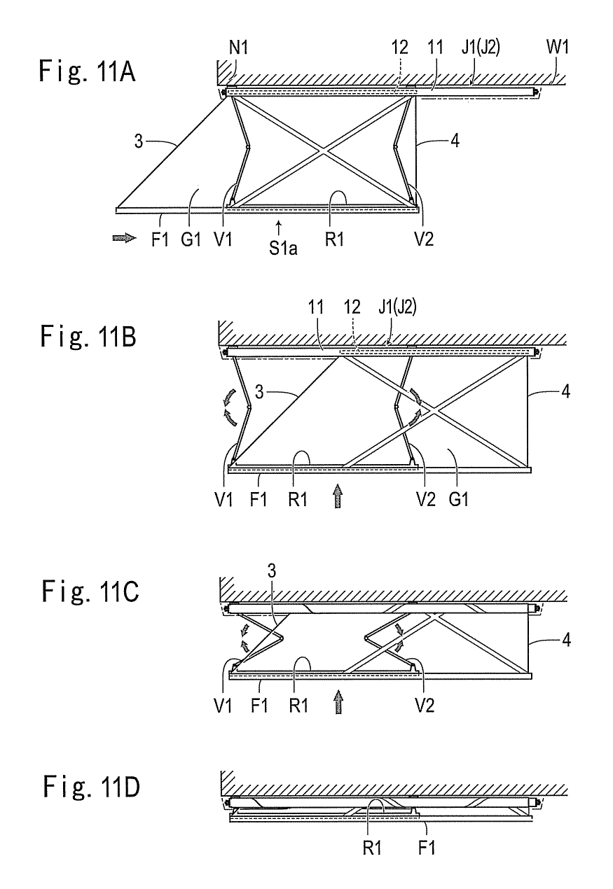

FIGS. 10(A) to 10(D) and FIGS. 11(A) to 11(D) are perspective diagrams and plan diagrams showing a projected corner canvas which is projected in a corner space portion, and the process through which the canvas is rolled up and wound, and when the diagrams are seen in reverse order, they show the process through which the projected corner canvas is unwound and spread, that is, the process through which the canvas moves forward to the corner space portion;

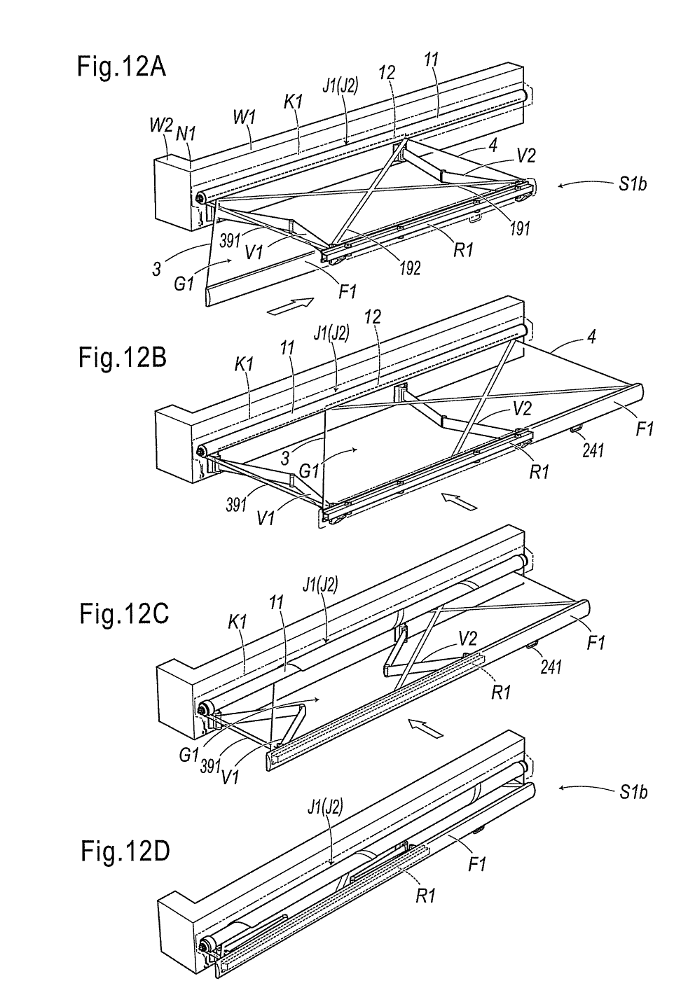

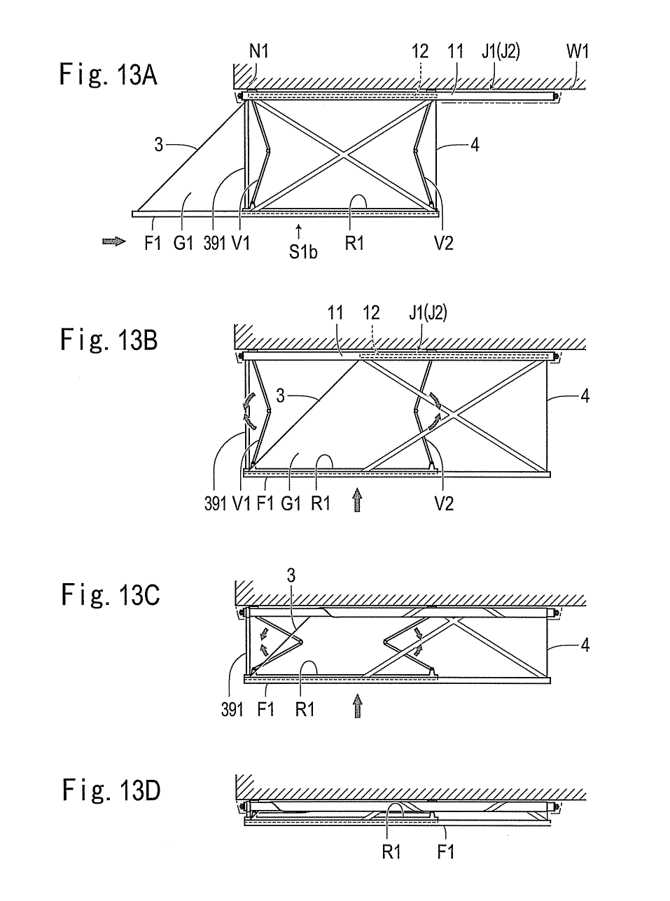

FIGS. 12(A) to 12(D) and FIGS. 13(A) to 13(D) are perspective diagrams and plan diagrams showing a single device S1b having a synchronizing belt according to the second embodiment, and a projected corner canvas which is projected in a corner space portion and the process through which the canvas is rolled up and wound;

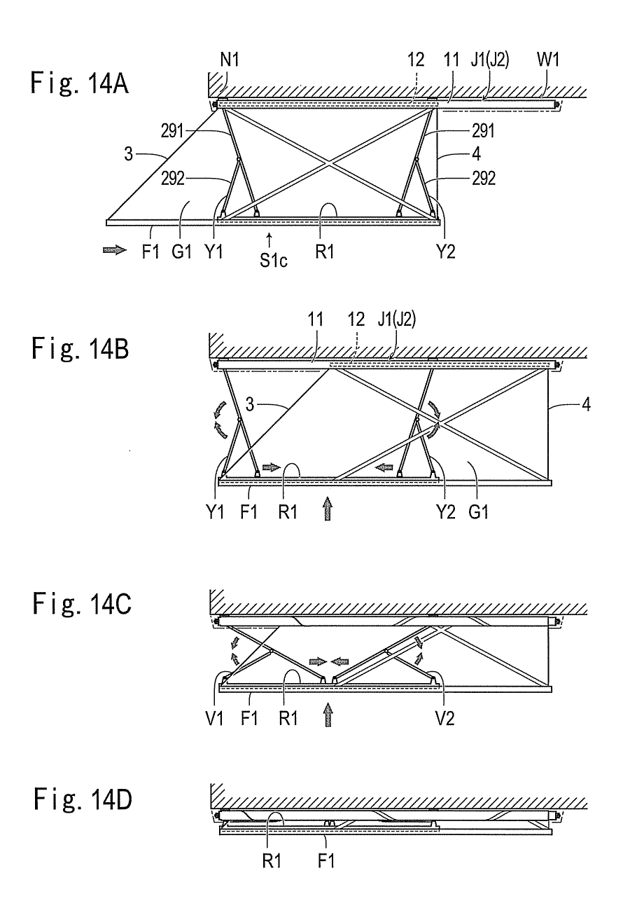

FIGS. 14(A) to 14(D) are plan diagrams showing a single device S1c having foldable arms in a reverse y shape according to the third embodiment, and a projected corner canvas which is projected in a corner space portion and the process through which the canvas is rolled up and wound;

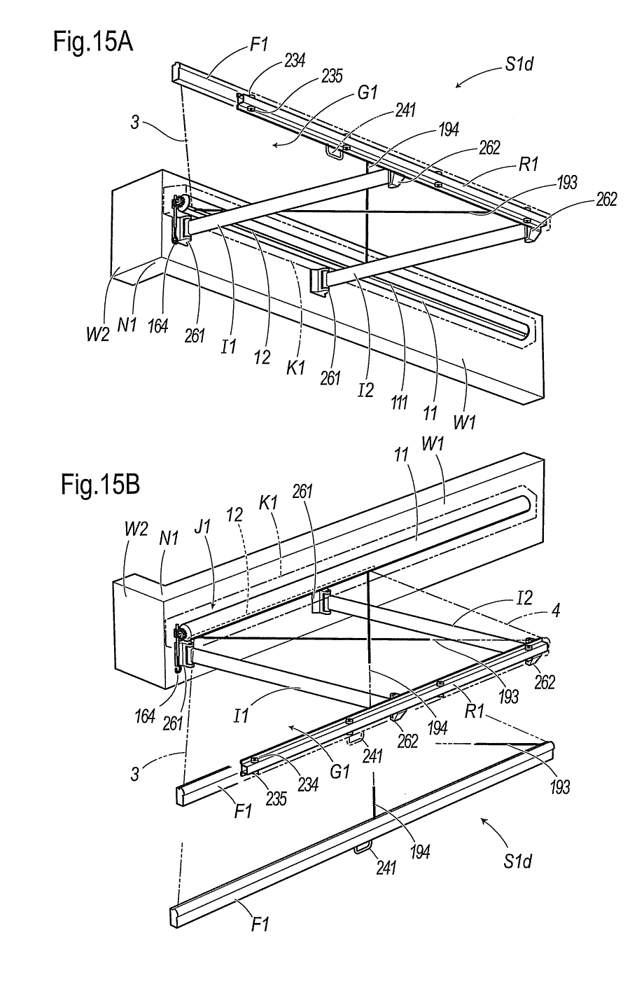

FIGS. 15(A) and 15(B) are perspective diagrams showing a single device S1d having foldable arms in straight line form according to the fourth embodiment; FIG. 15(B) shows the front bar of a projected corner canvas in a separated state from the transverse guide rail;

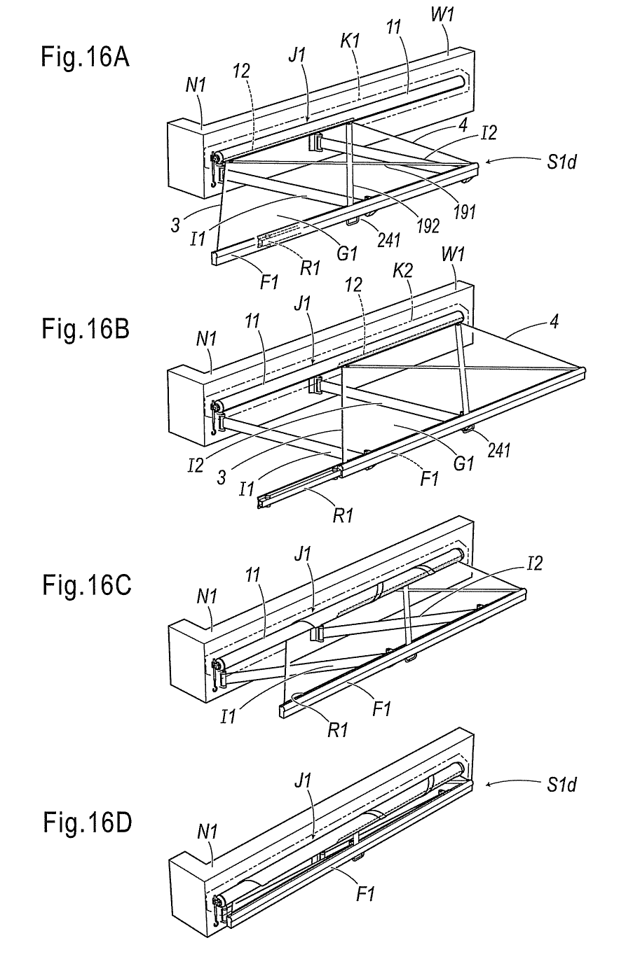

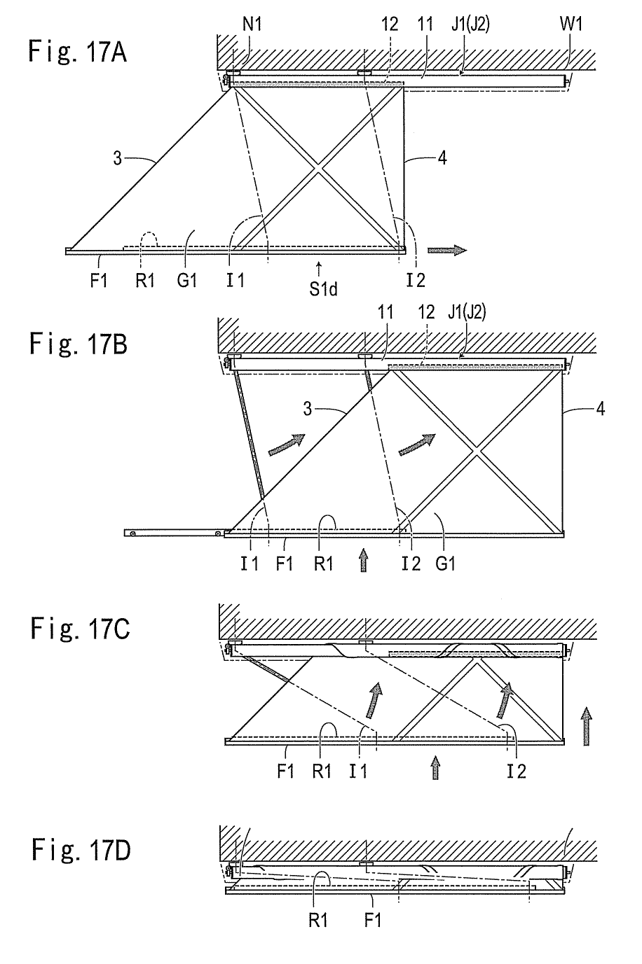

FIGS. 16(A) to 16(D) and FIGS. 17(A) to 17(D) are perspective diagrams and plan diagrams showing a projected corner canvas which is projected in a corner space portion and the process through which the canvas is rolled up and wound, and when the diagrams are seen in reverse order, they show the process through which the projected corner canvas is unwound and spread, that is, the process through which the canvas moves forward to the corner space portion;

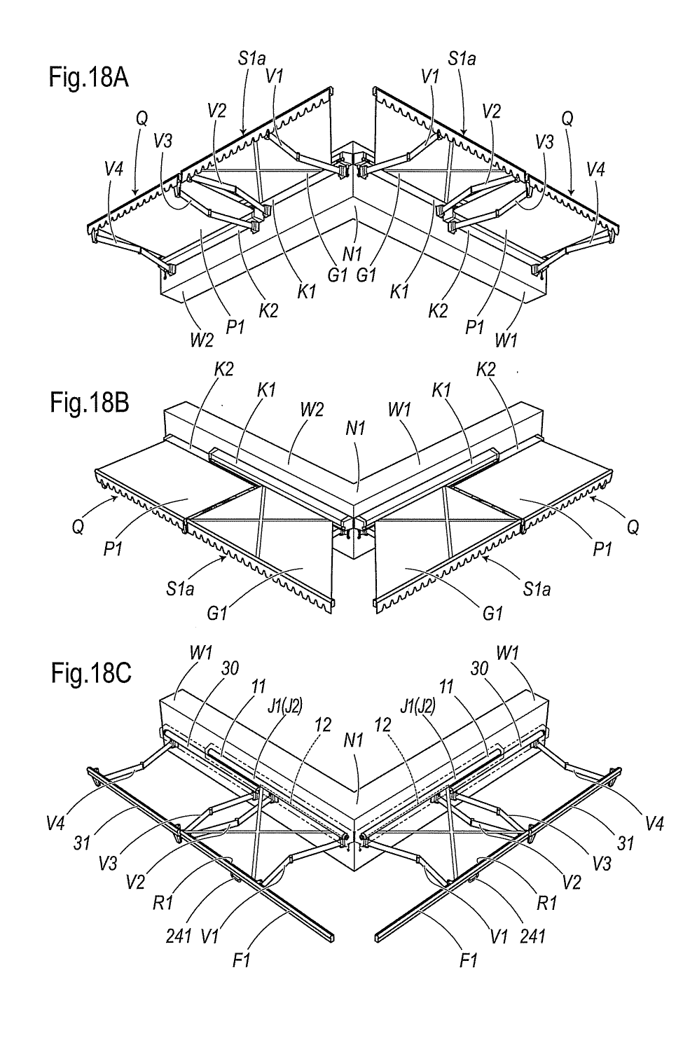

FIGS. 18(A) to 18(C) are perspective diagrams showing two single devices S1a placed perpendicular to each other on the two sides of a projected corner portion in such a manner that the front end portions of the movable awning devices, which have a prior art structure, overlap in the up-down direction in the respective rear half bottom portions in such a state that the respective canvases are spread; FIG. 18(C) shows the respective casings and canvases with the canvas transparent;

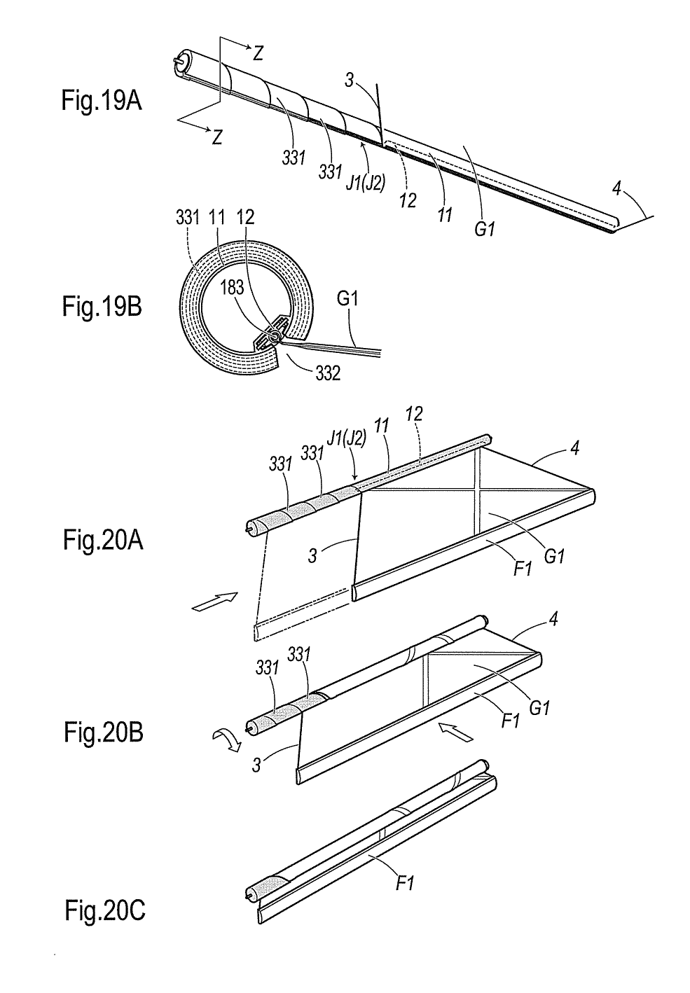

FIGS. 19(A) and 19(B) are a perspective diagram and a longitudinal cross sectional diagram showing a winding roller with which a bulk ring is engaged;

FIGS. 20(A) to 20(C) are perspective diagrams showing the process through which the rolled up projected corner canvas is wound;

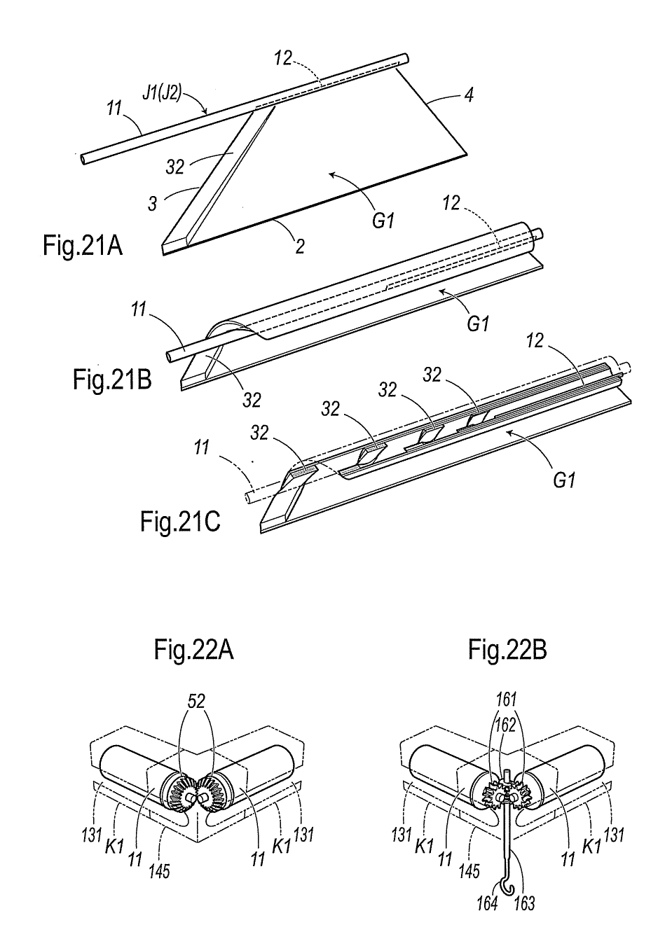

FIGS. 21(A) to 21(C) are cross sectional diagrams showing a projected corner canvas to which a bulk cloth is sewn in a state where the canvas is wound around a winding roller and in a wound state;

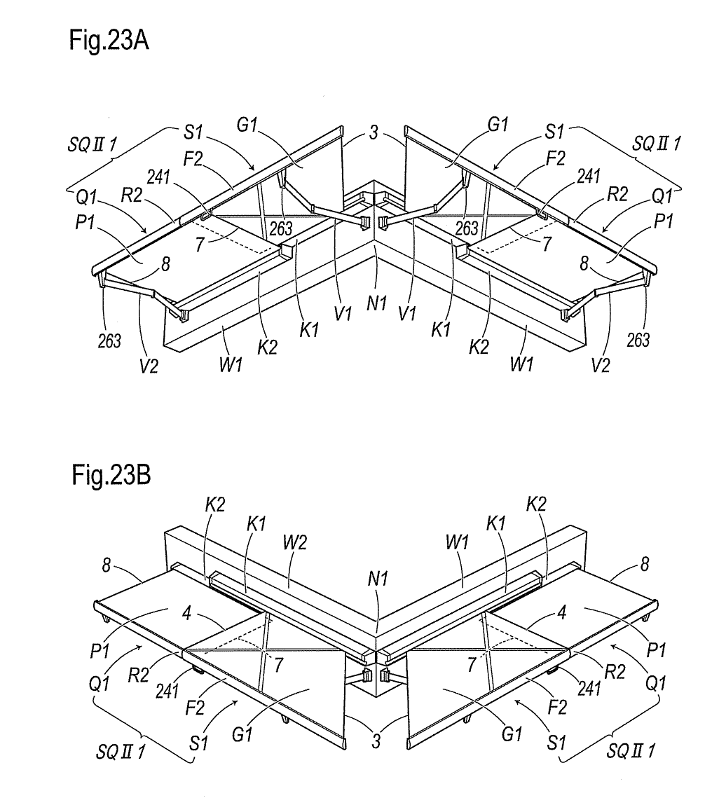

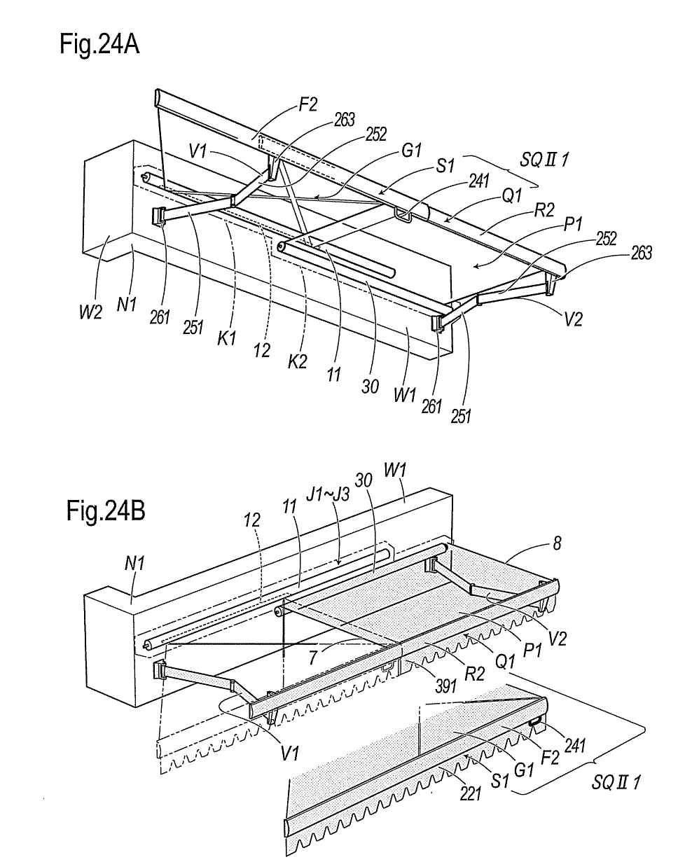

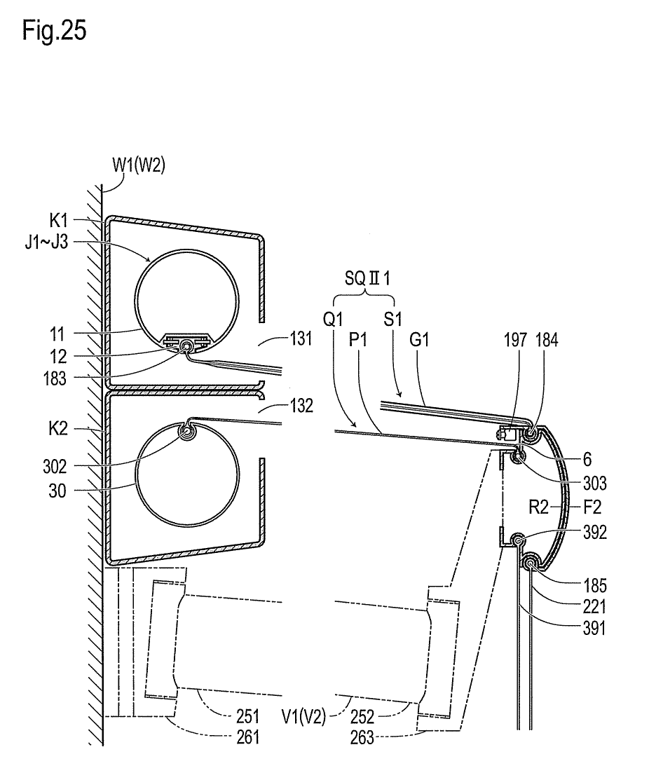

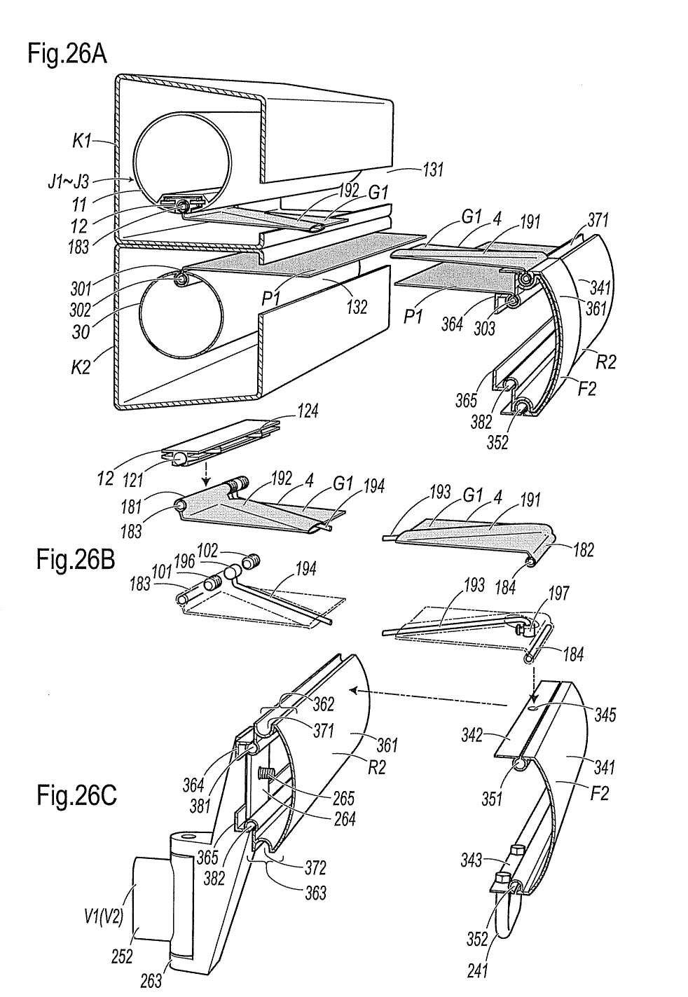

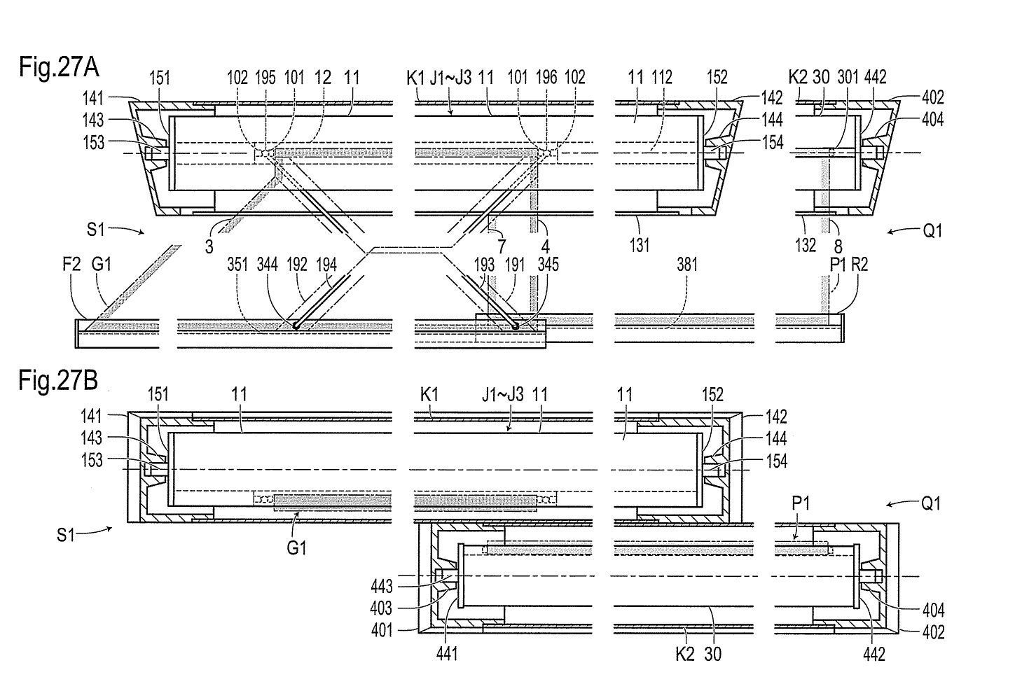

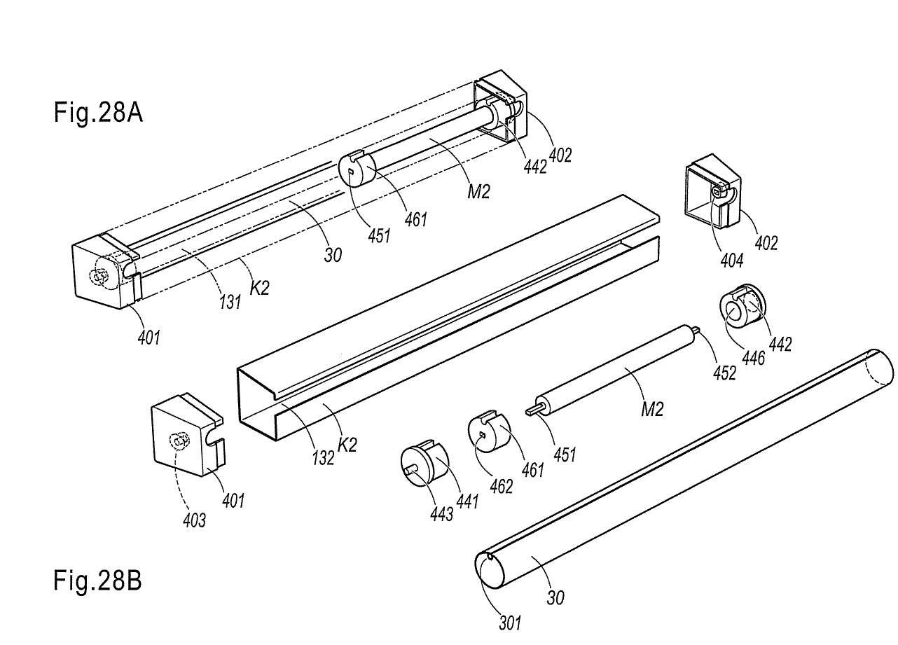

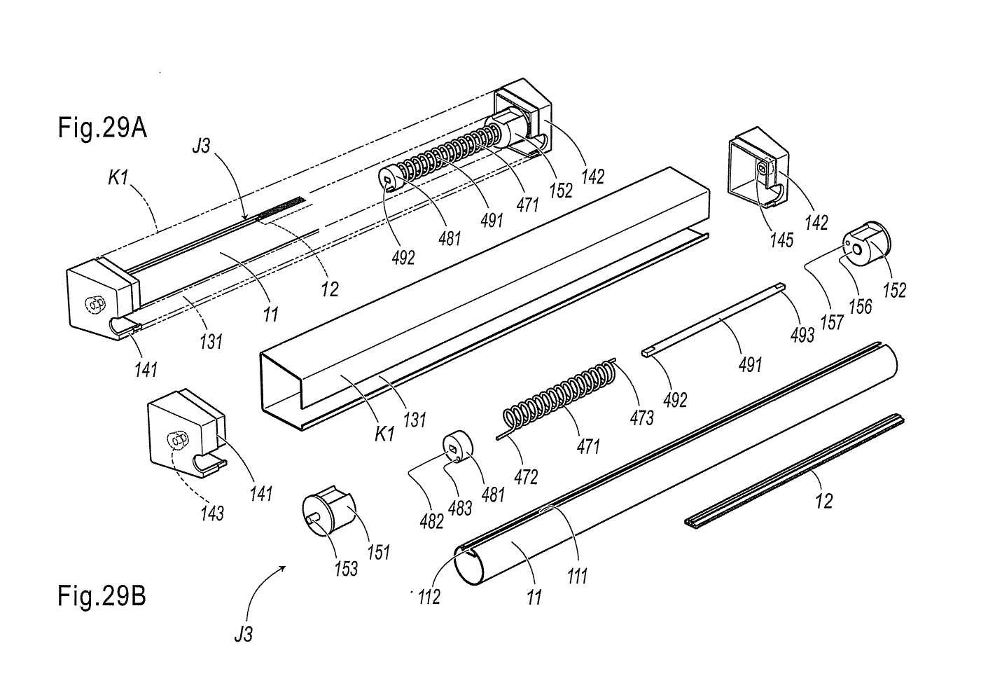

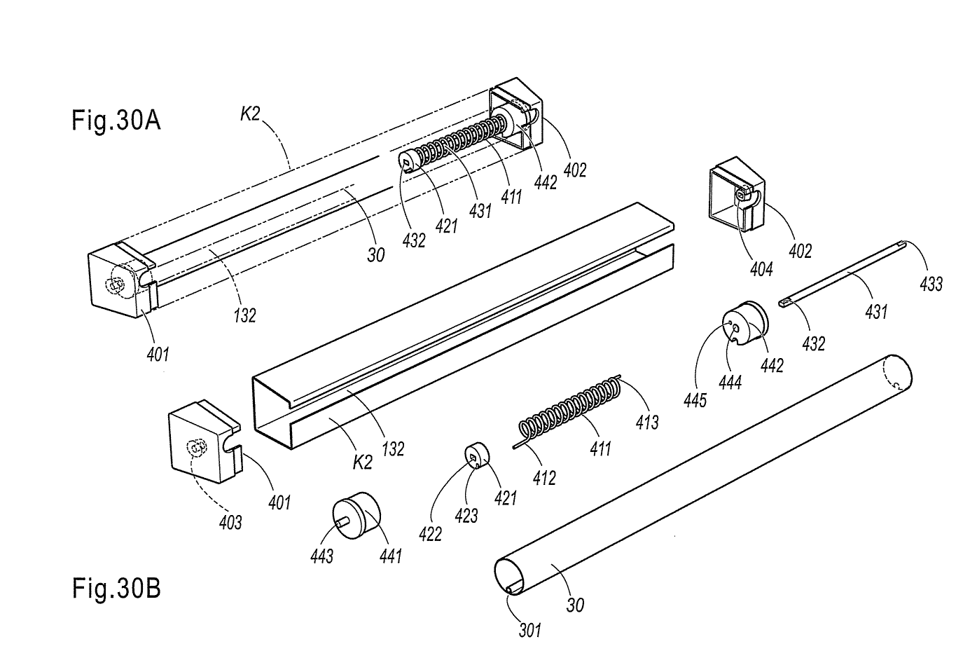

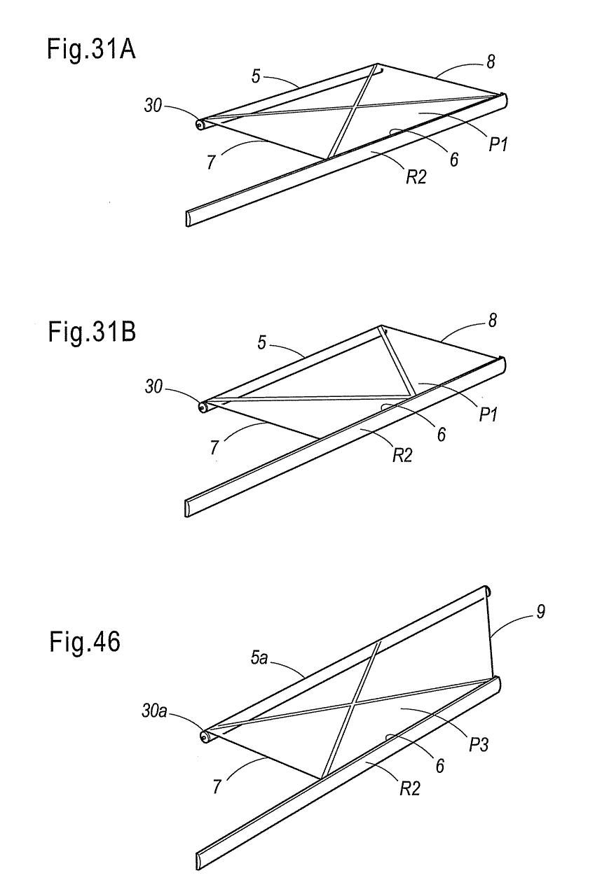

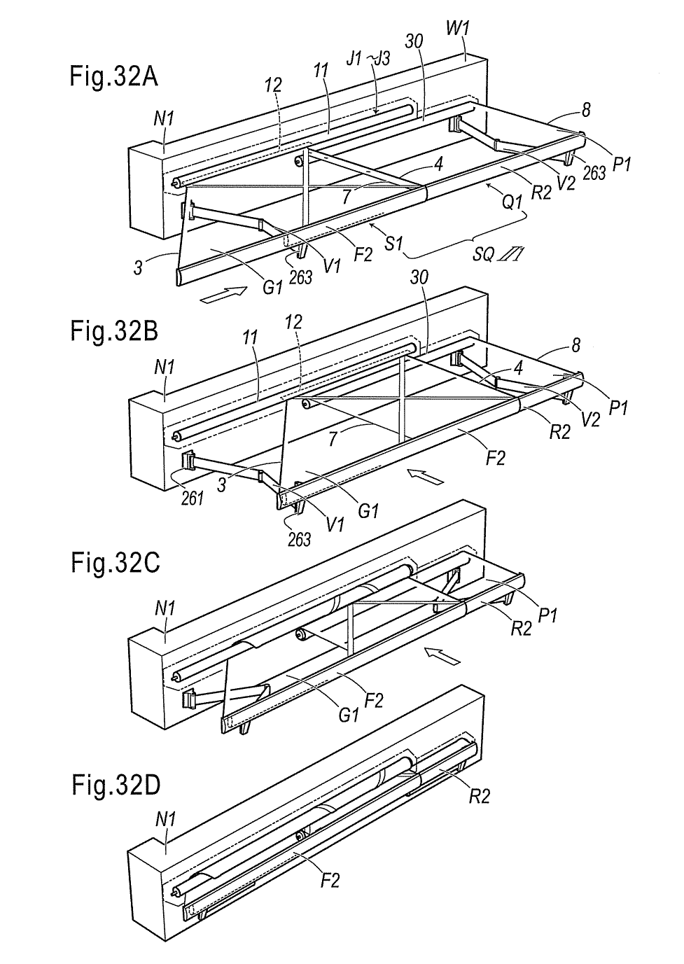

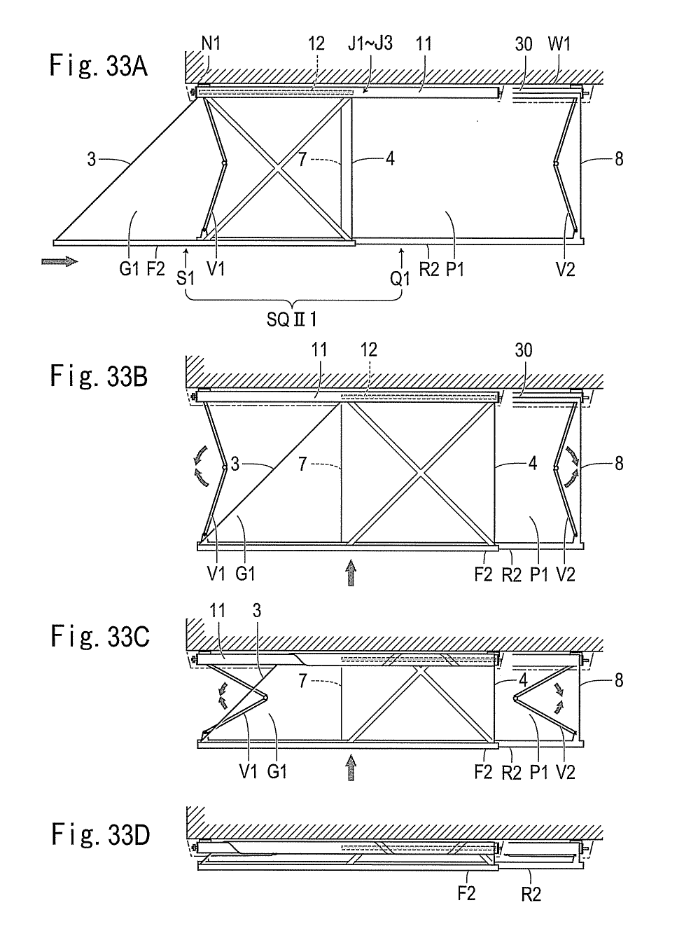

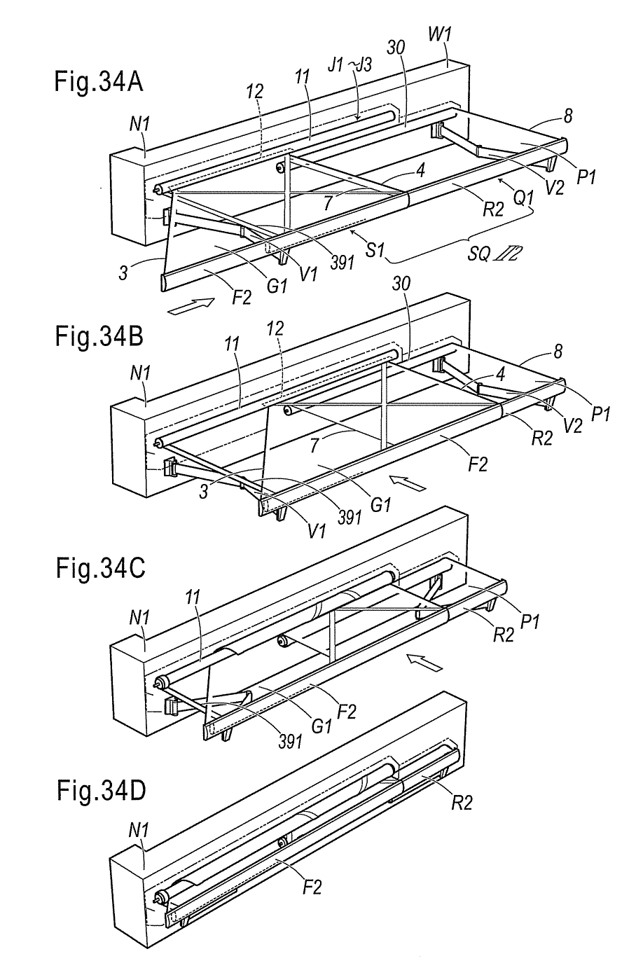

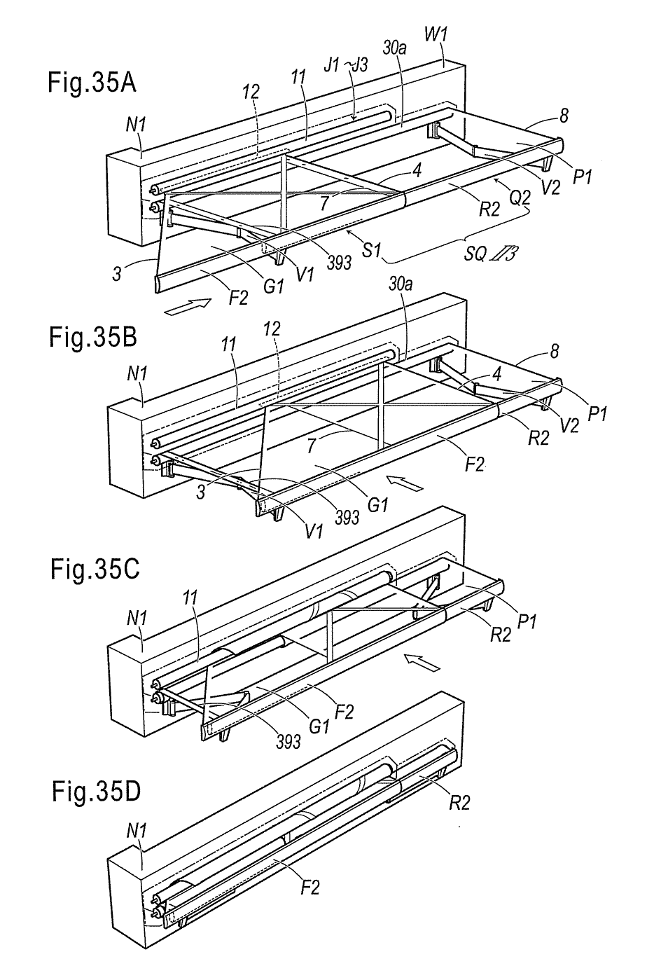

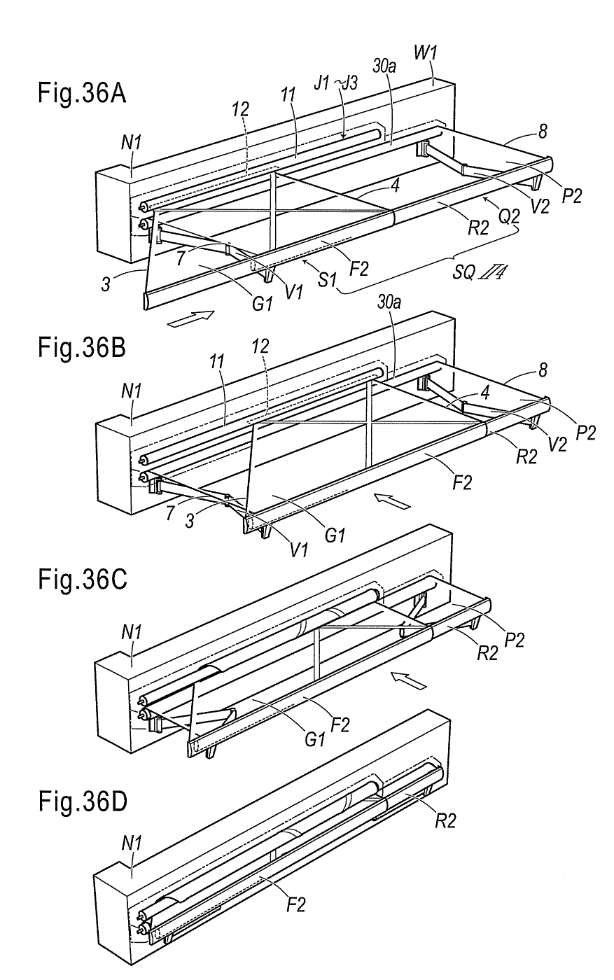

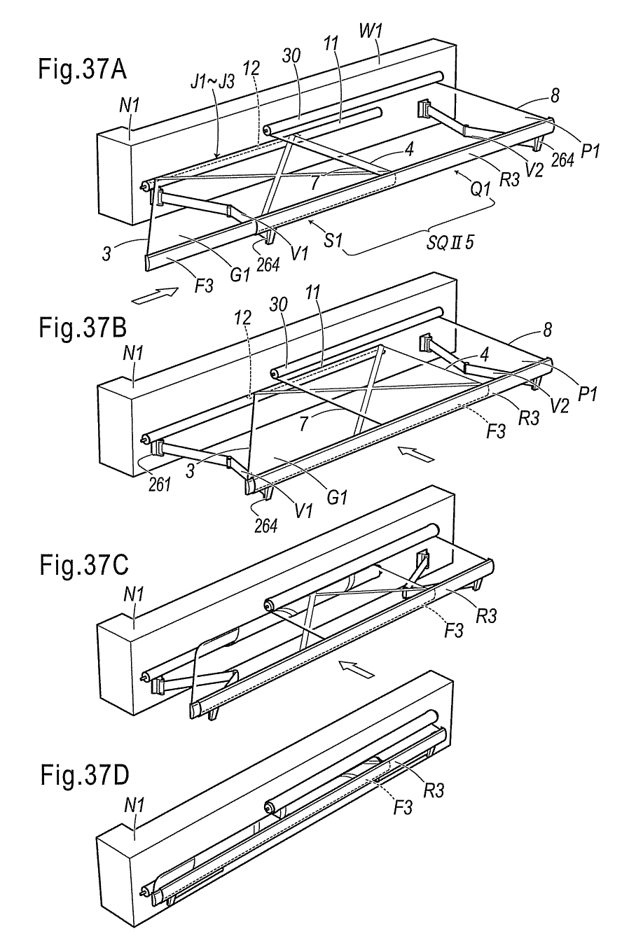

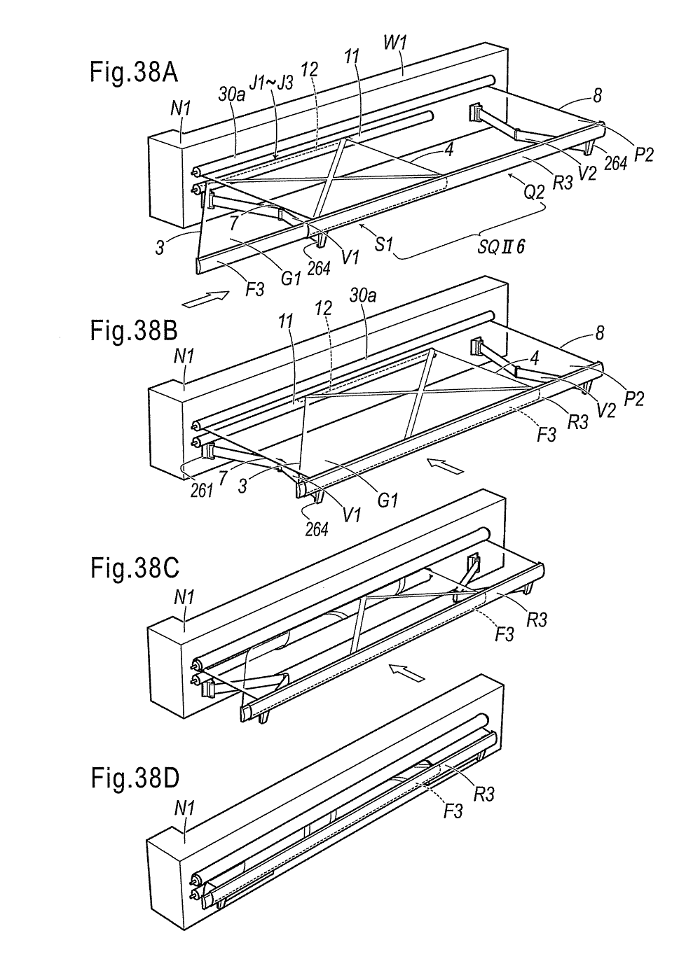

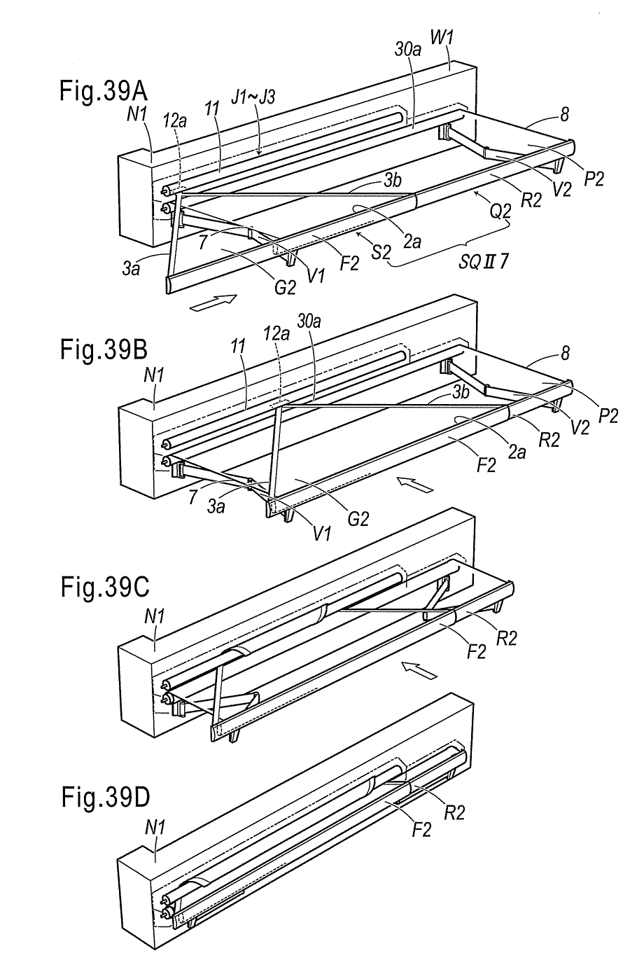

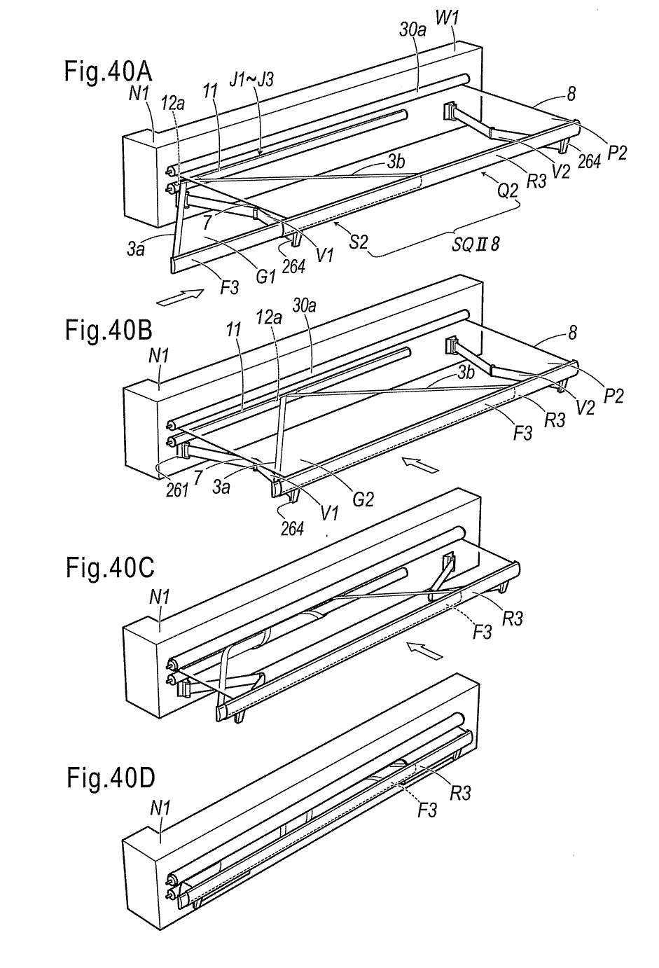

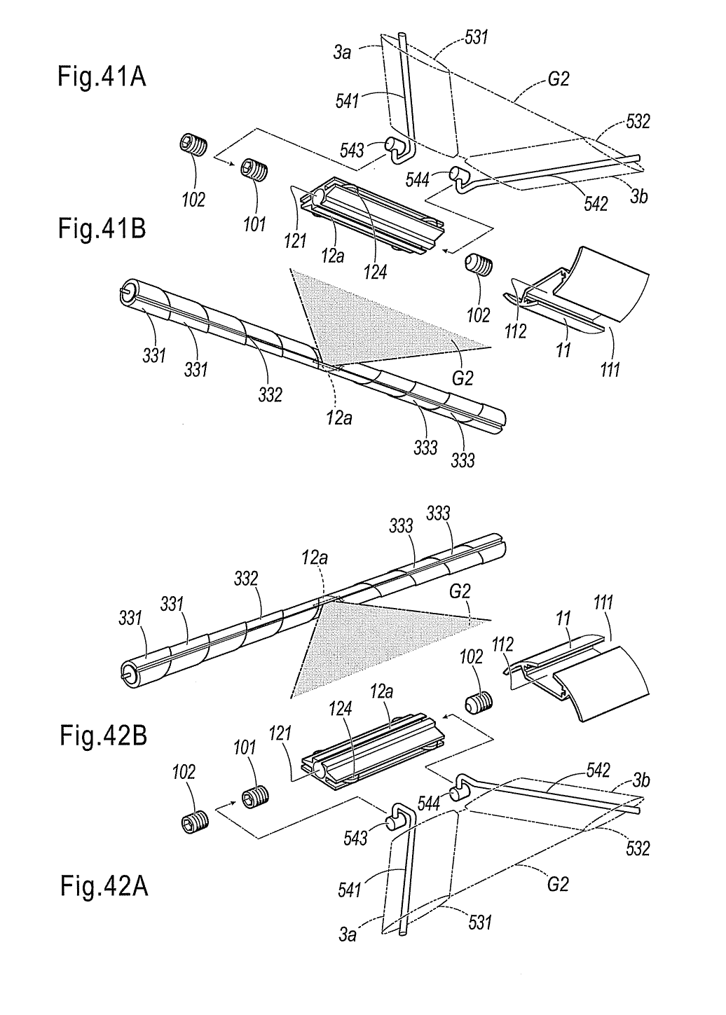

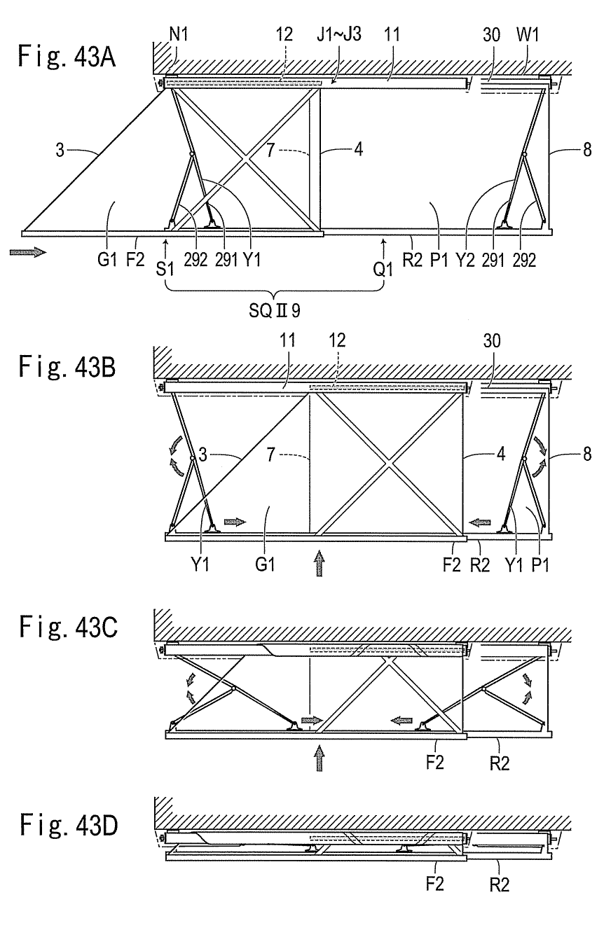

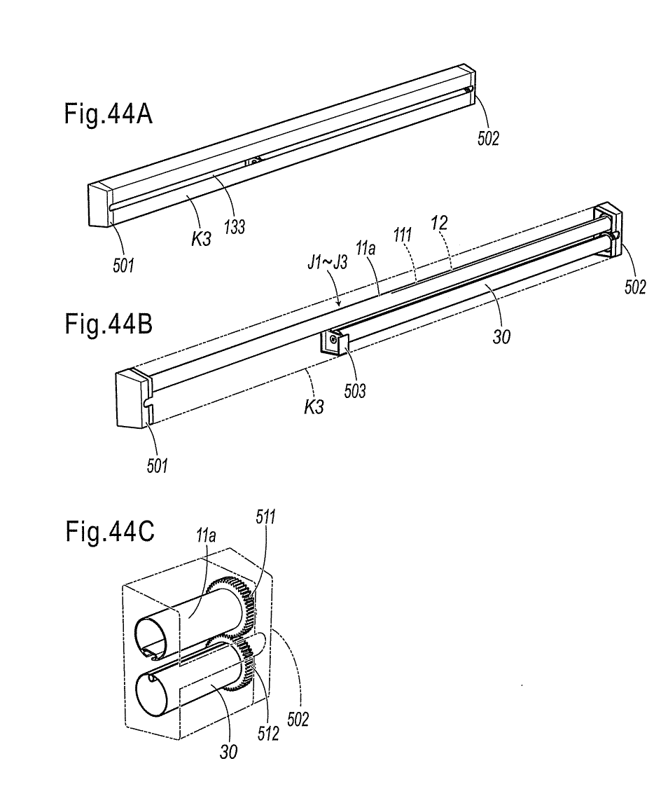

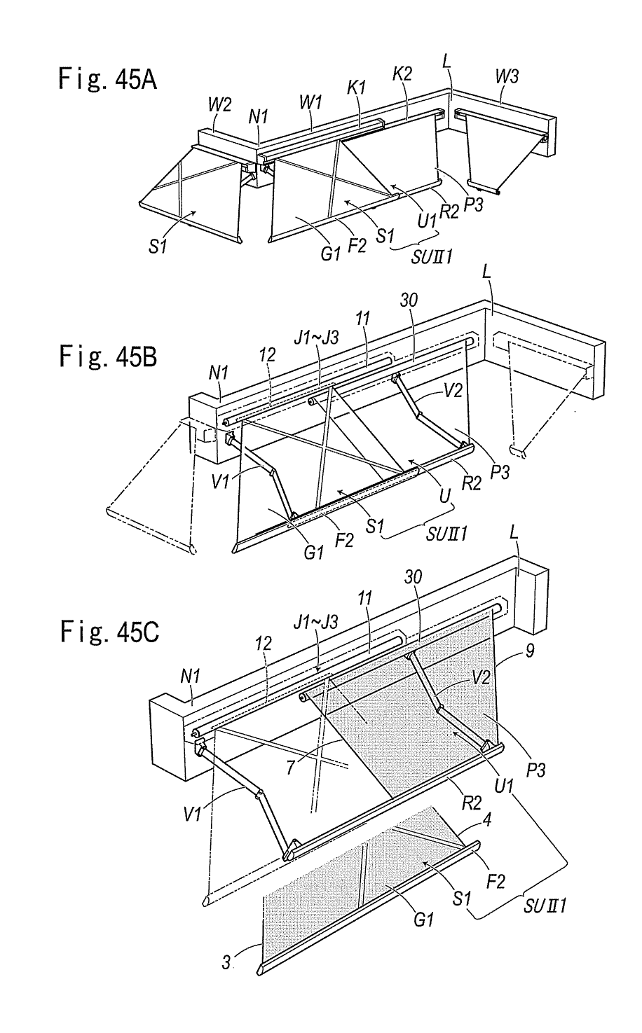

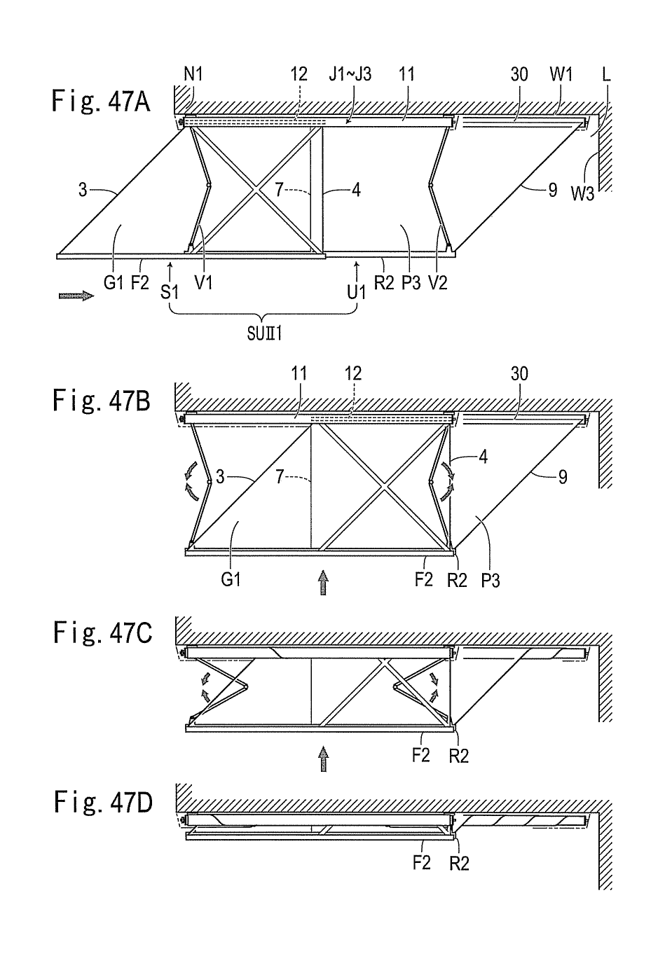

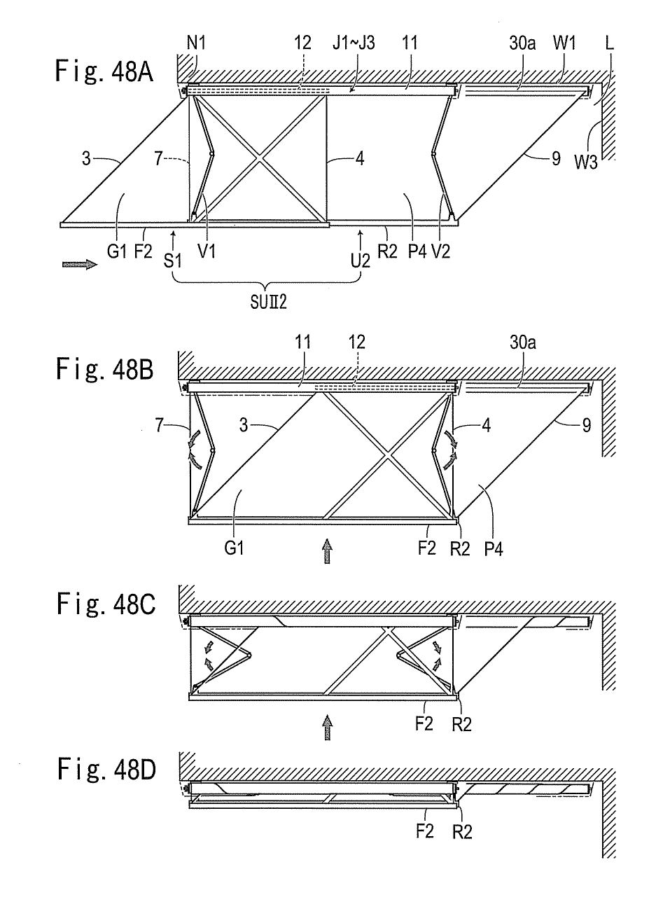

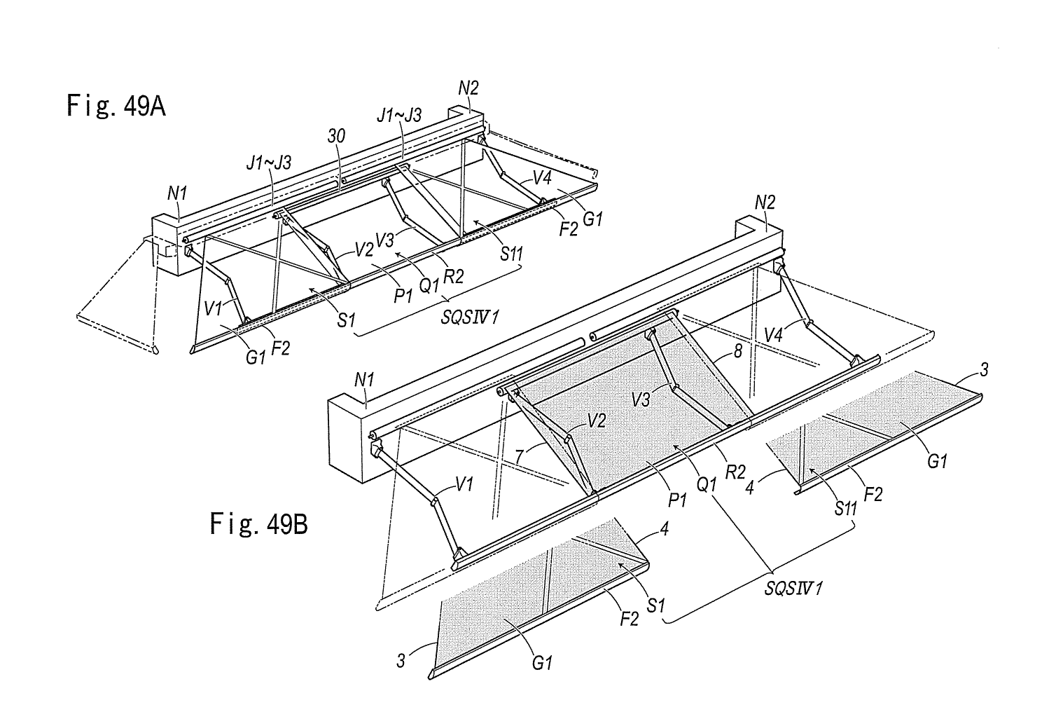

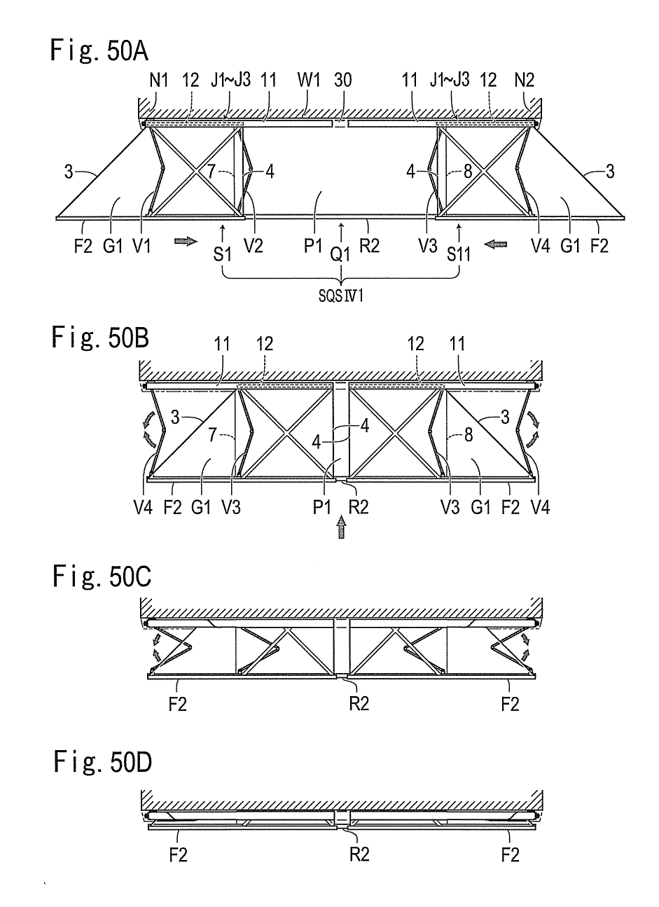

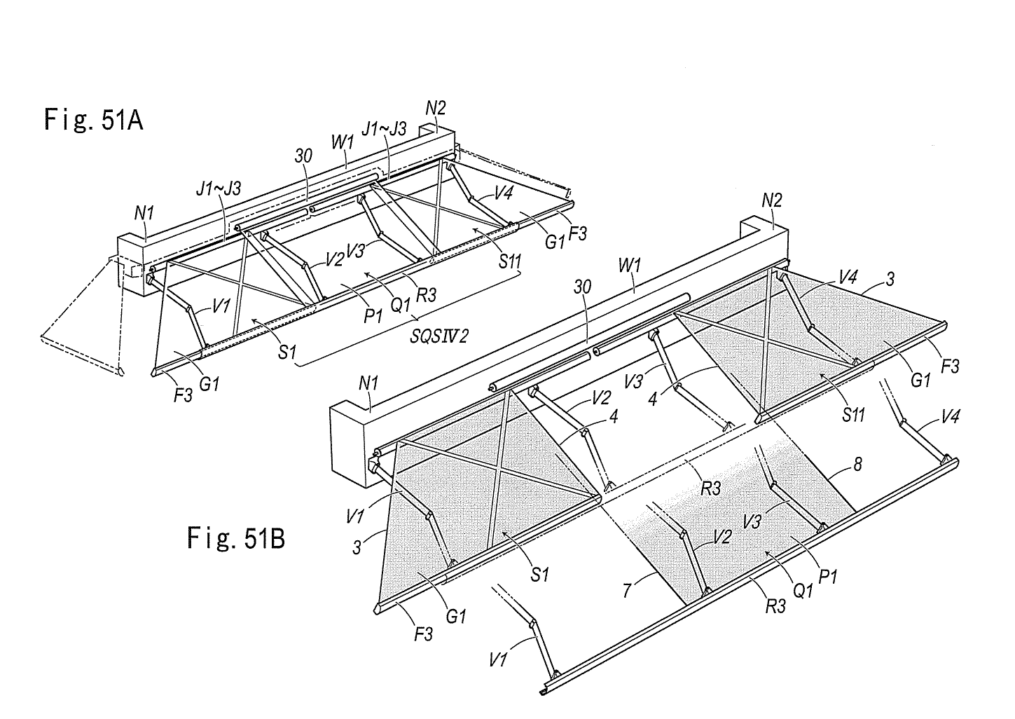

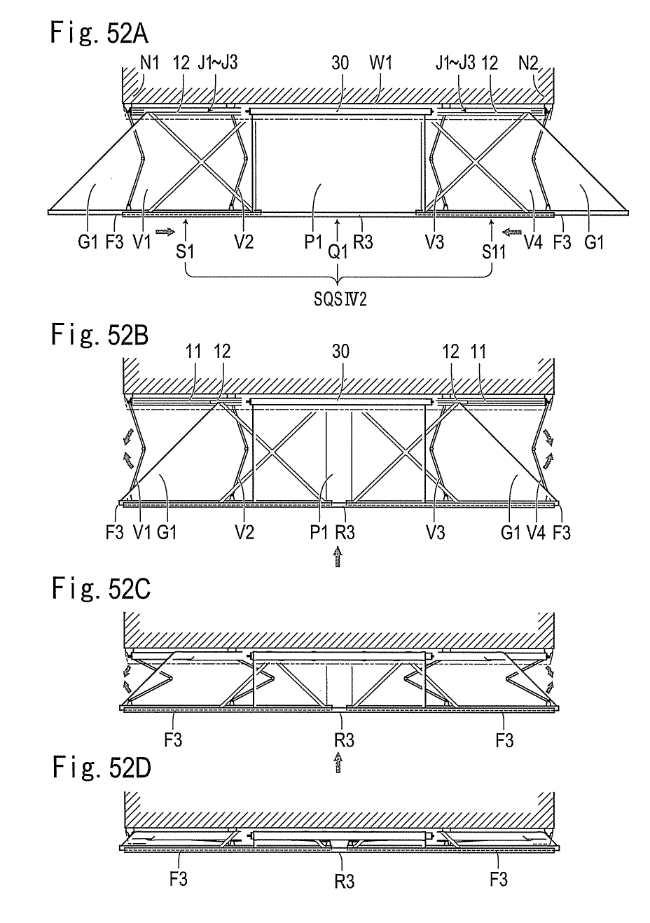

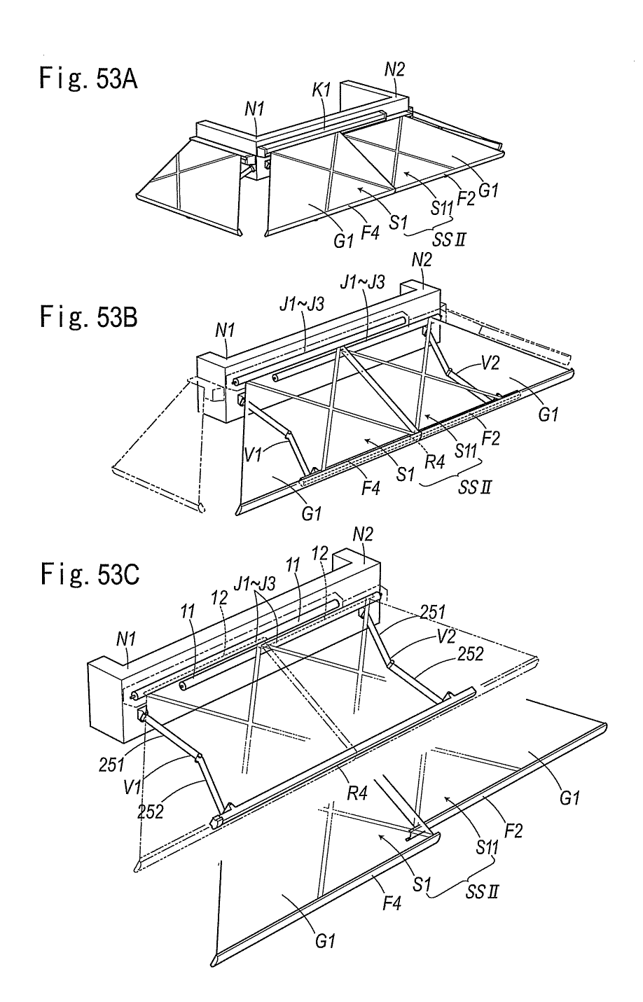

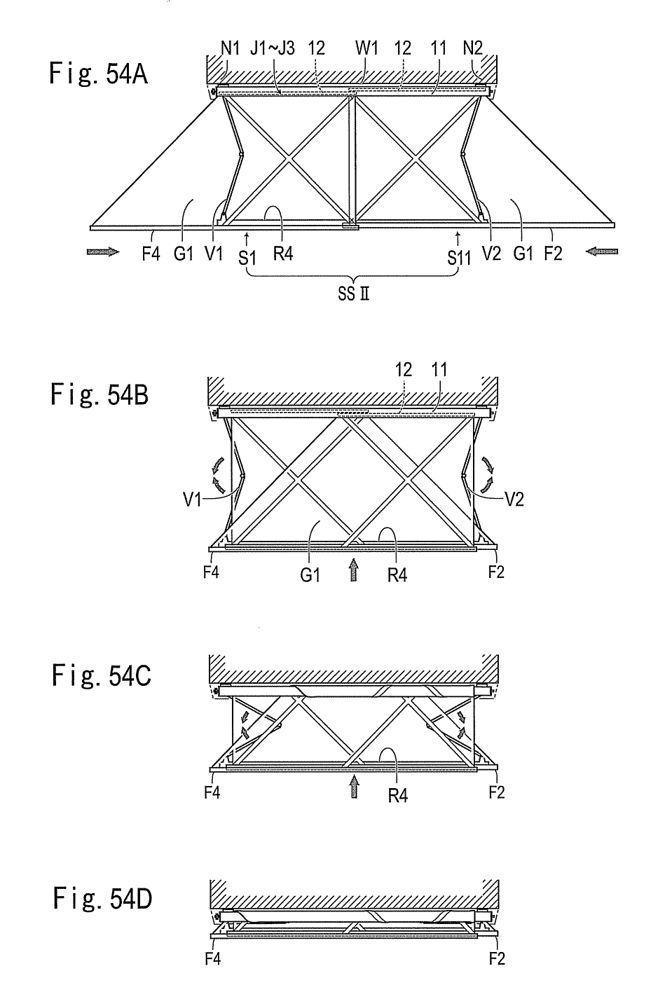

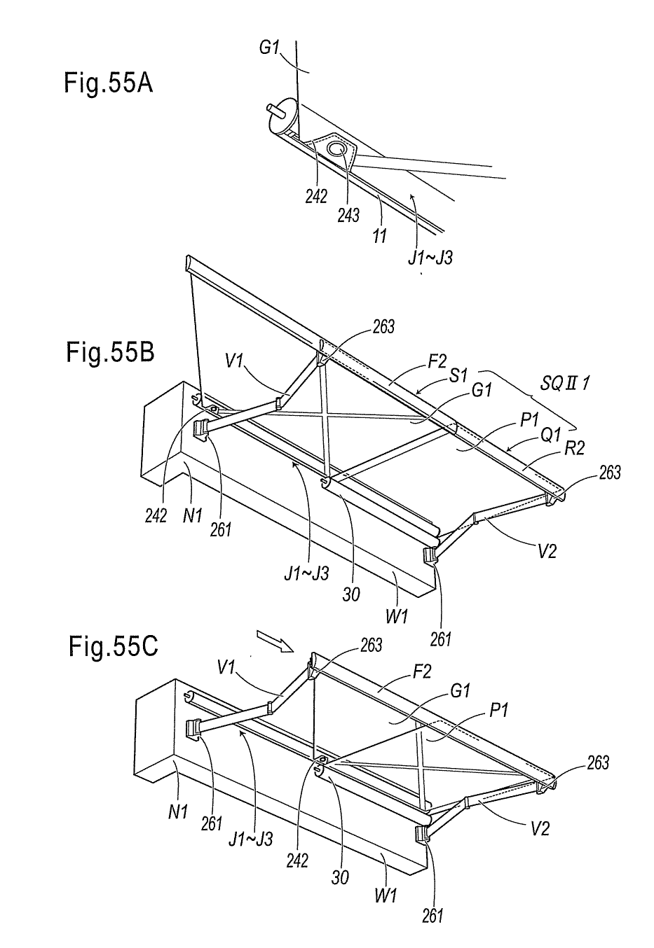

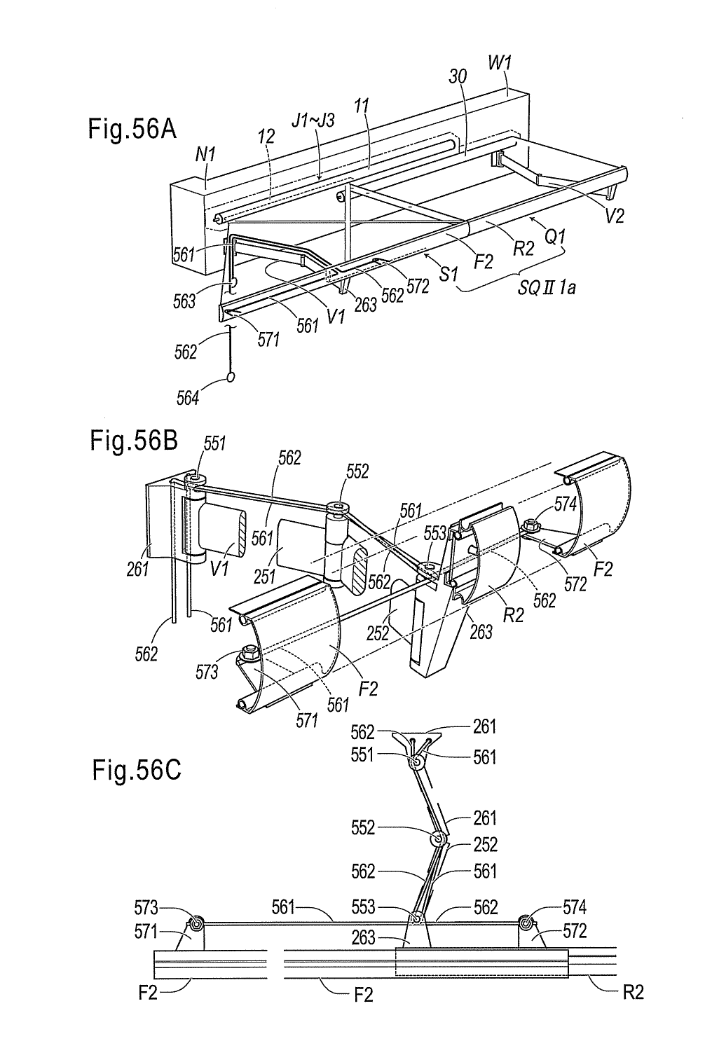

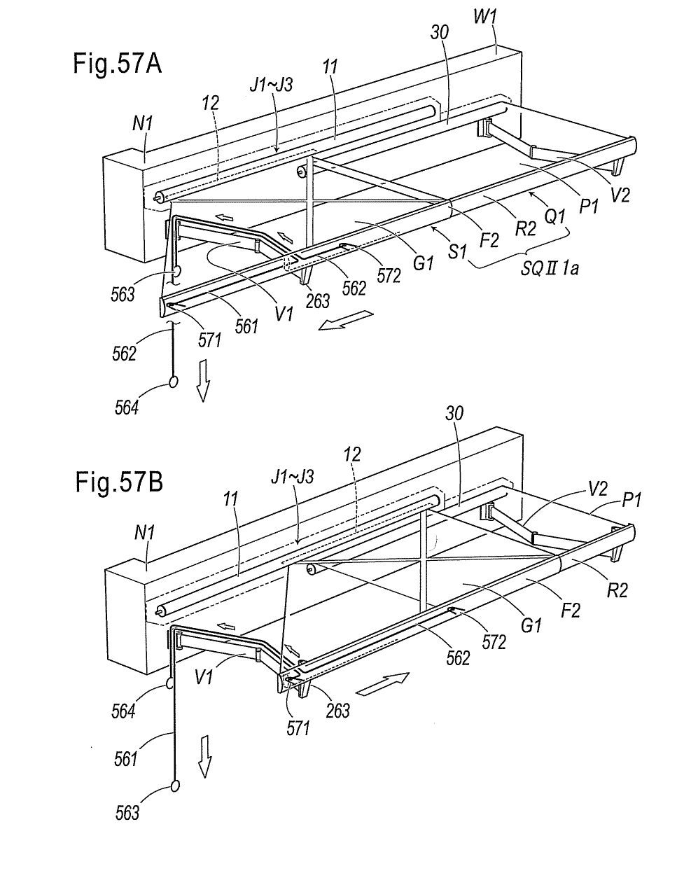

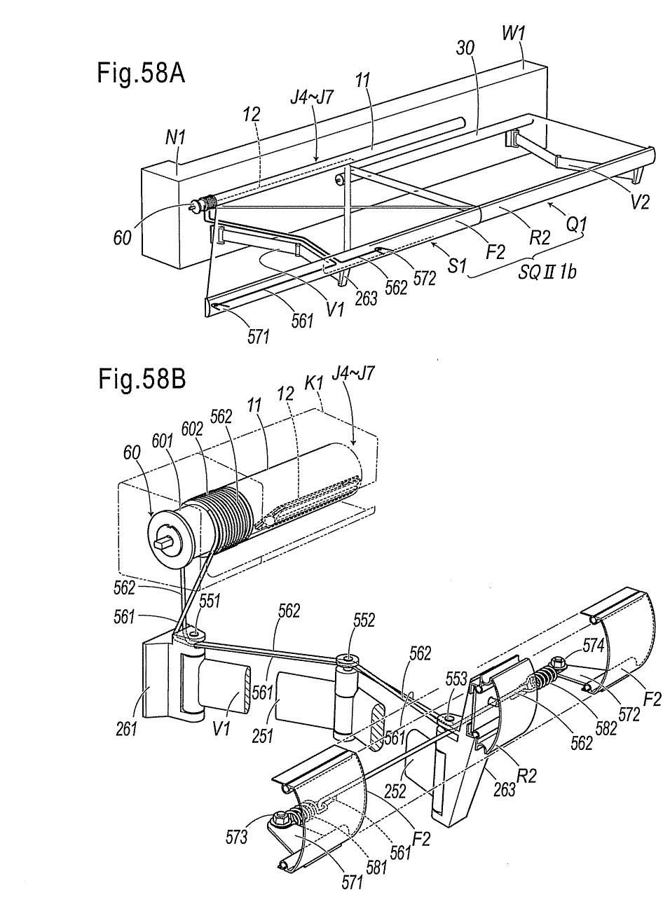

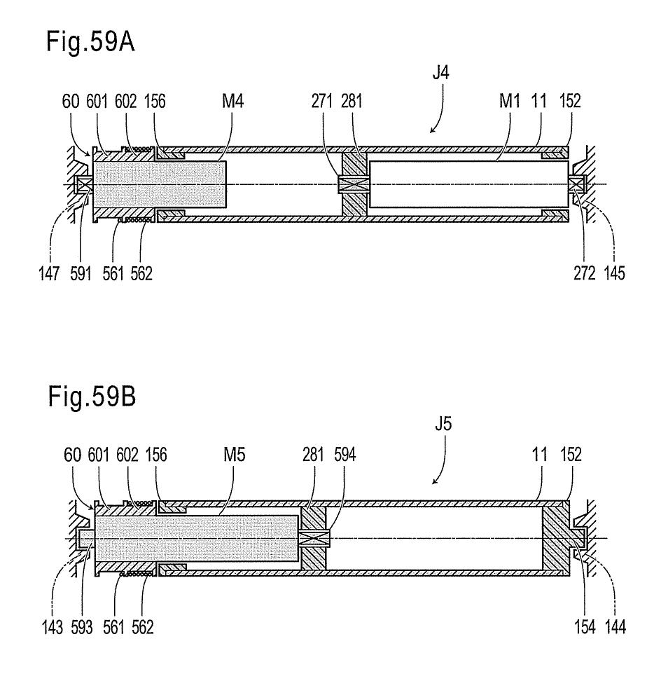

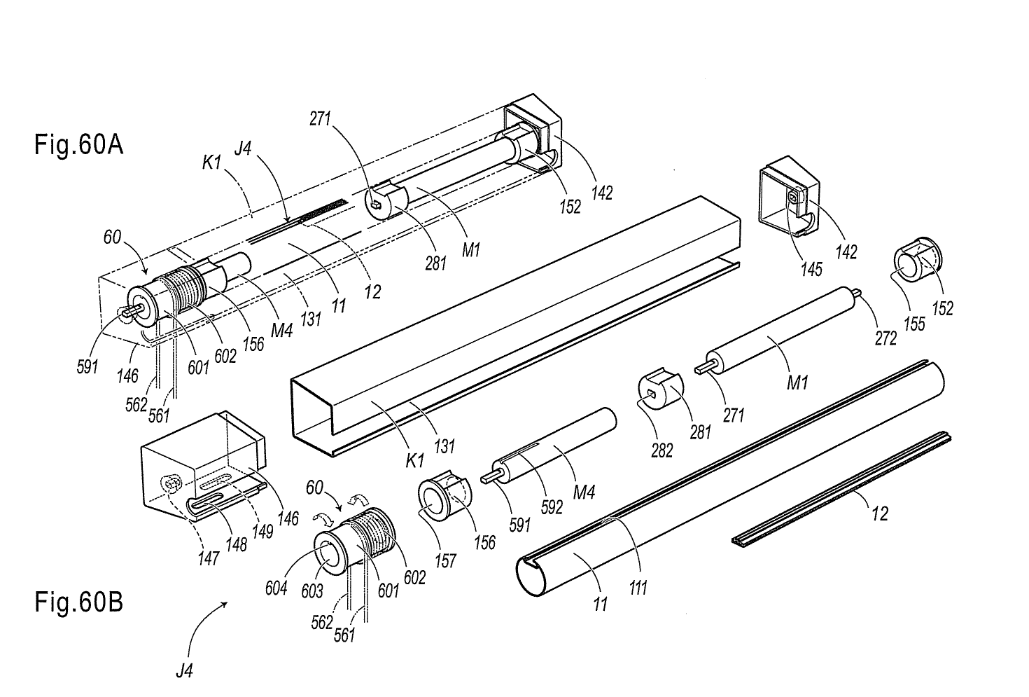

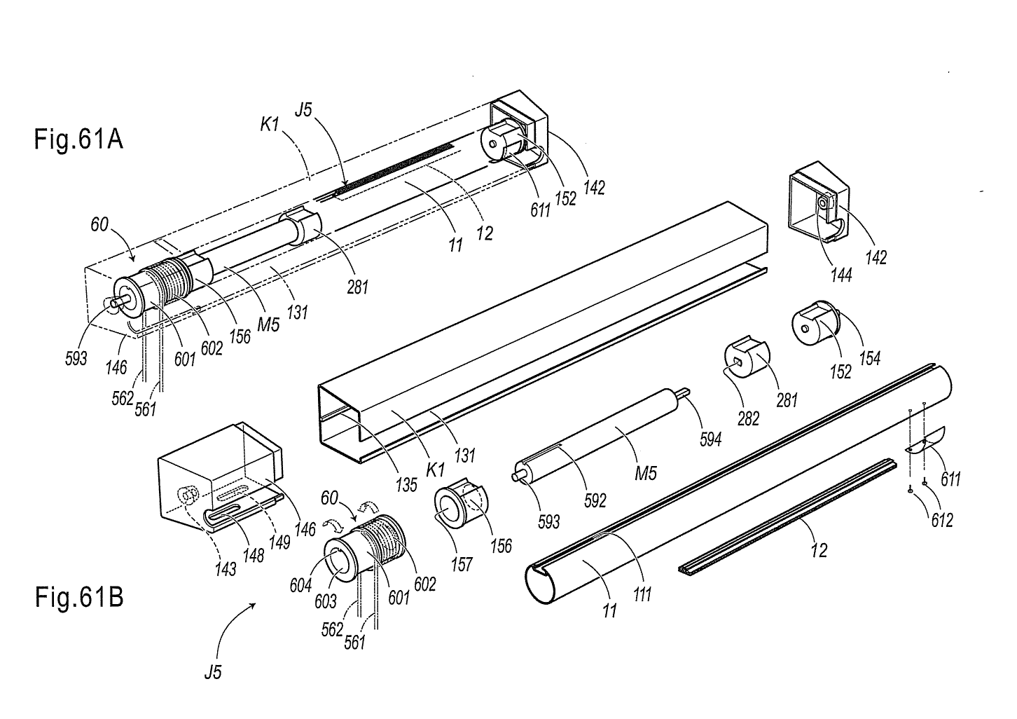

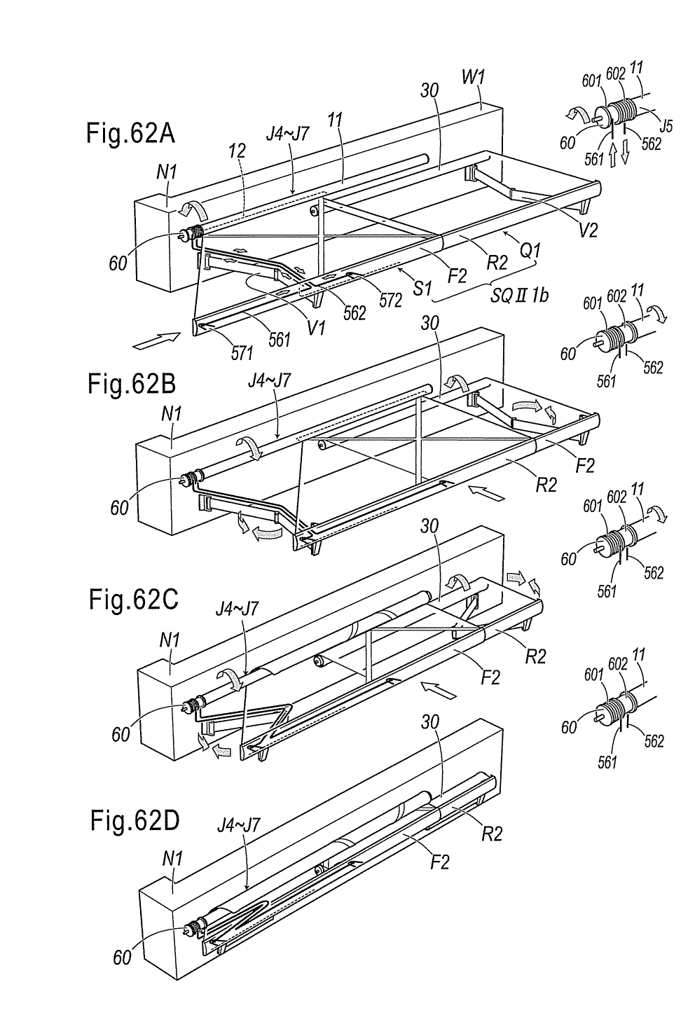

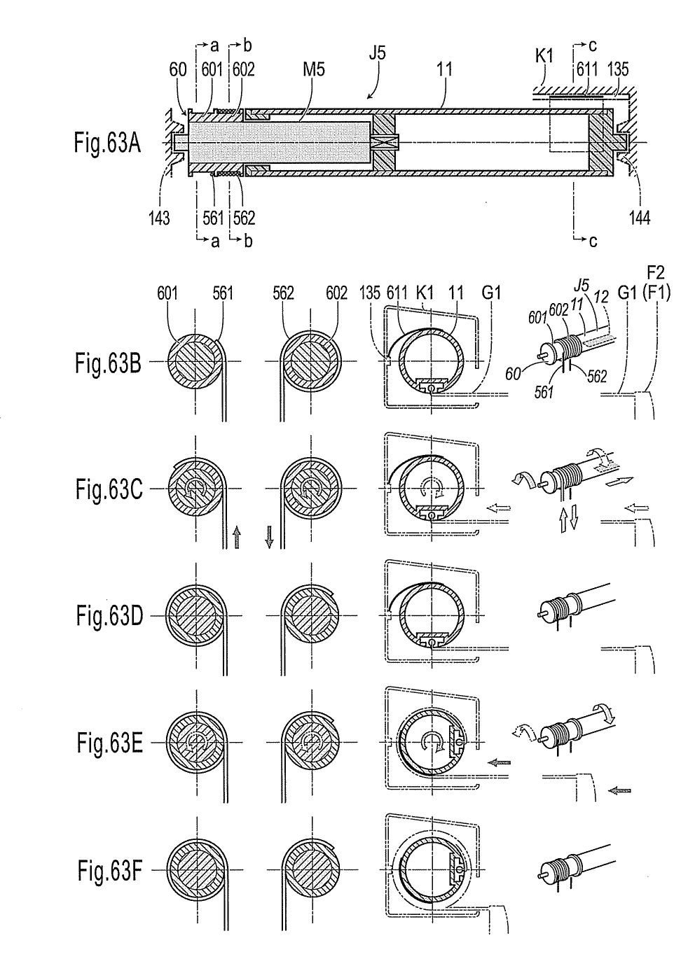

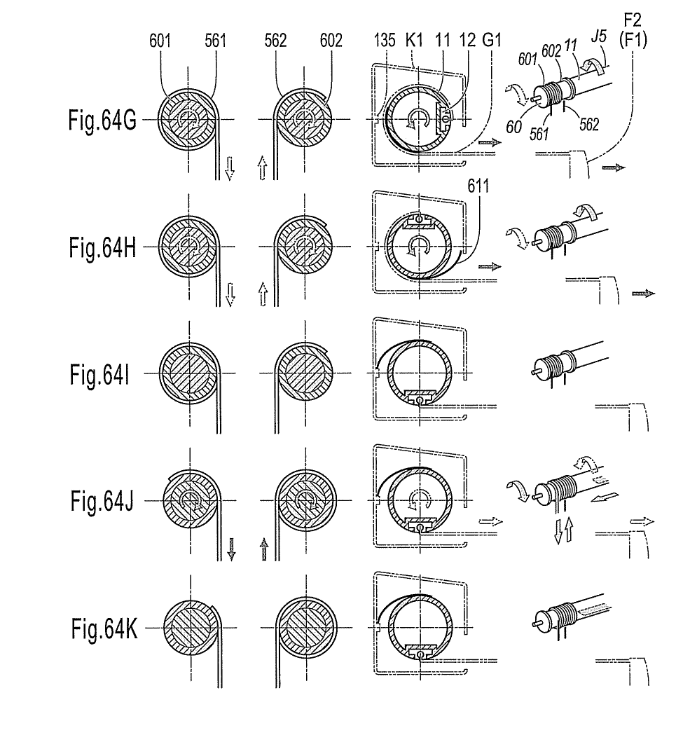

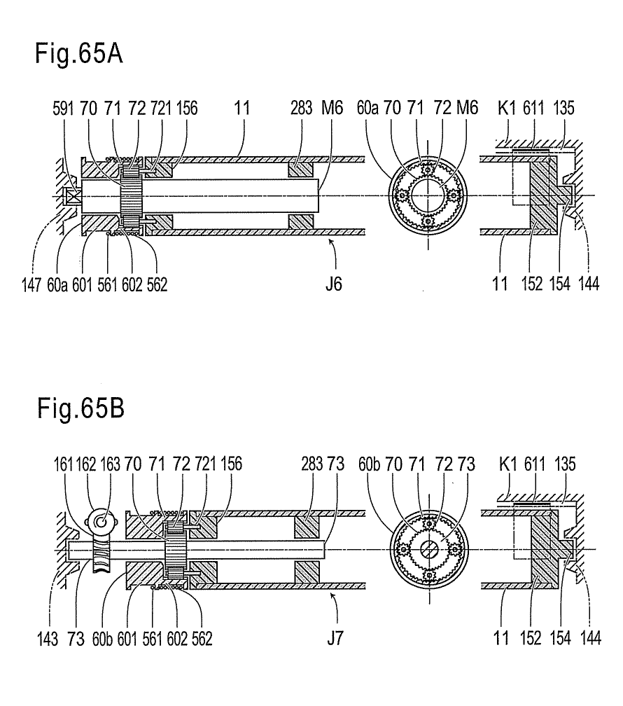

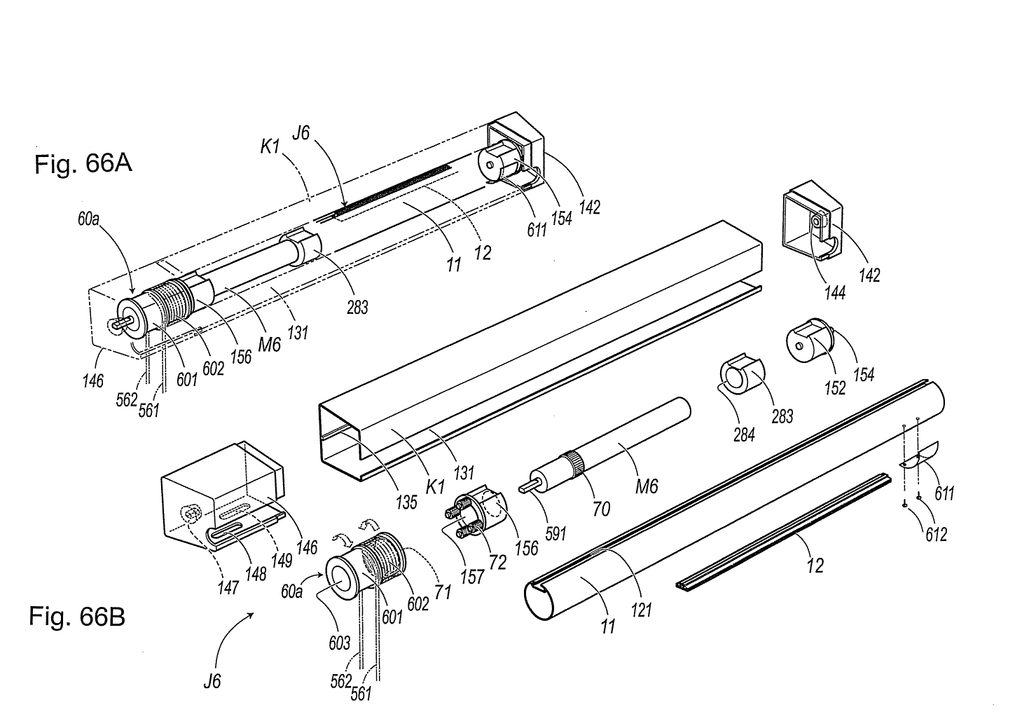

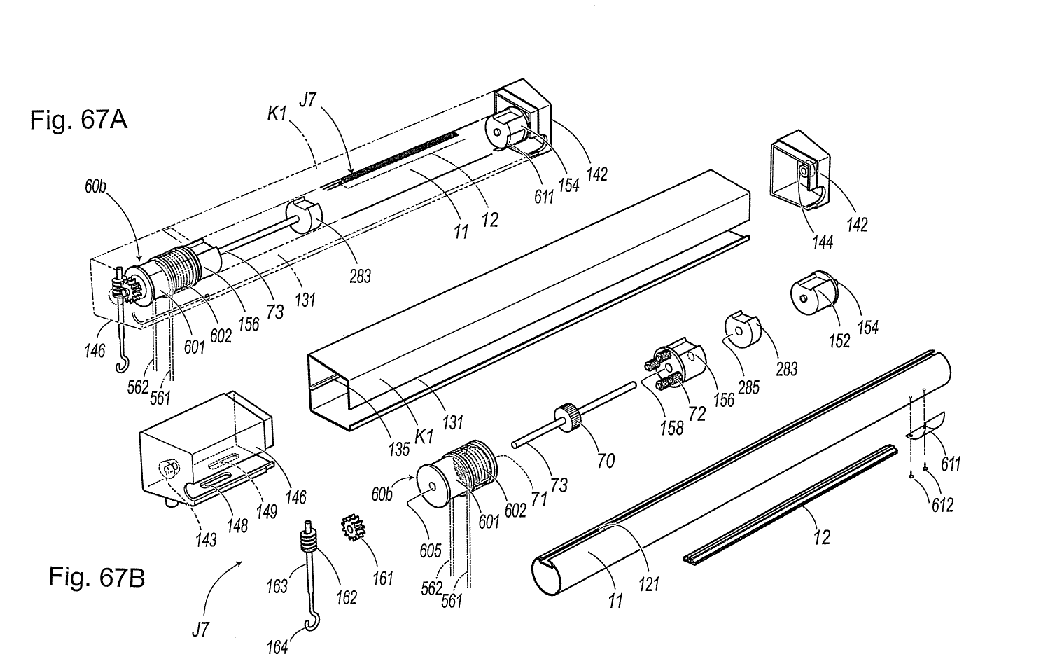

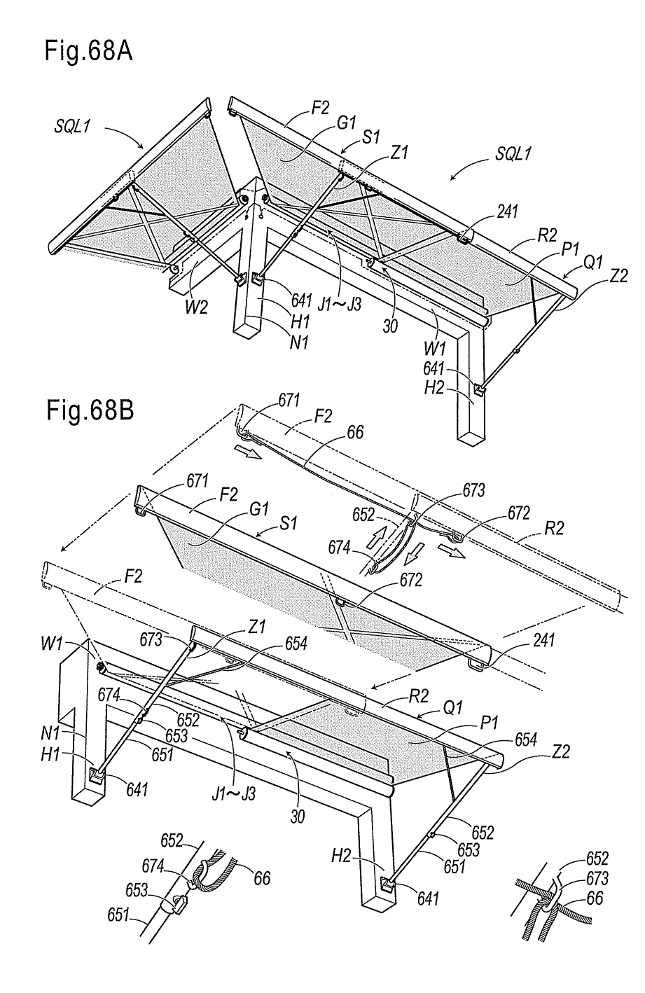

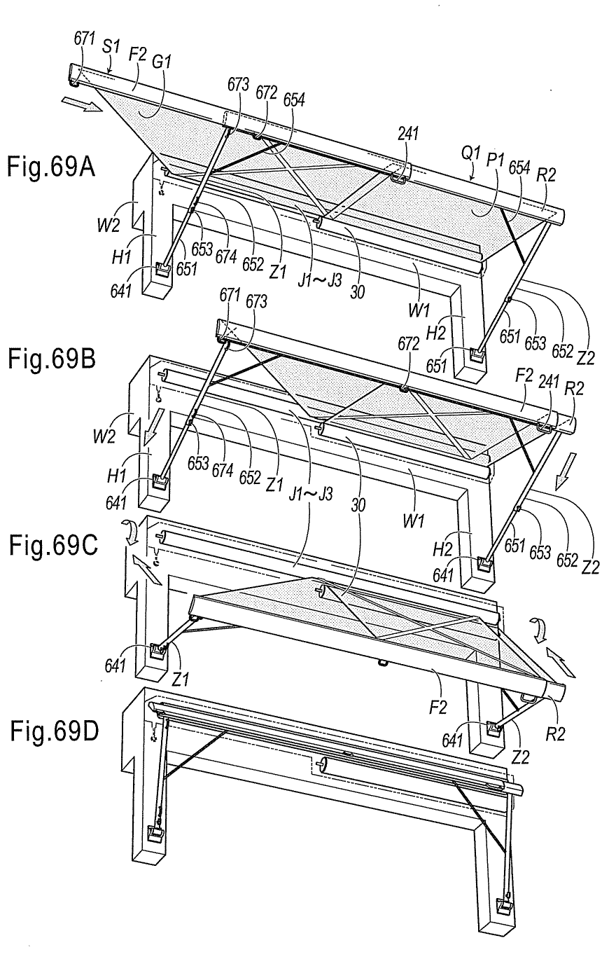

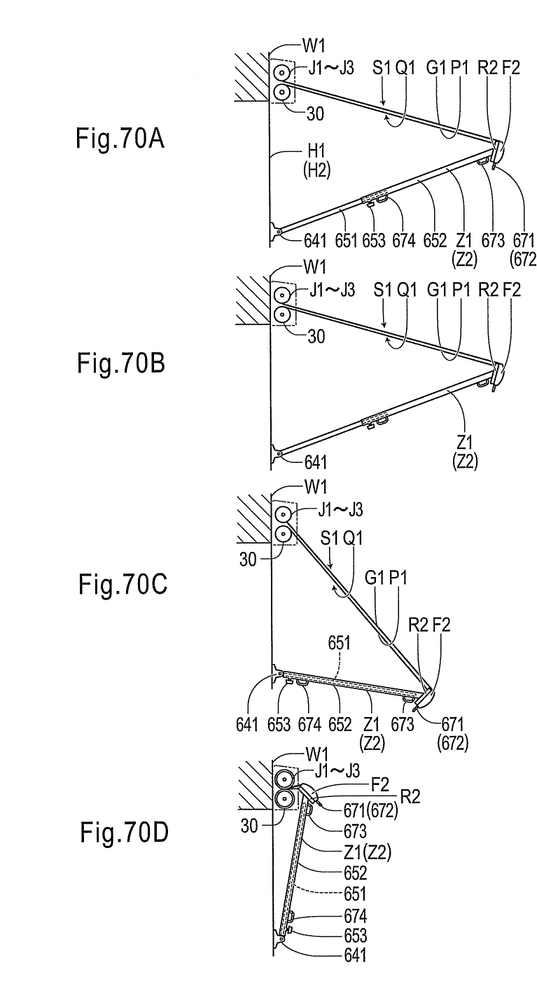

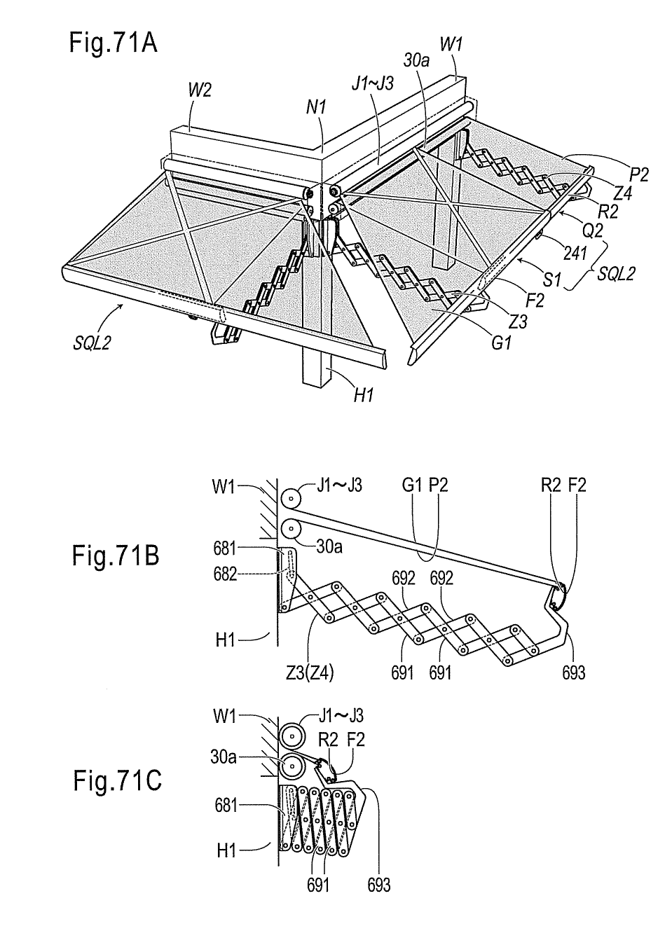

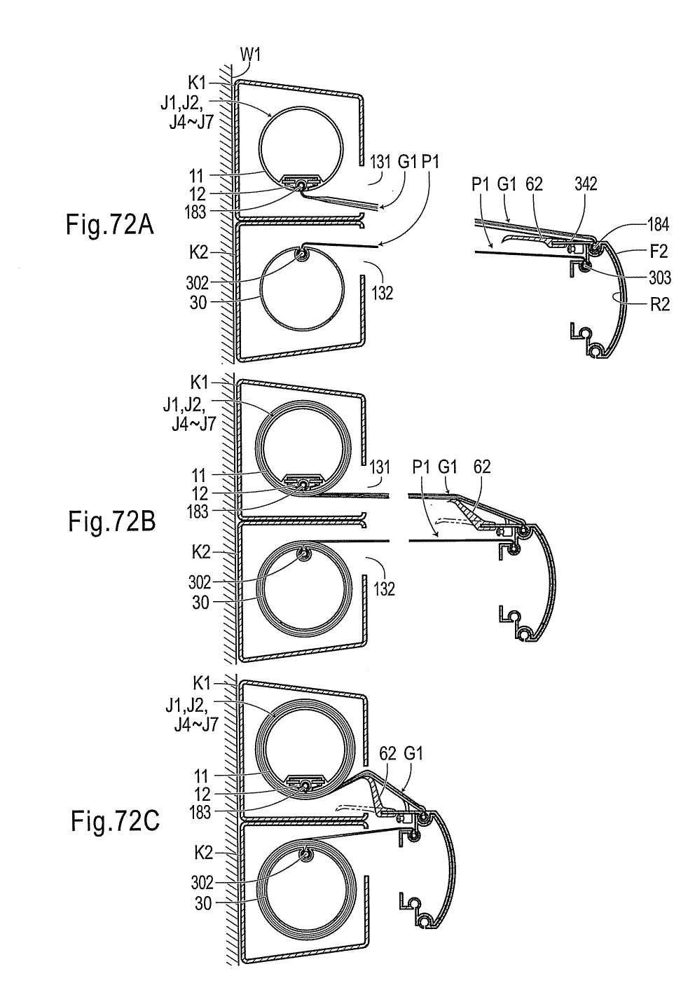

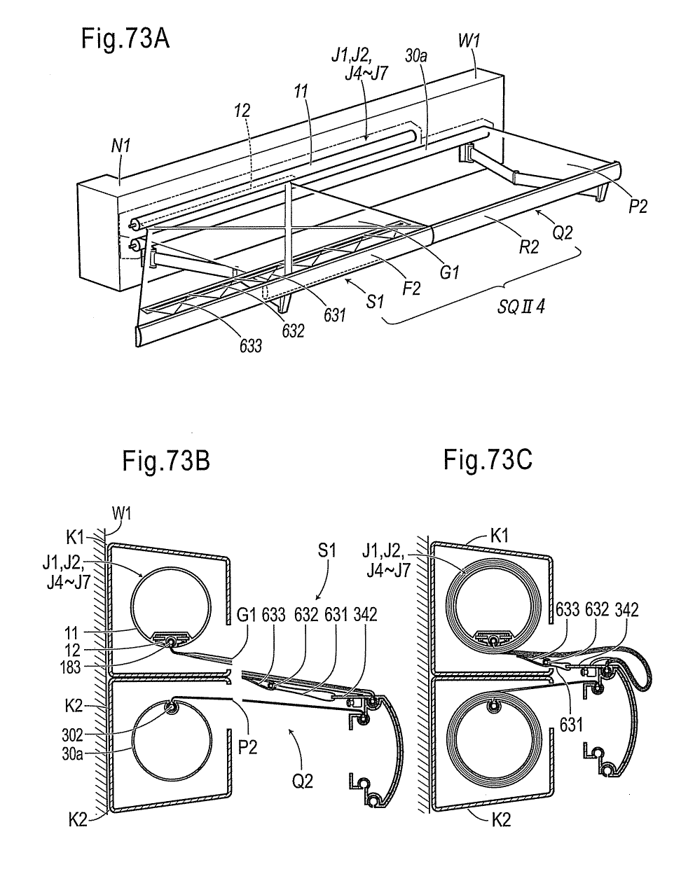

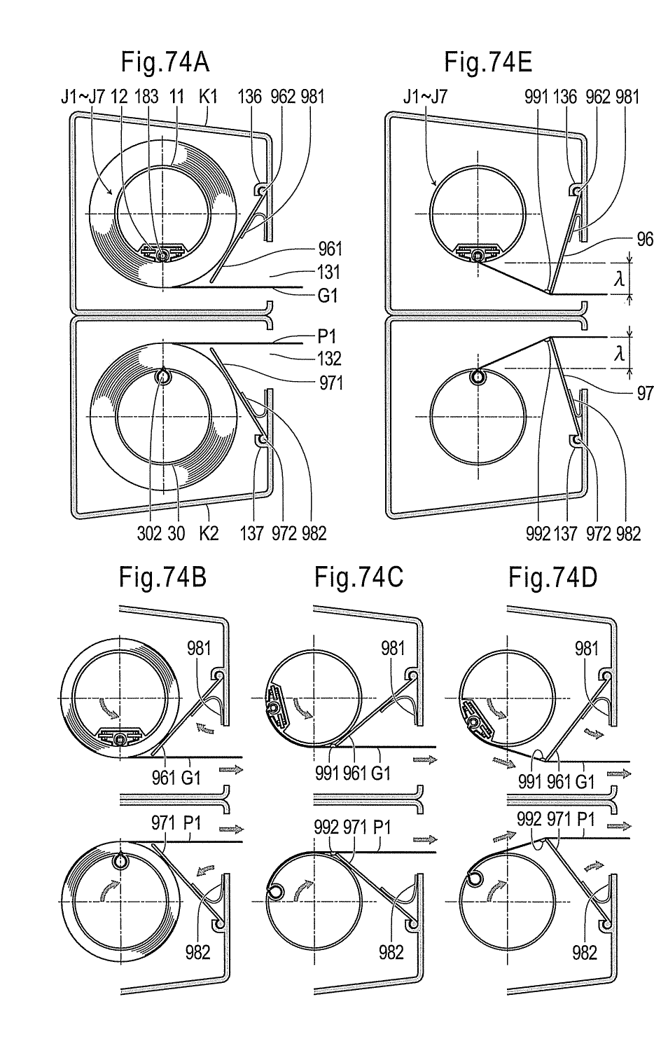

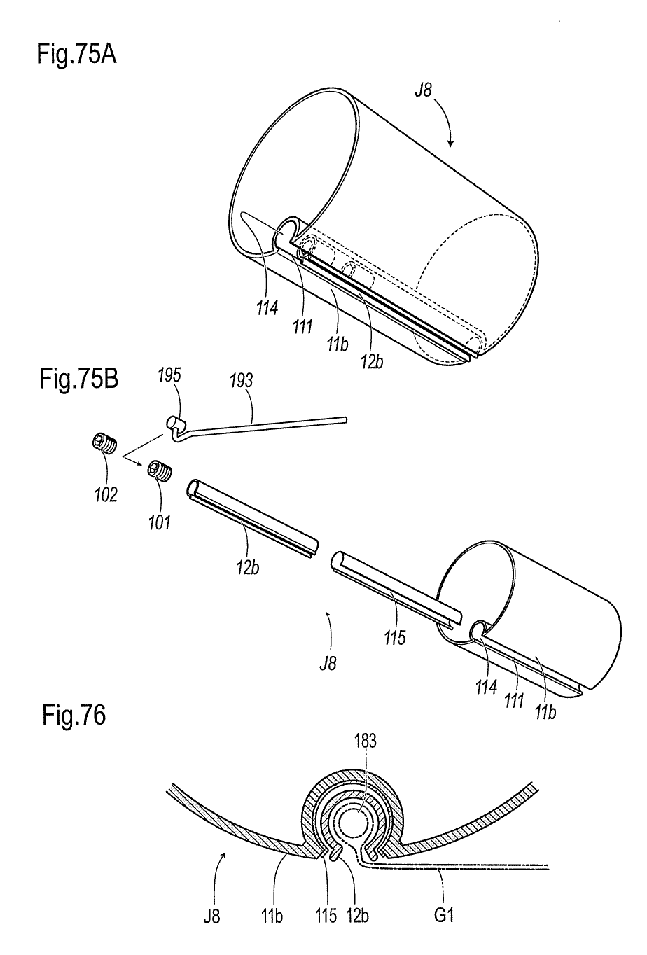

FIGS. 22(A) and 22(B) are diagrams showing the linked structure of single devices which are located on the two sides of a projected corner portion; FIG. 22(A) shows the structure of engagement of helical gears or bevel gears; FIG. 22(B) shows a manually operable gear linking device;

FIGS. 23 to 44 show a foldable arm system complex awning device, which is a complex device in the first group, where an awning device for a projected corner and a rectangular awning device are combined according to an embodiment;

FIGS. 23(A) and 23(3) are perspective diagrams showing a complex device SQII1 according to the first example, where the devices are on the two sides of a projected corner portion;

FIGS. 24(A) and 24(B) are diagrams showing a complex device SQII1 with the canvases transparent; FIG. 24(B) shows a projected corner canvas and the front bar thereof in a separated state from the front bar of the rectangular canvas;

FIG. 25 is a longitudinal cross sectional diagram showing a main portion of the complex device SQII1, and a foldable arm for supporting the front bar and brackets of two end portions, in the front and in the rear, of the foldable arm with imaginary lines;

FIGS. 26(A) to 26(C) are perspective diagrams showing a longitudinal cross section of a portion where a projected corner canvas and a rectangular canvas overlap and surrounding portions; FIG. 26(B) shows the rear portion of a slider and a projected corner canvas, and the base portion and front end portion of a connection wire which penetrates through the canvas with the canvas transparent in upper, middle and lower portions; FIG. 26(C) respectively shows the front bar of a projected corner canvas in a right portion and the front bar of a rectangular canvas and the brackets thereof in a left portion;

FIGS. 27(A) and 27(B) are a plan diagram showing a lateral cross section of a complex device SQII1 and a front diagram showing a longitudinal cross section of the complex device SQII1, and a winding roller for a projected corner canvas and a winding roller for a rectangular canvas provided side by side at a distance from each other in the up-down direction in the case where they are supported in the respective casings at the two ends;

FIGS. 28(A) and 28(B) are perspective diagrams showing a main portion of a winding device for a rectangular canvas in which an electric motor is incorporated and the components thereof;

FIGS. 29(A) and 29(B) are perspective diagrams showing a main portion of a winding device for a projected corner canvas in which a coil spring is incorporated and the components thereof;

FIGS. 30(A) and 30(B) are perspective diagrams showing a main portion of a winding device for a rectangular canvas in which a coil spring is incorporated and the components thereof;

FIGS. 31(A) and 31(B) are perspective diagrams showing a spread rectangle which is the canvas attached to a rear half portion of a winding roller and a front bar; FIG. 31(A) shows a case where connection wires for supporting the canvas in a tense state penetrate through holes which cross in X shape created in the main body portion of the canvas, and FIG. 31(B) shows a case where connection wires penetrate through holes created in V shape;

FIGS. 32(A) to 32(D) and FIGS. 33(A) to 33(D) are perspective diagrams and plan diagrams showing a projected corner canvas which is projected in a corner space portion, a rolled-up projected corner canvas and the process through which a rectangular canvas is wound, and when the diagrams are seen in reverse order, they show the process through which the two canvases are unwound and spread, and the process through which the projected corner canvas moves forward to the corner space portion;

FIGS. 34(A) to 34(D) and FIGS. 35(A) to 35(D) are perspective diagrams showing a complex device SQII2·3 having a synchronizing belt according to the second and third embodiments, and a projected corner canvas which is projected in a corner space portion, a rolled-up projected corner canvas and the process through which a rectangular canvas is wound;

FIGS. 36(A) to 36(D) are perspective diagrams showing a complex device SQII4 according to the fourth embodiment, where the rectangular canvas and the roller for winding the rectangular canvas extend to the vicinity of the corner of the front end portion of the device; FIGS. 36(B) to 36(D) show the process through which the projected corner canvas and the rectangular canvas that have moved away from the corner space portion are wound;

FIGS. 37(A) to 37(D) and FIGS. 38(A) to 38(D) are perspective diagrams showing a complex device SQII5·6 according to the fifth and sixth embodiments, where the positional relationship between the projected corner canvas and the rectangular canvas in the up-down direction is changed and a projected corner canvas which is projected in a corner space portion, a rolled-up projected corner canvas and the process through which the rectangular canvas is wound;

FIGS. 39(A) to 39(D) and FIGS. 40(A) to 40(D) are perspective diagrams showing a complex device SQII7·8 according to the seventh and eighth embodiments, where the projected corner canvas is approximately in a triangular form, and a triangular canvas which is projected in a corner space portion, a rolled-up triangular canvas and the process through which the rectangular canvas is wound;

FIGS. 41(A) and 41(B) and FIGS. 42(A) and 42(B) are perspective diagrams showing a case where a triangular canvas is wound around a winding roller of a complex device SQII7·8 from beneath and a case where the canvas is wound from above; FIGS. 41(A) and 42(A) are exploded diagrams showing a triangular canvas in the state before the top hem is attached to the slider, and FIGS. 41(B) and 42(B) show the positional relationship between the winding roller and the triangular canvas having a bulk ring when the triangular canvas is wound around the winding roller;

FIGS. 43(A) to 43(D) are plan diagrams showing a complex device SQII9 according to the ninth embodiment, where foldable arms are in reverse y shape, and the projected corner canvas which is projected in a corner space portion, a rolled-up projected corner canvas and the process through which the rectangular canvas is wound;

FIGS. 44(A) to 44(C) are perspective diagrams showing integrated casings for winding and storing a corner projected canvas and a rectangular canvas according to an embodiment; FIG. 44(C) shows an engagement structure where the rear end portion of the winding rollers of the two canvases are engaged through a spur gear;

FIGS. 45(A) to 45(C) are perspective diagrams showing a complex device SUII1 in the second group made up of an awning device for a projected corner and an awning device for a recessed corner according to the first embodiment; FIG. 45(C) shows a projected corner canvas and the front bar thereof in a state where the two are separated in the front-rear direction;

FIG. 46 is a perspective diagram showing a recessed corner canvas in a reverse trapezoid form with right angles spread between the winding roller and the front bar in a tense state, and a case where connection wires for tensing the canvas penetrate through holes created in the main body portion of the canvas so as to cross in an X shape;

FIGS. 47(A) to 47(D) and FIGS. 48(A) to 48(D) are plan diagrams showing a complex device SUII1·2 according to the first and second embodiments, where the recessed corner canvas and the winding roller for the canvas have different lengths, and a projected corner canvas which is projected in a corner space portion, a rolled-up projected corner canvas and the process through which a recessed corner canvas is wound;

FIGS. 49(A) and 49(B) are perspective diagrams showing a complex device SQSIV1 in the third group which is attached between two projected corner portions according to the first embodiment; FIG. 49(B) shows a rectangular awning device in a middle portion in such a state that the front portion of the awning device for a projected corner in front and rear portions is separated to the front;

FIGS. 50(A) to 50(D) are plan diagrams showing the process through which the complex device SQSIV1 operates; FIGS. 50(B) to 59(D) show two projected corner canvases in the front and in the rear that are rolled up in the vicinity of the center of the device, and the process through which the rectangular canvas is wound;

FIGS. 51(A) and 51(B) are perspective diagrams showing a complex device SQSIV2 according to the second embodiment, where a rectangular awning device in the middle portion is combined with upper portions of the awning devices for a projected corner in front and rear portions; FIG. 51(B) shows how the front portion of the rectangular awning device in the middle portion is separated to the front;

FIGS. 52(A) to 52(D) are plan diagrams showing the process through which the complex device SQSIV2 operates; FIGS. 52(B) to 52(D) show two projected corner canvases in the front and rear that have been moved backward to the vicinity of the center of the device, and the process through which the rectangular canvas is wound;

FIGS. 53(A) to 53(C) are perspective diagrams showing a complex device SSII in the fourth group, where two awning devices for a projected corner which are combined in front-rear symmetry so that the backs face each other are attached between the two projected corner portions so as to shift in the up-down direction; FIG. 53(C) shows the front bars of the awning devices for a projected corner in the front and rear portions in such a state as to be separated to the front from the transverse guide rail in the middle portion;

FIGS. 54(A) to 54(D) are plan diagrams showing the process through which the complex device SSII operates; FIGS. 54(B) to 54(D) show the process through which the two projected corner canvases are wound;

FIGS. 55(A) to 55(C) are perspective diagrams showing a complex device SQII1·5, where an engaging flap for the operation of moving a projected corner canvas transversely is formed; FIG. 55(A) shows an enlarged portion of the engaging flap; FIGS. 55(B) and 55(C) show the projected corner canvas in a projected state in a corner space portion and in a state where the canvas has slid backward;

FIGS. 56(A) to 56(C) are a perspective diagram and a plan diagram showing the entirety and a main portion of a complex device SQII1a, where a movement conveying rope for manual operation which transversely slides the projected corner canvas runs between a V-shaped arm and the front bar;

FIGS. 57(A) and 57(B) are perspective diagrams showing the process through which the projected corner canvas slides backward and forward by means of a movement conveying rope;

FIGS. 58(A) and 58(B) are perspective diagrams showing the entirety and a main portion of a complex device SQII1b in which a movement conveying wire which runs between a V-shaped arm and the front bar and a winding reel for the wire are incorporated;

FIGS. 59(A) and 59(B) are schematic diagrams showing a longitudinal cross section of a winding roller in which a winding reel is incorporated; FIG. 59(A) shows a case where the winding reel and the winding roller are individually rotated by means of two electric motors, and FIG. 59(B) shows a case where the winding reel and the winding roller are driven by one electric motor, which rotates in both directions;

FIGS. 60(A) and 60(B) are exploded perspective diagrams showing a main portion of a canvas winding device in which the winding roller shown in FIG. 59(A) according to the fourth example is incorporated, and the components thereof;

FIGS. 61(A) and 61(B) are exploded perspective diagrams showing a main portion of a canvas winding device in which the winding roller shown in FIG. 59(B) according to the fifth example is incorporated, and the components thereof;

FIGS. 62(A) to 62(D) are perspective diagrams showing the process through which a complex device SQII1b in which a winding reel is incorporated operates, the process through which the projected corner canvas which is projected in a corner space portion slides backward, the rolled-up projected corner canvas, and the process through which the rectangular canvas is wound;

FIG. 63(A) is a schematic diagram showing the winding roller according to the fifth example, and a plan diagram showing a lateral cross section of the rotating stopper of the winding roller, FIGS. 63(B) to 63(F) are diagrams showing the process through which the projected corner canvas which is projected in a corner space portion moves backward and after that is wound around a winding roller so as to be stored step by step, and cross sectional diagrams along line a-a, b-b and c-c in FIG. 63(A), from the left of each diagram, and perspective diagrams showing the main portion in each step are added to the right;

FIGS. 64(G) to 64(K) are diagrams showing the process through which the projected corner canvas is unwound and spread, and furthermore, the process through which the canvas moves forward toward the corner space portion so as to be spread in a tense state step by step and laid out in the same positional relationship as in the case of FIGS. 63(B) to 63(F);

FIGS. 65(A) and 65(B) are schematic diagrams showing longitudinal cross sections of winding rollers according to the sixth and seventh examples, where a differential gear mechanism is incorporated; FIG. 65(A) shows a case where the winding reel and the winding roller are driven by means of one electric motor, and FIG. 65(B) shows a case where the winding reel and the winding roller are driven by means of a manually operable device;

FIGS. 66(A) and 66(B) are exploded perspective diagrams showing a main portion of a canvas winding device in which the winding roller according to the sixth example shown in FIG. 65(A) is incorporated, and the components thereof;

FIGS. 67 (A) and 67(B) are exploded perspective diagrams showing a main portion of a canvas winding device in which the winding roller according to the seventh example shown in FIG. 65(B) is incorporated, and the components thereof;

FIGS. 68 to 71 are diagrams showing the complex devices SQL1·2 according to the first and second embodiments of lateral arm type complex awning devices;

FIGS. 68(A) and 68(B) are perspective diagrams showing a complex device SQL1, where devices are on the two sides of a projected corner portion as viewed from beneath; FIG. 68(B) is an exploded diagram showing a projected corner canvas, the front bar thereof and a movement conveying rope for operating and sliding the projected corner canvas in a hung state, as well as enlarged portions through which the movement conveying rope penetrates in the left and right portions of the lowest portion;

FIGS. 69(A) to 69(D) and FIGS. 70(A) to 70(D) are perspective diagrams and side diagrams showing the projected corner canvas which is projected in a corner space portion, the rolled-up projected corner canvas and the process through which the rectangular canvas is wound, and when the diagrams are seen in reverse order, they show the process through which the two canvases are unwound and spread and the process through which the spread projected corner canvas moves transversely forward to the corner space portion;

FIGS. 71(A) to 71(C) are diagrams showing a complex device SQL2 according to the second embodiment, where the foldable arms for the front bar are replaced with expandable links having a pantograph structure; FIG. 71(B) is a side diagram showing an expandable link in such a state as to be extended so as to pull out and spread the canvases on the upper portion side and the lower portion side, and FIG. 71(C) is a side diagram showing the two canvases in a rolled-up state and the expandable link in a pushed in and folded state;

FIGS. 72(A) to 72(C) are diagrams showing the process of operation of an elastic fluctuating flap which is attached to the front bar of the projected corner canvas;

FIGS. 73(A) to 73(C) are diagrams showing the rear surface close to the bottom hem of the projected corner canvas in the case where an expandable net for supporting the projected corner canvas in a tense state is spanned; FIG. 73(B) shows the longitudinal cross section when the canvas is spread; FIG. 73(C) shows the longitudinal cross section when the canvas is wound and stored;

FIGS. 74(A) to 74(E) are diagrams showing the process of operation of a fluctuating flap which is pressed and supported in such a manner so as to freely rise and lower inside the casing; FIG. 74(A) shows the canvases in such a state as to be wound and stored on the upper portion side and the lower portion side; FIG. 74(E) shows the fluctuating flap that has risen at the final stage, when the canvas is spread, and thus narrowed the gap in the vicinity of the opening through which the canvas is pulled out; FIGS. 74(B) to 74(D) show the state in the middle steps, between FIGS. 74(A) and 74(E), and also a state where the fluctuating flap rises or lowers when engaged with a protrusion in a location just before the top hem of the canvas;

FIGS. 75(A) and 75(B) are exploded diagrams showing a winding roller according to the eighth example, where the slider incorporated in the winding rollers according to the first to seventh examples is replaced with a slide cap; and

FIG. 76 is a cross sectional diagram showing an enlarged main portion of the slide cap which is engaged in the top hem of the projected corner canvas and supportedly inserted in the slide guide path and the guide trench of the main body of the roller in such a state as to be movable.

### BEST MODE FOR CARRYING OUT THE INVENTION

In the following, the embodiments of the present invention are described in reference to the accompanying drawings. First, the foldable arm type single awning device shown in FIGS. 1 to 22 and related configurations are described, and second, the foldable arm type complex awning device shown in FIGS. 23 to 54 and related configurations are described. In addition, embodiments in the case where the projected corner canvases in the single devices and the complex devices are transversely slid by means of a movement conveying rope for manual operation as shown in FIGS. 56 and 67 and transversely slid by means of an electric motor or a manually operable device as shown in FIGS. 58 to 67 or driven for winding and unwinding are described.

Third, the lateral arm type complex awning device and related configuration shown in FIGS. 68 to 71 are described.

In addition, a device for supporting the canvas when it is stored and the canvas in a tense state when spread and a device for narrowing the gap between the canvases in a complex device are described.

### 1. Concerning Foldable Arm Type Single Awning Device

In the single devices S1a to S1d according to the present invention, a canvas winding device having a winding roller J1 or J2 for a projected corner canvas G1 and a front bar F1 and a canvas tensing device having a transverse guide rail R1 for the above described front bar F1 and foldable arms V1 and V2, Y1 and Y2 or I1 and I2 are organically combined.

### Concerning First Embodiment

The configuration of respective portions concerning the single device S1a according to the first embodiment and the process of operation of the single device are described in reference to FIGS. 1 to 11.

Concerning Canvas Winding Device

(1) Concerning First Example of Winding Roller

K1 is a casing for winding and storing a projected corner canvas G1, and the casing is attached directly to the outer wall W1 (front wall) or W2 (side wall) in the vicinity of the corner of a projected corner portion N1 in an approximately horizontal state or fixed indirectly via an appropriate support bracket (not shown) which is attached so that the angle of inclination can be freely adjusted if necessary.

A winding roller J1 for the projected corner canvas G1 is incorporated inside the casing K1, and the winding roller J1 is formed of the main body of the roller 11 in hollow cylindrical form, as shown in FIG. 6(B) and FIG. 6(C) and a slider 12 that is supportedly inserted into the main body.

A slide trench I11 is created in the main body of the roller 11 in the direction of the axial line, and a slide path 112 in protrusion form is formed on the inner side thereof, in the direction of the axial line so that the above described slide 12 is supportably inserted into the slide trench III and the slide path 112 so as to be freely rotated and guided.

A canvas engaging trench 121 in an approximate Ω shape is created in the center protrusion of the slider 12 and wing plate portions 123 with a slit trench 122 are projected in portions on both sides of the center protrusion.

124 are small wheels which are engaged in the slit trench 122 of the wing plate portion 123 at appropriate intervals and assembled in such a manner so as to be freely rotatable by means of pins 125, and thus guided along the rail trench 113 created on the side wall portion of the above described slide path 112 while being rotated.

131 is an opening through which the canvas is drawn out and which is created in the front surface of the casing K1, 141 and 142 are end caps which are engaged in the two end portions, front and rear, of the casing K1, and bearing portions 143 and 144 having a round hole are provided inside in such a manner so as to protrude.

151 and 152 are end caps which are engaged in the two end portions, front and rear, of the main body of the roller 11, and the support axes 153 and 154, which penetrate through the main body portion of the cap so as to be secured, are both engaged with the above described bearing portions 143 and 144 in such a manner so as to be freely rotatable.

161 is a worm gear which is engaged and fixed to the support axis 153 of the end cap 151, 162 is a worm gear which is engaged with the worm gear 161, and the worm rotation axis 163 of the worm 162 is vertically supported by the up-down bearing portion 145 inside the above described end cap 141, and a hook 164 which is engaged with the operation rod (not shown) is formed in the lower end portion of the worm.

As a result, the winding roller J1 is manually operated so as to be freely rotatable forward and backward.

Here, in the case of the above, the end caps 141 and 142 are used as a bracket for bearings for the winding roller J1, and in the case where the end caps 141 and 142 are attached in such a manner as to protrude from the outer wall W1 or W2, the casing K1 becomes unnecessary.

(2) Concerning Projected Corner Canvas

Here, the configuration of the projected corner canvas G1 shown in FIGS. 7(A) to 7(C) and 8(A) and 8(B) and wires which are incorporated are described.

The projected corner canvas G1 is formed of a tent cloth made of plain cloth or a synthetic resin in trapezoid form with approximately right angles in a spread state, and made up of the main body portion of the canvas in rectangular form X1 and a protrusion of the canvas in right angled triangle form X2 which is projected from one side.

In terms of the outer shape, the top side 1 of the upper end portion of the canvas (hereinafter referred to as top hem of canvas) and the bottom side 2 of the lower end portion of the canvas (hereinafter referred to as bottom hem of canvas) are parallel to each other, and a diagonal side 3 of which the angle of inclination is approximately 45 degrees is placed between the front end portion of the bottom portion of the canvas 2 and the front end portion of the top hem 1 of the canvas so as to spread toward the bottom, and in addition, a perpendicular side 4 (hereinafter referred to as perpendicular portion of canvas) is placed between the rear end portion of the bottom hem 2 of the canvas and the rear end portion of the top hem 1 of the canvas.

181 and 182 are through holes in bag form which are created in the top hem 1 of the canvas and the bottom hem 2 of the canvas, and fixing members, such as a wire 183 or 184, a tube or a rope, penetrate through the inside of the holes.

191 and 192 are through holes in bag form which are created so as to cross along diagonal lines connecting the four corner portions of the main body portion of the canvas X diagonally, and canvas tensing members, such as a connection wire 193 or 194, a connection belt or a rope, penetrate through the inside of the holes. An engaging piece 195 or 196 of the front end portion of the wire is drawn out diagonally upward from the opening through which the top portion of the crossing through holes 191 and 192. The bottom end portion of the wire and the fixture for the wire 197 or 198 are drawn out diagonally downward from the opening at the bottom of the crossing through holes 191 and 192.

Therefore, in order to attach the projected corner canvas G1 to the winding roller J1, first, the top hem 1 of the canvas is placed in such a manner as to face the trench 121 where the canvas is engaged in the slider 12, and the attachment wire 183 passes through the hole 181, and thus, the top hem 1 of the canvas is fixed so that it cannot be pulled out.

Next, screws 101 are screwed in the front and the rear of the trench with which the canvas is engaged 121, as shown in FIGS. 4, 5 and 6(C), an engaging piece 195 or 196 of the connection wire 193 or 194 which is drawn out from the opening of the top hem is engaged with the above described engaging trench 121 and a screw 102 is screwed in on the outside thereof so that the engaging piece 195 or 196 is positioned and fixed in such a state so as to be sandwiched by the screws.

(3) Concerning Front Bar

F1 is a front bar to which the bottom hem 2 of the projected corner canvas G1 is attached, and the front bar has a cross section in approximately box form where an opening is created in the center portion on the rear, as shown in FIGS. 3(A), 4(A) and 4(B). The front portion of the horizontal upper plate portion 201 and the upper portion of the perpendicular front plate portion 202 are formed in such a manner so as to bulge out to the projected corner portion in arc form, and the trenches 211 and 212 with which the canvas is engaged are created in the lateral direction in portions with steps.

A rim 204 is formed in the rear portion of the lower plate portion 203 of the front bar F1 in such a manner as to stand straight, and a rim 205 which faces the rim 204 in the up-down direction is formed in such a manner so as to hang from the bottom portion in the middle of the upper plate portion 201.

In FIGS. 5, 213 and 214 are through holes for attaching a wire, and provided in the vicinity of the middle portion and the rear end portion of an eave plate portion 206 which is projected to the rear of the upper plate portion 201.

Thus, the bottom hem 2 of the canvas is located in such a place as to face the engaging trench 211 and the wire 184 penetrates through hole 182 in the bottom hem 2, and thus, the bottom hem 2 of the canvas is fixed so that it cannot be pulled out. Next, the bottom end portion of the connection wire 193 or 194 drawn out from the opening at the bottom penetrates through the holes 213 and 214 shown in FIG. 5, and the projected corner canvas G1 is spread in such a state as to have appropriate tenseness, and fixtures 197 and 198 are bound and fixed in this state.

221 is a front skirt which is formed so as to hang from the front bar F1, and the upper end portion of the front skirt faces the above described engaging trench 212 and an attachment wire 185 penetrates through the hole 222 in the upper end portion of the above described skirt 221 so that the skirt is secured so that it cannot be pulled out.

As a result, a winding device for the projected corner canvas G1 can be formed.

(4) Concerning Electric Power Structure of Winding Roller

In the case of the above described winding roller J1, the roller is manually operated so as to rotate, while in the case of the winding roller J2 in the second example shown in FIGS. 9(A) and 9(B), the roller rotates forward and backward by means of an electric motor M1 in columnar form which is built in within the main body of the roller 11.

In FIGS. 9(A) and 9(B), the electric motor M1 penetrates through the rear portion of the main body of the roller 11, and the motor output axis 271 is provided and the axial portion for attachment 272 is provided in the front end portion and the rear end portion of the roller, respectively.

281 is a movement conveying socket provided with a notch 283 which engages with the main body of the roller 11, and the motor output axis 271 is engaged with an axial hole 282 of the socket. 155 is a through hole in the end cap 152, and the rear end portions of the electric motor M1 are supported with a bearing through the hole 155.

Thus, the movement conveying socket 281 is engaged with and fixed to the motor output axis 271, and after that, the electric motor M1 penetrates through the rear portion of the main body of the roller 11 while the end cap 152 penetrates through the rear portion of the main body of the electric motor M1, and after that is engaged with the rear end portion of the main body of the roller 11, and thus, the axial portion of the rear end of the electric motor M1 is engaged with and secured to an oblong hole (square hole is also possible) of the bearing portion 44 of the end cap 142. As a result, the electric motor M1 is incorporated inside the main body of the roller 11.

Accordingly, when the electric motor M1 is driven, the output axis 271, the movement conveying socket 281 and the main body of the roller 11 rotate forward and backward integrally, so that the operation of winding and unwinding the projected corner canvas G1 is automated and power is conserved.

Concerning Device for Tensing Canvas

(1) Concerning Transverse Guide Rail

As shown in FIGS. 2(A), 2(B), 3(A) and 4(A), the transverse guide rail R1 has a longitudinal cross section in protrusion form and faces the side, and is formed of a rear plate portion 231 and a rail portion 232 in box form which protrudes to the front, and approximately four pairs of small wheels 234 and 235 are supported with a bearing in two side portions, upper and lower, of the rail portion 232 by means of axial pins 233 in such a manner so as to be freely rotatable horizontally, and assembled at the rail portion 232 with intervals in between.

Thus, the small wheels 234 and 235 of the transverse guide rail R1 are engaged in the upper chamber and the lower chamber of the above described front bar F1 in such a manner as to face each other, and thus, the front bar F1 is incorporated in such a manner as to be freely guided and rotated in the direction of the axial line of the transverse guide rail R1.

241 is an engaging portion (engaging hole is also possible) created so as to protrude from the bottom in the vicinity of the middle of the front bar F1, and used in such a manner that the front end portion of the operation rod (not shown) is engaged with the engaging portion 241, and after that, the spread projected corner canvas G1 is operated so as to move transversely.

(2) Concerning Foldable Arms

V1 and V2 are a pair of foldable arms in lateral V shape (hereinafter referred to as V-shaped arms) which are freely foldable in two and support portions on the two sides, front and rear, of the transverse guide rail R1, and the rear link 251 and the front link 252 are connected in such a manner so as to be freely foldable in two toward the inside, and a spring or a pulling wire (not shown) is connected in the connection portion, which is foldable in two, and the V-shaped arms V1 and V2 are pressed in such a direction as to spread.

261 are base portions for the V-shaped arms V1 and V2, that is to say, brackets for supporting the base portion of the rear link 251 around a pin which is attached to the other wall W1 or W2 at the bottom of the above described casing K1, and the bracket 261 for one V-shaped arm V1 is attached to a portion close to the corner of the projected corner portion N1, which is the front end portion of the winding roller J1, and the bracket 261 for the other V-shaped arm V2 is attached in the vicinity of the middle portion of the winding roller J1 in such a manner that the brackets are at a distance from each other.

262 are front end portions of the V-shaped arms V1 and V2, that is to say, brackets for supporting the front end portions of the front links 252, around a pin, and fixed to the rear plate portion 231 in the vicinity of the two ends, front and rear, of the transverse guide rail R1.

As a result, a device for tensing the canvas, which is the projected corner canvas G1, is formed.

Concerning Process for Rolling Up and Winding Projected Corner Canvas for Storage

As shown in FIGS. 10(A) and 11(A), in the case where the projected corner canvas G1 that is projected in a corner space portion is wound and stored, first a front end hook portion of an operation rod (not shown) is hooked from beneath with the engaging portion 241 of the front bar F1, and after that, a sliding operation is carried out so that the front bar slides to the rear. At this time, in the case where the engaging portion 241 is at such a level that it can be reached from beneath with the hands, the engaging portion 241 is held and pulled to the rear for the operation.

Then, the projected corner canvas G1 is pulled to the rear while the canvas is kept in a spread state, and at this time, the front bar F1 of the bottom hem 2 of the canvas moves backward along the transverse guide rail R1, and the slider 12 of the top hem 1 of the canvas also moves backward along the slide trench 111 and the slide path 112 following the movement of the front bar F1. As a result, as shown in FIGS. 10(B) and 11(B), the projected corner canvas G1 transversely slides parallel to the rear portion of the device.

Naturally, the slider 12 of the top hem of the canvas moves backward to the rear half portion of the main body of the roller 11 or is pulled down at least to a location in the rear, where the projected portion of the canvas X2 in triangular form does not stick out from the projected corner portion N1 along the line connecting the side wall W2.

Next, in the case of the winding roller J1 of the first example shown in FIG. 6, an operation rod (not shown) is engaged with the hook 164 of the manually operable device, and a rotating operation is carried out. In addition, in the case of the winding roller J2 of the second example shown in FIG. 9, the electric motor M1 is driven for winding.

Then, the projected corner canvas G1 is wound around the winding roller J1 or J2 from beneath with the front surface of the top hem 1 of the canvas on the inside and the rear surface on the outside, and wound as shown in FIGS. 10(C), 10(D), FIGS. 11(C) and 11(D).

At this time, the V-shaped arms V1 and V2 are folded against the elastic resilience, due to a spring which is incorporated in the connection portion, which is also foldable in two, and the transverse guide rail R1 and the front Bar F1, which is supportedly inserted into the transverse guide rail, are folded and stored while moving in a parallel manner in a straight line toward the wall portion.

In the case of the above, connection wires 193 and 194 connect the front bar F1 and the slider 12, and cross between the two and spread and support the projected corner canvas G1 in a tense state. Therefore, when the spread projected corner canvas G1 is operated so as to move transversely, the main body portion of the canvas X1 can be prevented from being distorted and changing in form within the plane, and thus, smooth, transverse movement of the projected corner canvas G1 can be secured.

Concerning Process for Pulling Out, Unwinding and Spreading Projected Corner Canvas

Next, in the case where the projected corner canvas G1 wound around the winding roller J1 or J2 is spread toward the front of the building, the operation rode which is engaged with the hook 164 of the manually operable device is rotated in the direction opposite to that above through the operation, or the electric motor M1 is driven so as to rotate in the direction of unwinding.

Then, the projected corner canvas G1 that has been wound around the winding roller J1 or J2 is unwound, and the elastic resilience of the V-shaped arms V1 and V2 that have been folded in a wall portion is released, so that the V-shaped arms in V shape V1 and V2 are rotated by means of the pressing resilience in such a direction as to spread, and as shown in FIGS. 10(D) to 10(B) and FIGS. 11(D) to 11(B), the transverse guide rail R1 into which the front bar F1 is supportedly inserted is pushed out in a straight line to the front while moving in parallel.

As a result, the projected corner canvas G1 is unwound to the front of the front wall W1 so as to spread and be supported in a tense state.

Next, the front end hook portion of the operation rode (not shown) is engaged from beneath with the engaging portion 241 of the front bar F1, and after that, the front bar is slid toward a corner space portion through operation or, in the case where the engaging portion 241 is at such a level that it can be reached with the hands, the engaging portion 241 is held and pushed toward the front through the operation.

Then, the projected corner canvas G1 moves in parallel while being kept in a spread state, and pushed out to the corner space portion. At this time, the front bar F1 of the bottom hem 2 of the canvas is transversely slid along the transverse guide rail R1, and the slider 12 of the top hem 1 of the canvas is transversely slid along the slide trench 111 and the slide path 112.

As a result, the projected corner canvas G1 moves forward in parallel, as shown in FIGS. 10(B), 10(A), FIGS. 11(B) and 11(A), and the projected portion of the canvas X2 is projected toward the corner space portion.

Accordingly, as shown in FIGS. 1(A) and 1(B), two single devices S1a are attached to a portion of the corner of the front wall W1 in a projected corner portion N1 and a portion of the corner of the side wall W2 in a perpendicular state (obtuse angle or acute angle is also possible), and the projected corner canvases G1 that have been wound around the respective winding rollers J1 and J2 are unwound and spread, and after that moved transversely to the corner space portion while the canvases G1 are kept in a spread state, and then, the two projected corner canvases G1 are projected in such a state as to be located on the two sides of the corner space portion, and the corner space portion of the building is covered so that a good appearance is provided.

### Concerning Second Embodiment

In FIGS. 12(A) to 12(D) and FIGS. 13(A) to 13(D) showing the single device S1b according to the second embodiment, 391 is a synchronizing belt, and the base portion thereof is attached to the front end portion of the main body of the roller 11, and the front end portion of the belt is attached to the front end portion of the transverse guide rail R1.

Accordingly, as shown in FIGS. 12(B) and 13(B), when the projected corner canvas G1 that has moved to the rear half portion of the device is wound or unwound, the synchronizing belt 391 is wound or unwound in sync in the front end portion of the device.

This belt winding device prevents the front end portion of the device from becoming imbalanced with the rear portion of the device when the projected corner canvas G1 is wound or unwound, and thus, the transverse guide rail R1 can be smoothly moved in parallel in the front-rear direction with good balance and without fail.

Other parts of the configuration are the same as in the first embodiment, and therefore, the same symbols are attached in the drawings, and description thereof is omitted.

### Concerning Third Embodiment

In FIGS. 14(A) to 14(D) showing the single device S1c according to the third embodiment, Y1 and Y2 are foldable arms in front-rear symmetry (hereinafter referred to as Y-shaped arms) which are supported while pressed in such a manner so as to be freely extendable in a reverse y shape in a plan view, and formed of a long main link 291 and a sub-link 292 of which the length is approximately half of the above described main link 291, and of which the rear end portion is supported around a pin in the vicinity of the middle portion of the main link.

The front end portion of the sub-link 292 is attached to the bracket 262 which is fixed to the two end portions, front and rear, of the transverse guide rail R1, and the bracket 262, which is supported around a pin in the front end portion of the main link 291, is attached to the transverse guide rail R1 in such a manner so as to be freely slidable or rotatable along the transverse guide rail.

Thus, a spring having an appropriate elasticity (not shown) is incorporated in the axial portion of the base portion of the main link 291, and the main link 291 is pressed so as to fluctuate in such a direction as to extend due to the elastic force. In addition, a spring, a pulling wire (not shown) and the like are incorporated in the connection portion, which is foldable in two between the middle portion of the main link 291 and the sub-link 292, so that the connection portion is pressed in such a direction that the link extends.

Therefore, as shown in FIG. 14(B), when the projected corner canvas G1 that has moved backward to the rear half portion of the device is wound as shown in FIGS. 14(B) to 14(D), the link portion made of the rear half portion of the main link 291 and the sub-link 292, from among the Y-shaped arms Y1 and Y2, are folded in two against the elastic resilience, due to the spring, which is incorporated in the connection portion that is foldable in two, and the front end portion of the main link 291 is guided and slid along the transverse guide rail R and thus folded.

As a result, the projected corner canvas G1 is wound around the winding roller J1 or J2, and the entirety of the device is compactly folded into a wall portion so as to be stored.

Accordingly, in the case where the foldable arms are Y-shaped arms Y1 and Y2, as described above, the spread projected corner canvas G1 can be smoothly moved transversely and without fail, as compared with the case of the V-shaped arms V1 and V2 in the first and second embodiments, and in addition, the ease of move in parallel along the transverse guide rail R1 increases.

Other parts of the configuration are the same as in the case of the first embodiment, and therefore, the same symbols are attached in the drawings, and description thereof is omitted.

Here, as an amalgam of the above described first and third embodiments, it is possible to support the front end portion of the transverse guide rail R1 with the Y-shaped arm Y1 and support the rear end portion with the V-shaped arm V2.

### Concerning Fourth Embodiment

In FIGS. 15(A) to 17(D) showing the single device S1d according to the fourth embodiment, I1 and I2 are a set of foldable arms in straight line form which are supported in parallel (hereinafter referred to as I-shaped arms), and the transverse guide rail R1 for guiding and sliding the front bar F1 is supported and pressed so as to be pushed in parallel diagonally to the front from the wall portion or, conversely, freely rotated in parallel diagonally toward the rear.

The brackets 261 which support the base portion of these I-shaped arms I1 and I2 around a pin are respectively secured in a location close to the end portion of the corner of the projected corner portion N1 in the vicinity of the lower portion of the front end of the casing K1, and the front wall W1 in the vicinity of the middle portion of the casing K1, which is at a distance from the location close to the end portion of the corner of the projected corner portion N1 to the rear.

The brackets 262 which support the front end portion of the I-shaped arms I1 and I2 around a pin are secured in the vicinity of the middle portion of the transverse guide rail R1 and in a location on the rear surface of the rear end portion at the same distance from each other as in the case of the above described brackets 261. Thus, a spring (not shown) is incorporated in the portion of one or both axes of the base portion and the front end portion of the I-shaped arms I1 and I2, so that the elastic resilience allows the I-shaped arms I1 and I2 that have been folded in a wall portion to rotate in parallel in such a direction as to extend, and thus, push out the transverse guide rail R1 with which the front bar F1 is engaged diagonally to the front in parallel, as shown in FIGS. 16(D) to 16(B) and 17(D) to 17(B) so that the projected corner canvas G1 is unwound and spread.

In contrast, when the projected corner canvas G1 is wound, the I-shaped arms I1 and I2 rotate in parallel against the elastic resilience and are folded and stored while allowing the transverse guide rail R1 to move in parallel toward the wall portion diagonally to the rear.

This single device S1d is different from that in the above described case of the first to third embodiments, and the transverse guide rail R1, into which the front bar F1 is supportedly inserted, moves in parallel in a diagonal direction instead of moving in parallel in a straight line.

Other parts of the configuration are the same as in the first embodiment, and therefore, the same symbols are attached to the drawings, and description thereof is omitted.

Concerning Combination with Conventional Movable Awning Device

Incidentally, as shown in FIGS. 18(A) to 18(C), a movable awning device Q having a conventional structure for spreading and winding the rectangular canvas P1 (hereinafter referred to as conventional device) can be combined with the rear half portion of the above described single devices S1a to S1d according to the present invention.

In FIGS. 18(A) to 18(C), K2 is a casing for winding and storing a rectangular canvas P1 and a winding roller 30 which rotates forward and backward through manual operation or electric power operation is incorporated inside the casing, where the top hem 5 of the rectangular canvas P1 is attached.

31 is a front bar for securing the bottom hem 6 of the rectangular canvas P1, and V3 and V4 are a pair of V-shaped arms which are freely foldable in two, where a spring or a wire presses the V-shaped arms V3 and V4 in such a direction that the arms spread, in the same manner as in the case of the V-shaped arms V1 and V2 in the first and second embodiments. Therefore, the front half portion of the conventional device Q close to the front end of the casing K2 is attached to the rear half bottom portion of the casing K1 of the single device S1a to S1d according to the present invention in such a manner as to approximately overlap. In addition, the V-shaped arms V3 and V4 are fixed to the front and the rear of the linear section of the outside walls W1 and W2 at an appropriate distance from each other at the base portion.

Accordingly, when the winding roller 30 of the conventional device Q is wound and rolled by means of a manually operable handle or an electric motor (not shown), the winding roller 30 winds the rectangular canvas P1 with the rear surface on the inside and the front surface on the outside, and thus, the canvas is wound from above, while the V-shaped arms V3 and V4 are folded inward against the elastic resilience of the arms, so that the front bar 31 moves in parallel toward the wall portion and is stored in the wall.

As described above, any of the single devices S1a to S1d according to the present invention and the conventional device Q can be combined, and thus, the outside of various types of buildings including a corner space portion can be covered as if it were an integrated portion so as to provide a good appearance.

In the case of the above, it is taken into consideration that the projected corner canvas G1 is wound from beneath and the rectangular canvas P1 is wound from above, so that the step in the bordering portion between the two canvases B1 and P1 when spread is inconspicuous, while the manner in which the casing K2 of the conventional device Q and the casing K1 of the single device S1a to S1d according to the present invention overlap is changed so that top and bottom are reversed, and thus, the combination allows the projected corner canvas G1 to be wound from above and the rectangular canvas P1 to be wound from beneath.

Concerning Linking Structure

In the case of the above, though the winding roller J1 or J2 of the single device S1a to S1d is described as being manually rotated or rotated with electric power, two single devices S1a to S1d are placed on the two sides in the projected corner portion N1 so that the front end portion of the device inside the corner cap 145 has an engaging structure between helical gears 52 (bevel gears are also possible), as shown in FIG. 22(A), or an engaging structure between worm 162 and worm gear 161, as shown in FIG. 22(B), and thus, the operation of winding and unwinding the projected corner canvas G1 can be linked. As a result, one electrically-driven device becomes unnecessary, and the manually operable device can be simplified.

Concerning Winding of Projected Corner Canvas

Incidentally, when the projected corner canvas G1 is wound around the winding roller J1 or J2, the top hem 1 of the main body portion of the canvas X1 is wound around the surface of the roller, and the bottom hem 2 of the canvas which spreads toward the bottom is wound as a roll in such a manner that the width of winding becomes gradually greater around the outer periphery. Therefore, when the projected portion of the canvas X2 starts being wound, the form of the canvas deteriorates when wound, which then causes wrinkling on the projected portion of the spread canvas X2 when the projected corner canvas G1 is pulled out, and thus, a problem arises, such that the appearance is damaged. Therefore, a configuration for preventing this problem is described below.

Concerning Bulk Ring

In FIGS. 19(A) and 19(B), 331 is a bulk ring which is engaged with the outer peripheral surface in approximately the front half portion of the main body of the roller 11, which is formed in a helix form in such a manner that the outer diameter of the roller increases step by step toward the front end portion of the roller from the vicinity of the middle of the winding roller J1 or J2, taking the thickness of the raw fabric of the canvas into consideration.

A portion of the bulk ring 331 which is in line with the slide engaging trench 111 can, of course, be formed in a V-shaped notch 332 in order to secure transverse sliding of the spread projected corner canvas G1.

Accordingly, the bulk ring 331 is attached to a front half portion of the winding roller J1 or J2 step by step, and thus, the bottom hem 2 of the canvas which spreads toward the bottom, as compared with the top hem 1 of the canvas, is wound evenly with good balance, as shown in FIGS. 20(A) to 20(C).

Here, in the case of the above, though the bulk ring 331 in helix form is engaged in the front half portion of the winding roller J1 or J2 step by step, as a second-best means, a bulk pipe (not shown) of which the outer diameter gradually and consecutively increases from in the vicinity of the middle of the roller to the front end portion of the roller can be engaged.

Concerning Bulk Plain Cloth

In FIGS. 21(A) to 21(C), 32 is a bulk sheet, which is a hem fixed to the front surface side close to the diagonal portion of the canvas 3, and the sheet is formed in such a manner that the thickness of the film gradually increases consecutively from the top hem 1 to the bottom hem 2 of the projected corner canvas G1.

When the projected portion of the canvas X2 having this bulk sheet 32 is wound around the outer periphery of the winding roller J1 or J2 having the same diameter in roll form, a portion of the above described sheet 32 functions as a type of spacer and is wound in helix form with bulk, as shown in FIG. 21(C).

Here, in the case of the above, though the bulk sheet 32 is formed in such a manner that the thickness of the film gradually increases, the thickness may increase step by step every one or two cycles.

### 2. Concerning Foldable Arm Type Complex Awning Device

This type of complex device can be divided into the first to fourth groups for the sake of convenience, and as shown in FIGS. 23 to 43, the complex devices SQII1 to 9 in the first group, from among these, is attached mainly in a location on a building where, for example, the front end portion of the device becomes a projected corner portion N1 and the front wall W1 and the side wall W2 continuing to the rear portion of the front end portion become a linear section (gently curved section is also possible).

As shown in FIGS. 45 to 48, the complex devices SUII1·2 in the second group are attached to a linear section of the outer wall W1, W2 portion, where one device is in a projected corner portion N1 and the other is in a recessed corner portion L.

As shown in FIGS. 49 to 52, the complex devices SQSIV1·2 in the third group are attached to a linear section where the two end portions, front and rear, of the devices are projected corner portions N1 and N2, and the outer wall W1, W2 portion between these has an appropriate length.

As shown in FIGS. 53 and 54, the complex devices SSII in the fourth group are attached to a linear section where the distance between one projected corner portion N1 and the other projected corner portion N1 is short in comparison with the case of the third group.

In the following, the complex devices in the first to fourth groups are described in sequence in reference to the attached drawings.

Concerning Complex Awning Devices in First Group

In the complex devices in this group, an awning device S1 or S2 for a projected corner canvas G1 or G2 which covers the corner space portion in the projected corner portion N1 (hereinafter referred to as awning device for a projected corner) and an awning device Q1 or Q2 for a rectangular canvas P1 or P2 (hereinafter referred to as rectangular awning device) which is either long or short and covers the outer periphery of a building in a linear section are combined organically.

From among the devices, the awning devices S1 and S2 for a projected corner are provided with a canvas winding device made up of a winding roller J1 to J3 for a projected corner canvas G1 or G2 where a slider 12 is supportedly inserted into the main body of the roller 11 so as to be freely movable through a guide and the front bar F2 or F3 of the winding roller, in the same manner as in the above described single devices S1a to S1d.

The rectangular awning devices Q1 and Q2 are provided with a canvas winding device having a winding roller 30 or 30a for a rectangular canvas P1 or P2 which is either long or short and a front bar R2 or R3 for the winding roller, and a canvas tensing device made up of foldable arms V1 and V2 or Y1 and Y2 for supporting the front bar R2 or R3 for a rectangular canvas P1 or P2 in such a manner that the front bar is freely move in parallel.

Thus, the front bar F2 or F3 of the projected corner canvas G1 or G2 is supportedly inserted in the front bar R2 or R3 of the rectangular canvas P1 or P2 in such a manner that the front bar F2 or F3 is freely slidable along either the outer side surface or the inner side surface.

### Concerning First Embodiment

Therefore, the configuration of the respective parts in the awning device S1 for a projected corner and the rectangular awning device Q1 in the complex device SQII1 according to the first embodiment shown in FIGS. 23 to 33 and the relationship in the organic combination of these are described below.

Concerning Awning Device for Projected Corner

(1) Concerning Canvas Winding Device

The projected corner canvas G1 which forms a canvas winding device and the winding roller J1 or J2 for the canvas G1 are the same as in the case of the above described single devices S1a to S1d, and therefore, the same symbols are attached in the drawings, and description thereof is omitted.

In order to wind or unwind the projected corner canvas G1, any of a winding roller J1 having the manually operable structure shown in FIG. 6, a winding roller J2 having the electric power structure shown in FIG. 9 and the below described winding roller J3 having the spring structure shown in FIG. 29 are combined with a winding roller 30 or 30a for a rectangular canvas P1 or P2 shown in FIGS. 28 and 30.

(2) Concerning Front Bar

F2 is a front bar to which the bottom hem 2 of a projected corner canvas G1 or G2 is attached, and the front plate portion 341 thereof is formed to an arc surface (vertical surface is also possible), and the rear portion has an opening.

In FIGS. 26, 351 and 352 are an upper engaging trench having an opening facing upward and a lower engaging trench having an opening facing downward, and these are created in an upper plate portion 342 and a lower plate portion 343 which are projected to the rear from upper and lower portions of the front surface of the front bar F2 in the longitudinal direction. 344 and 345 are through holes created in the vicinity of the middle and in the vicinity of the rear end of the upper plate portion 342.

Therefore, the bottom hem 2 of the canvas faces the upper engaging trench 351, and an attachment wire 184 penetrates through the hole 182, and thus, the bottom hem 2 of the canvas is fixed so that it cannot be pulled out. Next, an end portion of a connection wire 193 or 194 which leads out from the opening at the bottom penetrates through the hole 344 or 345 shown in FIGS. 26(C) and 27(A), and the projected corner canvas G1 is spread in an appropriately tense state, and then, a fixture 197 or 198 is fixed with a screw.

In FIGS. 24(B) and 25, 221 is a front skirt which is formed so as to hang from the front bar F2, and a through hole 222 created in the top hem of the front skirt 221 shown in FIG. 7(A) faces the lower engaging trench 352 and an attachment wire 185 penetrates through the hole so as to be fixed and prevented from being pulled out.

Concerning Rectangular Awning Device

(1) Concerning Canvas Winding Device

Next, a rectangular canvas P1 which is in rectangular form in a spread state and a winding device for winding or unwinding the rectangular canvas are described in reference to FIGS. 23 to 27 and 31 to 33.

As shown in FIGS. 23(A), 23(B), FIGS. 24(A) and 24(B), the casing K2 of the rectangular canvas P1 is attached directly to an outer wall W1 in a linear section ranging from a portion in the rear half bottom of the casing K1 for the projected corner canvas G1 to the rear in such a manner that the front half portion of the casing K2 approximately overlaps in the up-down direction, or fixed indirectly to a wall portion via an appropriate support bracket (not shown), and the casing is attached in such a manner that the angle of inclination can be freely adjusted if necessary.

The casing K2 supports the winding roller 30 for a rectangular canvas P1 having the same diameter as the main body of the roller 11 of the winding roller J1 or J2 with a bearing.

Here, an opening for drawing out a canvas 132 is created in an upper portion on the front portion of the casing K2 when the casing K1 is turned upside-down, and in addition, the end caps 401 and 402 in the two end portions, front and rear, of the casing K2 have a configuration which is the opposite of the end caps 141 and 142 of the above described casing K1 in the up-down direction, and thus, parts of the casings K1 and K2 are shared.

(2) Concerning First Example of Winding Roller

In FIGS. 28(A) and 28(B), M2 is an electric motor which is inserted in the rear portion of the winding roller 30 and a motor output axis 451 is provided in the front end portion of the electric motor M2, and an axial portion for attachment 452 is provided in a rear end portion, as in the case of the above described electric motor M1.

461 is a movement conveying socket having a trench portion which engages with the inner peripheral surface of the winding roller 30, and the motor output axis 451 engages with the axial hole 462 of the socket. 441 and 442 are end caps having a trench portion, and are engaged in the two end portions, front and rear, of the winding roller 30, and the axis 443 of one end cap 441 is supported with a bearing through a round hole in the bearing portion 403 of the end cap 401. 446 is a circular hole created in the center portion of the main body of the end cap 442, and the rear portion of the main body of the electric motor M2 is supportedly inserted into the hole.

Therefore, the movement conveying socket 461 is engaged with the motor output axis 451 and the electric motor M2 penetrates through the rear end portion of the winding roller 30, while the end cap 442 penetrates through the rear portion of the main body of the electric motor M2, the cap 442 is engaged with the rear end portion of the winding roller 30 and the rear end axial portion 452 of the electric motor M2 is engaged with and secured to the oblong hole of the bearing portion 404 of the end cap 402.

As a result, the output axis 451, the movement conveying socket 461 and the winding roller 30 rotate forward and backward integrally when the electric motor M2 that is incorporated in the winding roller 30 is driven.

301 is a canvas engaging trench in Q form created in the winding roller 30 in the direction of the axial line, and as shown in FIGS. 25 and 26(A), the top hem 5 of the rectangular canvas P1 faces the engaging trench 301, and an attachment wire 302 is inserted into the trench so as to be fixed and prevented from being pulled out.

Here, in the case where the above described winding roller 30 is manually rotated instead of using the electric motor M2, the electric motor M2, the movement conveying socket 361 and the end cap 442 shown in the figures are removed, and instead, end caps 441 are engaged in the two end portions, front and rear, of the winding roller 30, and a worm gear (not shown) is engaged with the axial portion 443 of either the end cap 441 at the front or that at the rear, as in the case of the winding roller J1 shown in FIG. 6(A). Thus, the system is formed by supporting the worm rotating axis (not shown) with which a worm which engages with the above described worm gear is engaged vertically with a bearing inside the end cap 401 of the casing K2.

(3) Concerning Front Bar

R2 is a front bar to which the bottom hem 6 of the rectangular canvas P1 is attached, and which guides and slides the front bar F2 of the projected corner canvas G1, and the front plate portion 361 of the front bar R2 is formed so as to have an arc surface (vertical surface is also possible) which is almost the same as the above described front bar F2, and the front bar R2 is formed in such a manner that the above described front bar F2 is supportedly inserted into the front bar R2.

In FIGS. 26, 371 and 372 are an upper guide trench and a lower guide trench created in an upper plate portion 362 and a lower plate portion 363 of the front bar R2, and a protrusion of the upper engaging trench 351 of the front bar F2 is engaged with the upper guide trench 371, and a protrusion of the above described lower engaging trench 352 is engaged in the lower guide trench 372.

As a result, the front bar R2 on the inner side functions as a slide guide rail for the front bar F2 on the outer side, and in addition, this function is stable, and therefore, the front bar R2 is long, extending from the rear end portion of the device to the vicinity of the projected corner portion N1 in the front end portion of the device.

381 and 382 are an upper engaging trench having an opening facing upward and a lower engaging trench having an opening facing downward, and are created in portions with steps formed in the rear half portion of the upper plate portion 362 and the lower plate portion 363 of the above described front bar R2 in the longitudinal direction.

Therefore, the bottom hem 6 of the rectangular canvas P1 faces the upper engaging trench 381, as shown in FIG. 25, FIGS. 26(A) and 26(C), and an attachment wire 303 is inserted into the trench so as to be fixed and prevented from being pulled out.

In FIGS. 24(B) and 25, 391 is a front skirt which is formed so as to hang from the front bar R2, where the top hem of the skirt faces the lower engaging trench 382 and an attachment wire 392 is inserted into the trench so as to be fixed and prevented from being pulled out.

As a result, a winding device for the rectangular canvas P1 is formed.

Here, the front end portion and the rear end portion of the spread rectangular canvas P1 are vertical canvas portions 7 and 8, as shown in FIGS. 31(A) and 31(B).

Here, in the case where the front bar R2 is long in comparison with the length of the winding roller 30, as shown in FIGS. 31(A) and 31(B), a X-shaped or V-shaped bag-like hole is created in the rectangular portion of the main body of the rectangular canvas P1, and the base portion of the connection wire that penetrates through the hole is attached to the winding roller 30 and the front end portion of the wire is attached to the rear half portion of the front bar R2, and it is desirable to support the rectangular canvas P1 in a tensely spread state.

As a result, this prevents the rectangular canvas P1 from changing in form in the plane when wound or unwound, and the rectangular canvas is useful for securing parallel movability for the front bar R2.

In the case where the winding roller 30a, the front bar R2 and the rectangular canvas P2 are all long, there is, naturally, little necessity for the above described connection wire for tensing the canvas to be incorporated.

(4) Concerning Foldable Arms

V-shaped arms V1 and V2 for supporting portions on the two sides, front and rear, of the front bar R2 have such a connection between a rear link 251 and a front link 252 so as to be freely foldable in two, as in the case of the above described single devices S1a and S1b, and a spring or a pulling wire (not shown) is incorporated in the connection portion thereof so as to push and press the V-shaped arms V1 and V2 in such a direction that the arms open.

The bracket 261 for supporting the base portion of the rear link 251 around a pin is attached to the outer wall W1 in lower portions close to the front end of the casing K1 and close to the rear end of the casing K2.

263 is a bracket for supporting the front end portion of the V-shaped arms V1 and V2, that is to say, the front end portion of the front links 252, around a pin and, as shown in FIGS. 25 and 26(C), the front half portion of the bracket 263 is formed so as to stand diagonally upward, so that the front end portion is pressed against the rear surface of the front bar R2. 264 is an attachment plate which is engaged on the rear surface in a portion close to the two end portions, front and rear, of the front bar R2, where a screw 265 is engaged in the attachment plate 264 from the rear surface of the above described bracket 263 from above, and as a result, the front bar R2 is pinched by the bracket 263 from the two sides so as to be fixed.

Concerning Process for Winding and Storing Projected Corner Canvas

As shown in FIGS. 32(A) and 33(A), a case where the electric motor M1 for winding the projected corner canvas G1 shown in FIG. 9 and the electric motor M2 for winding the rectangular canvas P shown in FIG. 28 are driven in sync when the projected corner canvas G1 which is projected in a corner space portion and the rectangular canvas P1 which spreads to the front are wound and stored is described below.

First, the front end hook portion of an operation rod (not shown) is engaged with the engaging portion 241 of the front bar F2 from beneath, and after that, an operation for sliding the front bar to the rear is carried out.

Then, the projected corner canvas G1 is pulled down toward the rear while being kept in a spread state, and at this time, the front bar F2 of the bottom hem 2 of the canvas moves backward along the front bar R2 of the rectangular canvas P1, and the slider 12 of the top hem 1 of the canvas follows the movement of the front bar so as to move backward along the slide trench 111 of the main body of the roller 11 and the slide path 112, and thus, the projected corner canvas G1 moves backward in parallel, as shown in FIGS. 32(B) and 33(B).

The slider 12 to which the top hem 1 of the canvas is attached naturally moves backward to the rear half portion of the main body of the roller 11, or at least the end portion which protrudes from the projected portion of the canvas X2 is pulled down to a portion in the rear to such an extent as not to protrude from the projected corner portion N1.

Next, the electric motor M1 for winding the projected corner canvas G1 and the electric motor M2 for winding the rectangular canvas P are driven in sync.

Then, the projected corner canvas G1 is wound around the winding roller J2 from beneath with the front surface of the top hem 1 of the canvas on the inside and the rear surface on the outside, while the rectangular canvas P1 is wound around the winding roller 30 from above with the front surface of the top hem 5 of the canvas on the outside and the rear surface on the inside and wound in sync, as shown in FIGS. 32(C), 32(D), 33(C) and 33(D). At this time, the V-shaped arms V1 and V2 are folded against the resilient force to open the arms, due to a spring which is incorporated in the connection portion for folding the arms in two, and the front bar R2 and the front bar F2, which is supportedly inserted into the front bar R2, are compactly stored in the wall while translating in a straight line toward a wall portion.

Concerning Process for Unwinding and Spreading Projected Corner Canvas

Next, in the case where the projected corner canvas G1 and the rectangular canvas P1 that have been wound around the winding rollers J2 and 30, respectively, are spread to the front of the building, the electric motor M1 for the winding roller J2 and the electric motor M2 for the winding roller 38 are driven so as to rotate in the opposite direction from the above.

Then, the projected corner canvas G1 that has been wound around the winding roller J2 and the rectangular canvas P1 that has been wound around the winding roller 30 are respectively unwound, and the elastic resilience of the V-shaped arms V1 and V2 that have been folded in a wall portion are released, so that the pressing force of resilience rotates the V-shaped arms V1 and V2 in such a direction that the arms are open and, as shown in FIGS. 32(D) to 32(B) and 33(D) to 33(B), the front bar R2 into which the front bar F2 is inserted is pushed out in a straight line toward the front while moving in parallel. As a result, the projected corner canvas G1 and the rectangular canvas P1 are unwound to the front of the front wall W1 and supported in such a manner as to be spread in a tense state.

Next, the front end hook portion of an operation rod (not shown) is engaged with the engaging portion 241 of the front bar F1 from beneath, and an operation for sliding the front bar F1 toward a corner space portion is carried out.

Then, the projected corner canvas G1 moves in parallel in the transverse direction while being kept in a spread state, and pushed out to the corner space portion. At this time, the front bar F2 of the bottom hem 2 of the canvas moves transversely along the front bar R2 and the slider 12 of the top hem 1 of the canvas moves transversely along the slide trench 111 of the main body of the roller 11 and the slide path 112, and as a result, as shown in FIGS. 32(B), 32(A), 33(B) and 33(A), the projected corner canvas G1 moves forward in parallel and a projected portion of the canvas X2 is projected toward the corner space portion.

Accordingly, two sets of complex devices SQII1 described above are attached in the vicinity of the corner of the front wall W1 of the projected corner portion N1 and in the vicinity of the corner of the side wall W2 so as to form a right angle (obtuse angle or acute angle is also possible), as shown in FIGS. 23(A) and 23(B), and the two of each set are independently operated so as to spread or linked so as to operate so as to spread, and thus, the outer periphery of the building including a corner space portion in the projected corner portion N1 is covered so as to provide a good appearance.

Though the case of the above is described as a case where the awning device S1 for a projected corner and a rectangular awning device Q1 are linked in sync with the respective electric motors M1 and M2, one of the winding roller J2 and the winding roller 30 may be used as a roller for following in which a coil spring is built-in, as shown in FIGS. 29 and 30, and the other may be combined as an electrically or manually operated roller for drive.

Concerning Third Example of Winding Roller for Projected Corner Canvas

In FIG. 29 showing the winding roller J3 according to the third example, 471 is a coil spring which penetrates through the rear half portion of the main body of the roller 11 and 481 is a spring holding socket in disc form, and the front end portion 472 of the coil spring 471 is supportedly inserted into the through hole 483 created in an off-center portion, and the rear end portion 473 is supportedly inserted into the through hole 157, which is created in an off-center portion of the end cap 152.

491 is a fixed axis which is supportedly inserted into the coil spring 471 and penetrates through the hole 156 at the center of the end cap 152 and reaches the coil spring 471, so that the front end portion of the axis 492 is engaged in and fixed to the oblong hole 482 of the spring holding socket 481 and the rear end portion of the axis 493 is engaged in and secured to an oblong hole in the bearing portion 145 of the end cap 142.

Accordingly, when the winding roller J3 rotates, the coil spring 471 is gradually compressed via the end cap 152 of the main body of the roller 11, so that elastic energy is stored in the coil spring 471, or stored elastic energy is released.

Concretely, when winding of the projected corner canvas G1 around the winding roller J3 is completed, elastic energy is released with a slight amount of pressure to spare.

In contrast, elastic energy is gradually stored in the coil spring 471 as the projected corner canvas G1 spreads, and the maximum elastic resilience is stored when the canvas is completely spread.

Concerning Second Example of Winding Roller for Rectangular Canvas

In contrast to the above, in the case where the winding roller J2 is driven by the electric motor M1 shown in FIG. 9 or the winding roller J1 is driven using the manually operable device shown in FIG. 6, the coil spring 411 can be incorporated into the winding roller 30 for the rectangular canvas P1, which becomes the following side, as shown in FIG. 30. That is to say, the coil spring 411 penetrates through the rear half portion of the winding roller 30 in such a manner that the front end portion 412 of the coil spring is supportedly inserted into the through hole 423 created in an off-center portion of the spring holding socket 421, and the rear end portion 413 is supportedly inserted into the through hole 445 created in an off-center portion of the end cap 442.

In addition, the fixed axis 431 which penetrates through the coil spring 411 penetrates through the central through hole 444 of the end cap 442 and reaches the coil spring 411, and the front end portion of the axis 432 is engaged in and secured to an oblong hole 422 of the socket 421, and the rear end portion of the axis 433 is engaged with and secured to an oblong hole of the bearing portion 444 of the end cap 402.

Accordingly, when the winding roller 30 shown in FIG. 30 rotates following the rotation of the electric motor M1 shown in FIG. 9 and the manually operable device shown in FIG. 6 when driven, the coil spring 411 is gradually compressed via the end gap 442 of the roller 30 so that elastic energy is stored or stored elastic energy is released.

Concretely, when winding of the rectangular canvas P1 around the winding roller 30 is completed, elastic energy is released with a slight amount of pressure to spare.

In contrast, elastic energy is gradually stored in the coil spring 411 as the rectangular canvas P7 is spread, and the maximum elastic resilience is stored when the canvas is completely spread.

Accordingly, in the case where one is an electrically or manually operable device and the other is combined with one of the winding rollers J3 and 30 having the above described coil spring 471, appropriate elastic resilience can always be applied when the canvas is rolled around the winding roller J3 or 30, which becomes the following side, and stored, and unwound so as to spread.

Therefore, lack of tension, so that winding is completed while the canvas G1 or P1 on the following side is slack, or the canvas G1 or P1 that has been unwound on the following side is unwound in an insufficiently spread state, can be compensated for, or the tenseness is adjusted as a result of the buffering effects in the case where the tension becomes higher than necessary.

Likewise, the winding roller J2 or 30 is driven in sync with the electric motor M1 or M2 in such a manner that winding or unwinding of one of the canvases becomes insufficient in the case where the two canvases G1 and P1 are wound or unwound, and in contrast, there may be cases where the tension becomes too strong on one side in comparison with the other side.

In such a case, the coil spring 471 or 411 is incorporated into the winding roller J2 shown in FIG. 9 or the winding roller 30 shown in FIG. 28, and thus, lack of tension can be compensated for, or the effects of adjusting the tension, where tension is released so as to become appropriate, can be gained.

### Second Embodiment

The case of the complex device SQII2 in the second embodiment shown in FIGS. 34(A) to 34(D) is a case where a narrow synchronizing belt 391 is used in the same manner as in the single device S1b in the second embodiment, and the base portion of this belt is fixed to the front end portion of the main body of the roller 11 of the winding roller J1 to J3, and the front end portion of the belt is fixed to the rear surface portion close to the front end of the front bar R2.

Therefore, the belt winding device is synchronized when the projected corner canvas G1 and the rectangular canvas P1 are wound, and thus, preventing an uneven load from being applied when the projected corner canvas G1 is wound and unwound in particular, and the two front bars R2 and F2 can smoothly move in parallel in the front-rear direction with good balance and without fail.

### Third Embodiment

In the complex device SQII3 in the third embodiment shown in FIGS. 35(A) to 35(D), 393 is a narrow synchronizing belt, and the base portion of this belt is fixed to the front end portion of the long winding roller 30a which extends from a portion in the vicinity of the rear end of the device to a portion in the vicinity of the front end, while the front end portion of the belt is secured to a portion on the rear surface of the front end portion of the front bar R2. In this case, the winding roller 30a and the front bar R2 have approximately the same length.

This belt winding device is synchronized when the rectangular canvas P1 and the projected corner canvas G1 are wound or unwound, and thus, an uneven load can be prevented from being applied when the rectangular canvas P1 and the projected corner canvas G1 are wound.

### Fourth Embodiment

In the complex device SQII4 according to the fourth embodiment shown in FIGS. 36(A) to 36(D), the rectangular awning device Q2 allows the long winding roller 30a which extends from the rear end portion of the device to the front end portion of the device to wind and unwind the long rectangular canvas P2.

Therefore, the above described belt winding devices in the second and third embodiment become unnecessary. In addition, in this case, the winding roller 30a, the rectangular canvas P2 and the front bar R2 are all combined as a long device, and therefore, the rectangular canvas P2 can be wound or unwound with good balance. Therefore, it also becomes unnecessary to combine a connection wire for tensing the canvas in the main body portion of the rectangular canvas P2, as shown in FIGS. 31(A) and 31(B).

### Fifth Embodiment

The case of the complex device SQII5 in the fifth embodiment shown in FIGS. 37(A) to 37(D) is a modification where the rectangular awning device Q1 and the awning device S1 for a projected corner in the complex device SQII1 in the first embodiment are switched between the upper and lower layouts.

In FIGS. 37(A) to 37(D), R3 is the front bar of the rectangular canvas P1 and F3 is the front bar of the projected corner canvas G1, and in contrast to the case of the complex device SQII1 in the first embodiment, the front bar R3 of the rectangular canvas P1 is placed on the outer side and the front bar F3 of the projected corner canvas G1 is placed on the inner side, and thus, the two are supportedly engaged so as to be freely slidable.

In this case, the brackets 264 in the front end portions of the V-shaped arms V1 and V2 are attached in locations at the bottom of the two end portions, front and rear, of the front bar R3, and the front bar F3 of the projected corner canvas G1 is prevented from moving forward and backward.

Naturally, in this case the projected corner canvas G1, which is spread on the lower portion side, is wound from above and the rectangular canvas P1 which spreads to the upper side is wound from beneath, and thus, it is taken into consideration that the gap in the portion where the two canvases G1 and P1 overlap when the two spread becomes inconspicuous.

### Sixth Embodiment

The case of the complex device SQII6 according to the sixth embodiment shown in FIGS. 38(A) to 38(D) is a modification where the rectangular awning device Q1 and the awning device S1 for a projected corner in the complex device SQII4 in the fourth embodiment are switched between the upper and lower layouts.

In this case, as in the fifth embodiment, the front bar R3 of the long rectangular canvas P2 is placed on the outer side and the front bar F3 of the projected corner canvas G1 is placed on the inner side, and thus, the two front bars R3 and F3 are supportedly inserted so as to be freely slidable.

### Seventh Embodiment

In the case of the complex device SQII7 in the seventh embodiment shown in FIGS. 39(A) to 39(D), the projected corner canvas G1 in trapezoid form with right angles in a spread state in the above described complex device SQII4 in the fourth embodiment is replaced with a projected corner canvas G2 in approximately triangular form in a spread state (hereinafter referred to as triangular canvas).

In FIGS. 41, 531 and 532 are through holes created in bag form in the diagonal portions 3a and 3b of the triangular canvas G2, connection wires 541 and 542 penetrate through the holes, and the engaging pieces 543 and 544 in the front end portion of the wires are engaged in the engaging trench 121 of the slider 12a, which is relatively short, so as to be sandwiched by the screws 101 and 102 and fixed. The front end portion of the wires 541 and 542 are attached in locations at both ends, front and rear, of the front bar F2, to which the bottom hem 2a of the triangular canvas G2 is attached. S2 is an awning device for a projected corner using the triangular canvas G2.

Thus, the triangular canvas G2 is moved backward to a portion in the vicinity of the middle of the main body of the roller 11 of the winding roller J1 to J3, as shown in FIG. 39(B), and after that, the triangular canvas G2 and the rectangular canvas P2 are wound around the respective winding roller J1 to J3 and 30a in sync, as shown in FIGS. 39(C) and 39(D).

At this time, a bulk ring 331 in helix form where the outer diameter of the ring increases step by step is engaged between a portion in the vicinity of the middle of the main body of the roller 11 and the two end portions, front and rear, of the outer peripheral surface of the main body of the roller 11, as shown in FIG. 41(B).

As a result, a triangular canvas G2 which spreads toward the bottom can be wound around the winding roller J1 to J3 with good balance, and without causing any deterioration in the form or wrinkling due to winding.

In this case, the spread triangular canvas G2 is supported by connection wires 541 and 542 which penetrate through the diagonal portions 3a and 3b of the canvas so as to spread in a tense state, and therefore, the form can be effectively prevented from changing in the plane when the canvas is wound or slid transversely.

### Eighth Embodiment

The case of the complex device SQII8 in the eighth embodiment shown in FIGS. 40(A) to 40(D) is a case where the projected corner canvas G1 of the above described complex device SQII6 in the sixth embodiment is replaced with a triangular canvas G2, and a modification where the upper and lower portions of the triangular canvas G2 and the long rectangular canvas P2 in the above described complex device SQII7 in the seventh embodiment are switched.

In this case, the rectangular canvas P2 on the upper portion side is wound from beneath and the triangular canvas G2 on the lower portion side is wound from above, and thus, the two canvases P2 and G2 are wound around the respective winding rollers 30a and J1 to J3 in sync.

In this case, the respective components are assembled in the state shown in FIG. 42, where the triangular canvas G2 is turned upside-down relative to the case shown in FIG. 41.

Here, in this case, as in the case of the fifth and sixth embodiments, the front bar R3 of the rectangular canvas P2 is placed on the upper side and the front bar F3 of the triangular canvas G2 is placed on the inner side, and thus, the two front bars R3 and F3 are supportedly inserted so as to be freely slidable.

### Ninth Embodiment

In the case of the complex device SQII9 in the ninth embodiment shown in FIGS. 43(A) to 43(D), the V-shaped arms V1 and V2 in the complex device SQII1 in the first embodiment are replaced with the same Y-shaped arms Y1 and Y2 as in the case of the above described single device S1c in the third embodiment.

As a result, the corner projected canvas G1 and the rectangular canvas P1 can be smoothly wound and unwound and the spread projected corner canvas G1 smoothly moves forward and backward, and in addition, the parallel movability of the front bar R2 increases.

Here, as an amalgam of the above described first and ninth embodiments, the front end portion of the front bar R2 can be supported by the Y-shaped arm Y1, and the rear portion can be supported by the V-shaped arm V2.

Concerning Casing

Incidentally, though in the case of the complex devices SQII1 and 2 in the first group, the casing K2 of the rectangular canvas P1 is attached to a linear section ranging from a portion in the vicinity of the rear half at the bottom of the casing K1 of the projected corner canvas G1 to the rear portion so as to overlap with the casing K1 in the configuration, they may be integrated in one casing K3, as shown in FIGS. 44(A) and 44(B), where any of the above described winding rollers J1 to J3 and any of the winding rollers 30 shown in FIGS. 28 and 30 can be incorporated. In FIGS. 44(A) and 44(B), end caps 501 and 502 are engaged in the two end portions, front and rear, of the casing K3, and the main body of the roller 11a of the winding roller J1 to J3 extends to the rear so as to be supported with a bearing on the upper portion side on the inside of the casing K3, and one of the winding rollers 30 shown in FIGS. 28 and 30 is supported with a bearing on the lower portion side, and the front end portion is supported with a middle bearing 503. 133 is an opening in the center portion of the front surface of the casing K3 from which the projected corner canvas G1 and the rectangular canvas P1 are drawn out.

In this case, as shown in FIG. 44(C), a linking structure can be gained, where spur gears 511 and 512 are engaged with the rear end portion of the main body of the roller 11a, which extends to the rear of the device, and the rear end portion of the winding roller 30.

Therefore, one of the awning device S1 or S2 for a projected corner and the rectangular awning device Q1 or Q2 can have an electrically operable or manually operable drive structure, and the other can follow the rotation via the engagement of the spur gears 511 and 512 so as to rotate.

Concerning Complex Device in Second Group

The complex devices SUII1·2 in this group are applied to a linear section where one end is the projected corner portion N1 and the other end is a recessed corner portion L and, as shown in FIGS. 45 to 48, long and short corner canvases P3 and P4 in reverse trapezoid form with approximately right angles in a spread state which cover the corner space portion of the recessed corner portion L (hereinafter referred to as recessed corner canvas) are incorporated instead of the rectangular canvases P1 and P2 in the complex devices SQII1 to 9 of the first type.

In brief, the awning device S1 or S2 for a projected corner and the awning device U1 or U2 for long or short recessed corner canvas P3 or P4 (hereinafter referred to as awning device for recessed corner) are combined, and furthermore, the front bar F2 of the projected corner canvas G1 or G2 is supportedly inserted into the front bar R2 of the recessed corner canvas P3 or P4 so as to be freely slidable, so that the two front bars F2 and R2 are formed so as to freely move in parallel in a straight line to the front from the V-shaped arms V1 and V2.

### First Embodiment

In the case of the complex device SUII1 in the first embodiment shown in FIGS. 45(A) to 45(C) and 47, the rectangular canvas P1 in the complex device SQII1 in the first group is replaced with a recessed corner canvas P3, and the top hem 5a of the recessed corner canvas P3 shown in FIG. 46 is attached to the winding roller 30, which is formed between a portion in the vicinity of the middle of the device and a portion in the vicinity of the corner of the recessed corner portion L.

The recessed corner canvas P3 is formed in reverse trapezoid form with approximately right angles in the plane in a spread state, where the top hem 5a of the canvas, which is longer than the bottom hem 6 of the canvas, is parallel to the bottom hem 6, as shown in FIG. 46, a diagonal portion 9 of the canvas, of which the angle of inclination is approximately 45 degrees, is located between the rear end portion of the bottom hem 6 of the canvas and the rear end portion of the top hem 5a of the canvas, and a vertical portion 7 of the canvas is located between the front end portions of the top hem 5a of the canvas and the bottom hem 6 of the canvas.

Here, paths intersect in a X shape (V shape is also possible) in the plane are created in the rectangular portion of the main body of the recessed corner canvas P1, and one of the connection wires (not shown) which penetrate through the canvas is connected to the winding roller 30 or 30a and the other is connected to the front bar R2, and as a result, the form of the recessed corner canvas P3 can be prevented from changing, and the canvas is supported in such a manner as to spread in a tense state.

Therefore, as shown in FIGS. 45(A) to 45(C) and 47(A), the projected corner canvas G1, which is projected, is slid to the rear of the device through operation by being kept in a spread state, as shown in FIGS. 47(A) and 47(B), so that the protruding end of the projected portion of the canvas X2 is pulled down to a location in the rear so as not to be projected from the projected corner portion N1, in order to wind and store the projected corner canvas G1, which is projected in a corner space portion of the projected corner portion N1, and a recessed corner canvas P3, which is spread to the front of the front wall W1, which includes the corner space portion of the recessed corner portion L.

Next, when the projected corner canvas P1 and the recessed corner canvas P3 are driven and wound in sync, the projected corner canvas G1 and the recessed corner canvas P3 are wound around the respective winding rollers J1 to J3 and 30, as shown in FIGS. 47(B) to 47(D), and at the same time, the front bar R2 and the front bar F2, which is supportedly inserted into the front bar R2, are moved in parallel in a straight line toward the wall portion, while the V-shaped arms V1 and V2 are folded in two.

As a result, the entirety of the device is compactly stored in a wall portion between the projected corner portion N1 and the recessed corner portion L, as shown in FIG. 47(D).

### Second Embodiment

In the case of the complex device SUII2 in the second embodiment shown in FIGS. 48(A) to 48(D), the long rectangular canvas P2 in the complex device SQII4 in the first group is replaced with a long recessed corner canvas P4 which extends to the front end portion of the device in the same manner as the rectangular canvas P2.

Therefore, the top hem of the canvas of the recessed corner canvas P4 is attached to the long winding roller 30a, which is formed so as to have the same length as the roller between the front end portion of the device and a portion in the vicinity of the corner of the recessed corner portion L. In addition, the bottom hem of the recessed corner canvas P4 is attached along the entire length of the front bar R2.

Other parts of the configuration are the same as in the above described first embodiment, and therefore, the same symbols are attached in the drawings, and description thereof is omitted.

Here, the complex devices SUII1·2 in the second group are not limited to the above described case of the first and second embodiments, and the rectangular canvases P1 and P2 in the complex devices SQII2·3 and SQII5 to 9 in the first group can be replaced with the recessed corner canvas P3 or P4 in reverse trapezoid form with right angles, and thus, a great number of embodiments can be achieved, as in the case of the first group.

Concerning Complex Devices in Third Group

In the complex devices SQSIV1·2 in this group, the two end portions, front and rear, are projected corner portions N1 and N2, and the outer wall W1 portion between these is attached to a portion of a linear section having an appropriate length, and as shown in FIGS. 49 to 52, an awning device S1 for a projected corner which is attached to a portion close to the corner of one projected corner portion N1, an awning device S11 for a projected corner which is attached to a portion close to the corner of the other projected corner portion N2 in front-rear symmetry, and a rectangular awning device Q1 which is attached to the linear section between the two awning devices S1 and S11 are organically combined.

Thus, the two front bars F2 and F3 of the projected corner canvas G1 in the front and rear locations are supportedly inserted into the front bars R2 and R3 of the rectangular canvas P1 in the middle portion so as to be freely slidable and guided, and from among these, the front bars R2 and R3 are formed so as to freely move in parallel by means of four V-shaped arms (V1 to V4) (two arms are also possible) in locations on both sides, left and right, of the front bars.

### First Embodiment

In the complex device SQSIV1 in the first embodiment, as shown in FIGS. 49(A) and 49(B), the casings K1 for the awning devices S1 and S11 for projected corners having a winding roller J1 to J3 are attached to the two sides of the front wall W1 in such a manner that the rear surfaces of the two casings K1 face each other, and the casing K2 for the rectangular awning device Q1 is attached to a portion in the middle of the bottom of the two casings K1 located in the front and rear so as to overlap in the up-down direction.

In this case, the front bar R2 of the rectangular awning device Q1 in the middle portion is formed so as to have such a length as to extend to portions close to the ends of the corners of the two projected corner portions N1 and N2, and the two ends of the front bar are supported by the four V-shaped arms V1 to V4 at an appropriate distance between the portions on the two sides, front and rear.

Thus, the two front bars F2, front and rear, of the projected corner canvas G1 are supportedly inserted into the front and rear portions of the front bar R2 of the rectangular canvas P1 so as to be freely slidable.

Therefore, the projected corner canvas G1 on the one projected corner portion N1 side is slid towards the portion in the vicinity of the center of the device through the operation, and the projected corner canvas G1 on the other projected corner portion N2 side is slid towards the portion in the vicinity of the center of the device through the operation, as shown in FIGS. 50(A) and 50(B), and in addition, the projected corner canvas G1 on the other projected corner portion N2 side is slid towards the portion in the vicinity of the center of the device through the operation in order to wind the two projected corner canvases G1, which are projected in the corner space portions of the two projected corner portions N1 and N2, and the rectangular canvas P1, which is spread to the front of the front wall W1, for storage, as shown in FIGS. 49(A) and 50(A). Next, the two projected corner canvases G1 and the rectangular canvas P1 are driven and wound in sync, and then the projected corner canvas G1 and the rectangular canvas P1 are wound around the respective winding rollers J1 to J3 and 30, as shown in FIGS. 50(B) to 50(D), and at the same time, the front bar R2 and the front bar F2, which is supportedly inserted in the front bar R2, are linearly move in parallel towards a wall portion while the V-shaped arms V1 to V4 are being folded in two.

As a result, the entirety of the device is compactly stored in the wall portion between the projected corner portions N1 and N2, as shown in FIG. 50(D).

Here, in the case of the above, an awning device S2 for a projected corner, which is made by replacing the two projected corner canvases G1 with the triangular canvases G2 shown in FIG. 39, can be incorporated. In this case, the winding roller 30a having approximately the same length as the front bar R2 is attached to the lower portion side of the wall portion, and a long rectangular canvas P2 is attached to the above described long winding roller 30a and the front bar R2.

### Second Embodiment

In the complex device SQSIV2 in the second embodiment shown in FIGS. 51(A) and 51(B), a rectangular awning device Q1 is organically combined in an upper portion of the center between awning devices S1 and S11 for a projected corner of which the back surfaces face each other in the layout.

In addition, the front bars F3 of the two awning devices S1 and S11 for a projected corner which are located front and rear in symmetry in the layout are supportedly inserted into the portions on both sides, front and rear, of the front bar R3 of the rectangular awning device Q1 so as to be freely slid and guided rail. In addition, the two ends on both sides, front and rear, of the above described front bar R3 are supported by four V-shaped arms V1 to V4 in the same manner as in the case of the first embodiment.

In this case, unlike the case of the first embodiment, the front bar R3 is placed on the outer side and the front bars F3 located front and rear are placed on the inner side, the two projected corner canvases G1, front and rear, are wound around the winding rollers J1 to J3 from above, and the rectangular canvas P1 is wound around the winding roller 30 from below.

As a result, the three canvases G1 and P1 are compactly stored in a wall portion through the sliding process and the winding process shown in FIGS. 52(A) to 52(D) and through the folding process by means of the V-shaped arms V1 to V4.

Here, in the case of the above, an awning device S2 for a projected corner which is gained by replacing the two projected corner canvases G1 with the triangular canvas G2 shown in FIG. 40 can be incorporated. In this case, a winding roller 30a having approximately the same length as the front bar R2 is attached to the upper portion side in a wall portion, and a long rectangular canvas P2 is attached to the above described long winding roller 30a and the front bar R2.

In addition, in the case where the folding arms are Y-shaped arms Y1 to Y4 as described above, the spread projected corner canvas G1 smoothly moves transversely without fail in comparison with the case of the V-shaped arms V1 to V4 in the first and second embodiments, and the parallel movability of the transverse guide rail R1 increases.

Other parts in the configuration are the same as in the case of the first embodiment, and therefore, the same symbols are attached to the drawings and the description thereof is omitted.

Here, the V-shaped arms in the front end portion and the rear end portion of the device from among the four V-shaped arms V1 to V4 in the above described embodiments can be replaced with a Y-shaped arm Y1.

Concerning Complex Awning Devices in Fourth Group

In the complex device SSII in this group, as shown in FIGS. 53 and 54, it is assumed that the distance between two projected corner portions N1 and N1 is short in comparison with the case of the third group, and the two awning devices S1 and S11 for a projected corner overlap each other in front-rear symmetry in such a manner that their back surfaces face each other, and the respective casings K1 are attached in such a manner as to shift in the up-down direction.

In the complex device SSII shown in FIGS. 53(A) to 53(C), R4 is a transverse guide rail into which the front bars F2 and F4 of the two projected corner canvases G1, front and rear, are supportedly inserted so as to be freely slidable relative to each other, and the front end portions of two V-shaped arms V1 and V2 are attached to the two end portions, front and rear.

Therefore, the respective front bars F2 and F4 of the awning devices S1 and S11 for a projected corner are supportably inserted into the transverse guide rail R4 so as to be freely slidable relative to each other.

As a result, the two projected corner canvases G1 transversely slide relative to each other, as shown in FIGS. 54(A) to 54(D), and overlap in the up-down direction, and after that, are wound around the respective winding rollers J1 to J3, and at the same time, compactly stored in a wall portion without projecting to the front from the linear section between the projected corner portions N1 and N2 through the folding process by means of the V-shaped arms V1 and V2.

In the above described complex device SSII, though the transverse guide rail R4 and the front bars F2 and F4 are supported by the V-shaped arms, the Y-shaped arms can be replaced with Y-shaped arms Y1 and Y2.

Concerning Complex Awning Devices in Fifth Group

In the complex device in the fifth group, two complex devices SQII1 to 9 in the first group are typically combined in such a manner that they face the two projected corner portions N1, as shown in FIGS. 23(A) and 23(B), so that they operate independently or they freely link with each other.

In addition to the above, there are cases where one complex device SQII1 to 9 in the first group and one complex device SUII1·2 in the second group are combined so as to face the two projected corner portions N1 respectively, and where two complex devices SUII1·2 are combined so as to face the two projected corner portions N1 respectively.

In addition, in the case of the complex devices SUII1·2 in the second group, two complex devices SUII1·2 can face the two recessed corner portions L respectively so as to operate independently or freely link with each other.

A complex device SQSIV1·2 in the third group or a complex device SSII in the fourth group can, of course, be combined as one or two of the projected corner portions N1 so as to freely link with each other.

Concerning Transverse Device of Projected Corner Canvas

Incidentally, in the above described single devices S1a to S1d, complex devices SQII1 to 9, SUII1·2 and SQSIV1·2, the projected corner canvases G1 and G2 that have been unwound and spread to the front are transversely slid through the operation by hooking the engaging portion 241 formed in the front bar F1 to F3 with an operation rod (not shown) or by grasping the front bar in the case where the level thereof allows it to be reached with the hands.

Here, the embodiments of manually operable devices using an engaging flap or a movement conveying rope in addition to the above described hook or hands, and furthermore, canvas winding devices having a winding reel are described in sequence.

Concerning Engaging Flap

In the complex device SQII1 shown in FIGS. 55(A) to 55(C), 242 is an engaging flap formed on the rear surface in the vicinity of the front end portion of the top hem 1 of the projected corner canvas G1, and an engaging hole 243 is provided in the vicinity of the center. This engaging flap 242 can be formed by cutting the canvas cloth, as shown by two dotted chain lines in FIG. 8(C), and after that, bending the portion protruding to the above to the rear and sewing.

Thus, an operation rod is hooked in the above described engaging hole 243, and the projected corner canvases G1 and G2 are transversely slid through the operation.

Here, in the case of the above, a slit (not shown) for guiding an operation rod, into which the operation rod is inserted, is created in the center portion of the bottom plate of the casing K1 in the longitudinal direction, or it may be necessary to use a casing K1 without the bottom plate portion. In the case where the above described engaging hole 243 is created in a location which is exposed from the opening through which the canvas is drawn out 131 in the casing K1, it is, of course, not necessary to provide a slit as described above.

Concerning Manually Operable Device of Movement Conveying Rope

In the case of the complex device SQII1a shown in FIGS. 56(A) to 56(C), a movement conveying rope (wire is also possible) is placed using the V-shaped arm V1 in the front end portion of the device, and the figures show a case where the movement conveying rope is manually operated.

In the figures, 551 to 553 are slide guides formed in an upper end portion of the fulcrum portion of the V-shaped arm V1, and two movement conveying ropes 561 and 562 run through an annular trench created in the upper end portion of the slide guides 551 to 553 so as not to disengage.

571 is a protruding piece formed on the rear surface in the front end portion of the front bar F2, and the front end portion of one rope 561 which is wound from the rear portion of the slide guide 553, which is formed in the upper portion of the bracket 263 of the V-shaped arm V1, to the front is bound to the protruding piece by a nut 573 so as to be fixed.

572 is a protruding piece formed in the middle portion between the front and the rear of the front bar F2 towards the rear surface in the rear portion, and the front end portion of the other rope 562 which is wound from the front of the slide guide 553 to the rear is bound to the protruding piece by a nut 574 so as to be fixed. In addition, the base portions of the movement conveying ropes 561 and 562 on the wall side lead out through a through hole created vertically to the main body portion of the bracket 261 of the V-shaped arm V1 and are hung and spread downwards. 563 and 564 are handles for operating base portions of the movement conveying ropes 561 and 562 and are formed in ring form or node form.

Thus, when one of the movement conveying ropes 561 and 562 which runs between the V-shaped arm V1 and the front bar F2 in the complex device SQII1a shown in FIG. 56(A), for example, the handle 563 of the movement conveying rope 561, is pulled down, the bracket 571 in the front end portion of the front bar F2 is pulled towards the rear of the device. As a result, the corner projected canvas G1 transversely slides to the rear while being kept in a spread state from the corner space portion, as shown in FIGS. 57(A) and 57(B), and is pulled down to a location in front of the front wall W1. At this time, the handle 564 of the other movement conveying rope 562 is naturally pulled up from the bottom to the top.

In contrast, when the handle 564 of the other movement conveying rope 562 is pulled downwards, the bracket 572 in the rear portion of the middle of the front bar F2 is pulled towards the device. As a result, the corner projected canvas G1 transversely slides towards the corner space portion, and thus, moves forward while being kept in a spread state, as shown in FIGS. 57(B) and 57(A), and then, is projected in the corner space portion.

At this time, the handle 563 of the other movement conveying rope 561 is pulled from the bottom to the top.

Accordingly, one movement conveying rope 561 functions as a means for moving the projected corner canvas G1 backwards, and the other movement conveying rope 562 functions as a means for moving the projected corner canvas G1 forwards.

In the case of the above, though two movement conveying ropes 561 and 562 are placed, they can be replaced with one rope, for example, an endless rope where the portions of the operation handles 563 and 564 are directly connected. In the case of the above, though movement conveying ropes 561 and 562 run across the V-shaped arm V1, they may be hooked between the rear half portion of the main link 291 and the sub-link 292 of the Y-shaped arm Y1 in the complex device SQII9 so that they can be incorporated in the same manner as in the above.

Though in the case of the above movement conveying ropes 561 and 562 are incorporated in the complex device SQII1a, the ropes can run across the V-shaped arms V1, the arms Y-shaped Y1 or the front bar F1 in the single devices S1a to S1c in the same manner.

Here, in the case of the single device S1d shown in FIGS. 15 to 17, a slide guide (not shown) is provided in the vicinity of the middle between the bracket 261 of the base portion and the I-shaped arm I1, and a slide guide (not shown) is provided also in an appropriate portion in the vicinity of the middle of the transverse guide rail R1 so that the movement conveying ropes 561 and 562 can cross in such a state as to be folded in two in the same manner as in the above described cases of the V-shaped arms V1 and the Y-shaped arms Y1, and thus, the projected corner canvas G1 can be slid through a manual operation.

Concerning Canvas Winding Device Having Winding Reel

Next, in the complex device SQII1b shown in FIGS. 58(A) and 58(B), 60 is a winding reel engaged in the front end portion of the main body of the roller 11 so as to be freely rotatable forward and backward, which is divided into a front reel 601 and a rear reel 602 which are located in the front and in the rear with an annular brim portion formed in the middle of the outer periphery as a border. From among these, one of the movement conveying wires 561 and 562 is wound around either reel 601 or 602, while the other movement conveying wires 561 or 562 wound around the other reel 601 or 602 is unwound, and thus, the projected corner canvas G1 is transversely slid and moved forward and backward.

Thus, one wire for forward movement 562 from among the movement conveying wires 561 and 562 that lead out from the slide guide 551 in the base portion is wound around the rear reel 602 located approximately directly above the bracket 261 in spiral form, as shown in FIG. 58(B), and the base portion of the wire is fixed to the rear portion of the rear reel. In addition, the base portion of the other wire for backward movement 561 is fixed to the rear portion of the front reel 601.

581 and 582 are coil springs which are attached to the front end portions of the respective movement conveying wires 561 and 562 so as to press and support the movement conveying wires 561 and 562 which run between the front bar F2, the V-shaped arm V1 and the winding reel 60 in a tense state.

Other parts of the structure of the movement conveying wires 561 and 562 are the same as in the case of the above described movement conveying rope, and therefore, the same symbols are attached, and description thereof is omitted.

Next, the schematic diagram in FIG. 59(A) shows a case where the two electric motors M1 and M4 which are incorporated in the main body of the roller 11 of the winding roller J4 individually rotate as the drive system in the canvas winding device into which the above described winding reel 60 is incorporated, where the projected corner canvas G1 or G2 is wound and unwound by means of one electric motor M1, while the winding reel 60 rotates forward and backward by means of the other electric motor M4, and thus, the spread projected corner canvas G1 is driven so as to move transversely.

In addition, in the case of the schematic diagram in FIG. 59(B), one electric motor M5 is incorporated in the main body of the roller 11, so that when the operation of one of the winding roller J5 and the winding reel 60 is restricted, and thus, the rotation is stopped, the other winding roller J5 or winding reel 60 recoils and rotates.

As a result, winding and unwinding of the projected corner canvases G1 and G2, and in addition, transverse driving of the projected corner canvases G1 and G2 can be carried out by means of one electric motor M5.

Therefore, the winding roller J4 in the fourth example for individually rotating the two electric motors M1 and M4 shown in FIG. 60 and the recoiling rotation type winding roller J5 in the fifth example, into which one electric motor M5 is incorporated, as shown in FIG. 61, are described.

Furthermore, a case where the differential gear mechanism shown in FIGS. 65(A) and 65(B) is incorporated, the winding roller J6 in the sixth example having one electric motor M6 shown in FIG. 66 where a differential gear mechanism is implemented and the winding roller J7 in the seventh example, into which the manually drivable device shown in FIG. 67 is incorporated, are described below.

(1) Concerning Fourth Example of Winding Roller

In FIG. 60, 156 is an end cap in the front end portion of the main body of the roller 11, 157 is a circular hole in the cap, 603 is a circular hole in the winding reel 60, 604 is a protrusion formed in the inner wall portion of the circular hole 603, 591 is a front end axial portion of the electric motor M4, 592 is a trench created in the front half of the main body of the electric motor M4, and 146 is an end cap which functions as a casing for the winding reel 60, where long guide holes 148 and 149 through which the movement conveying wires 561 and 562 penetrate are created in parallel at the bottom.

Thus, the rear half of the main body of the electric motor M4 penetrates through the front end portion of the main body of the roller 11, and the winding reel 60 is engaged in the front half of the main body of the electric motor M4 so as to be fixed, and in addition, the front end axial portion 591 of the electric motor M4 is engaged in an oblong hole in the bearing portion 147 of the end cap 146 so as to be secured. Other parts of the configuration are the same as in the winding roller J2 in the second example shown in FIG. 9, and therefore, the same symbols are attached in the drawings, and description thereof is omitted.

Thus, the electric motor M4, which is incorporated as described above, is rotated in either direction, forward and backward, for example it is rotated so that the main body of the motor rotates, the winding reel 60 rotates together in such a manner that one wire, that is to say, the wire for backward movement 561, is wound around the front reel 601 in spiral form, and at the same time, the other wire wound around the rear reel 602, that is to say, the wire for forward movement 562, is unwound.

As a result, as shown in FIG. 62(A), the projected corner canvas G1, which is projected in the corner space portion, is moved backward to the location shown in FIG. 62(B) while being slid transversely.

When this is sensed, the electric motor M1 shown in FIG. 9 and the electric motor M2 for the rectangular canvas P1 shown in FIG. 28 rotate in sync so that, as shown in FIGS. 62(B) to 62(D), the arms V1 and V2 are folded in two against the pressing force for opening the V-shaped arms V1 and V2 while the projected corner canvas G1 is wound around the winding roller J4 from beneath and the rectangular canvas P1 is wound around the winding roller 30 from above, and thus, the two canvases G1 and P1 are wound and stored.

In contrast, when the electric motors M1 and M2 operate in sync so that the two canvases G1 and P1 that have been wound around the respective winding rollers J4 and 30 are rotated so as to be unwound, the force for opening the V-shaped arms V1 and V2 works in such a manner that the front bars F2 and R2 are pressed so as to move in parallel in a straight line toward the front, and thus, the two canvases G1 and P1 that have been wound around the respective winding rollers J4 and 30 are unwound so as to spread.

When this is sensed, the electric motor M4 rotates in the direction opposite to that above, and thus, the winding reel 60 is rotated so that the wire for forward movement 562 is wound around the rear reel 60, and at the same time, the wire for backward movement 561 that has been wound around the front reel 601 is unwound.

As a result, the projected corner canvas G1 is slid transversely toward the corner space portion so as to be projected.

(2) Concerning Fifth Example of Winding Roller

In FIG. 61, the support axis 593 is formed in the front end portion of the electric motor M5, and the motor output axis 594 is formed in the rear end portion.

Therefore, a trench 592 created in the front half of the main body of the electric motor M5 engages the protrusion 604 formed in the inner wall portion of the winding reel 60, the rear half of the main body of the electric motor M5 penetrates through the front end portion of the main body of the roller 11, and the motor output axis 594 is inserted through the hole 282 in the movement conveying socket 281 which is engaged in the main body of the roller 11 so as to be fixed.

In addition, the support axis 593 of the electric motor M5 is supported by the bearing portion 143 of the end cap 146, which also functions as a casing for the winding reel 60, in such a manner as to be freely rotatable.

135 is a guide protrusion provided on the inner wall surface of the rear plate portion of the casing K1 so as to protrude in the lateral direction, 611 is a rotational stopper in band plate form having an elastic force as that of a spring where the base portion is fixed to the rear end portion of the main body of the roller 11 with screws 612, and the front end portion of the stopper is engaged with the above described guide protrusion 135 so that the rotational stopper is guided and moves together with the main body of the roller 11, and when the engagement is released, makes close contact with the outer peripheral surface of the main body of the roller 11 so as to be wound.

Other parts of the configuration are the same as in the winding roller J2 in the second example shown in FIG. 9 and the winding roller J4 in the fourth example shown in FIG. 60, and therefore, the same symbols are attached in the drawings, and description thereof is omitted.

Thus, the process of operation using one electric motor M5 which is incorporated as described above is described below in reference to FIGS. 63(B) to 63(F) and 64(G) to 64(K). FIG. 63(A) is a plan diagram showing the cross section of the winding roller J5 for the projected corner canvas G1 and the casing K1 at the point in time when the spread projected corner canvas G1 is projected in the corner space portion in the projected corner portion N1.

FIGS. 63(B) to 63(F) show the process through which the spread projected corner canvas G1 in such a state as to be projected in the corner space portion is moved backward and wound around the winding roller J5 so as to be stored step by step, and the left side in each diagram shows the respective cross sections along line a-a, line b-b and line c-c in FIG. 61(A), and perspective diagrams showing the main portion at the point in time are added on the right side.

In addition, FIGS. 64(G) to 64(K) show the process for unwinding and spreading the projected corner canvases G1 and G2 that have been wound around the winding roller J5 to the front, and after that moving the canvases forward toward the corner space portion so that they are projected step by step in reverse.

Here, in each drawing, grey arrows indicate the actual movement, and white arrows with two-dot chain lines indicate the force of reaction generated at the time.

Concerning Process Through which Projected Corner Canvas Slides Backward And Process Through which Canvas is Wound Around Winding Roller so as to be Stored

In the state in FIG. 63(B), the projected corner canvas G1 in the complex device SQII1b shown in FIG. 58(A) is projected in the corner space portion, and the front bar F2 is pulled out to the front end portion.

Therefore, in order to wind the projected corner canvas G1 so as to be stored from this state, first the electric motor M5 is driven and the roller J5 and the reel 60 are rotated relative to each other so that the winding roller J5 rotates in the clockwise direction on the paper, as shown in FIG. 63(C) (winding reel 60 rotates in the counter-clockwise direction on paper).

At this time, the load applied by the wire for backward movement 562 which pulls the front bar F2 for counter-clockwise rotation of the winding reel 60 on the paper is approximately equal to the frictional resistance between the front bars F2 and R2, which is extremely small.

In contrast, the load applied by the front bars F1 and F2 pressed by the V-shaped arms V1 and V2 so as to open in the clockwise on the paper of FIG. 63(C) and the spread projected corner canvas G1 for clockwise rotation of the winding roller J5 on the paper is extremely large.

As a result, the winding roller J5 stays still, without rotating, and only the winding reel 60 rotates, counter-clockwise on the paper, as shown in FIGS. 63(C) and 63(D).

Therefore, the wire for backward movement 561 is wound around the front reel 601 and the wire for forward movement 562 of the rear reel 602 is unwound, and thus, the drive force is conveyed in such a direction so as to pull the front bar F2 of the projected corner canvas G1 to the rear.

As a result, as shown in FIG. 62(A), the projected corner awning device S1 which is projected in the corner space portion operates as shown by arrows in the respective portions added in the drawings, and moves transversely to the predetermined rear portion shown in FIG. 62(B).

This operation continues, as shown in FIG. 63(D), even after the winding of the wire for backward movement 561 around the front reel 62 is completed, or the backward movement of the front bar F2 stops, that is to say, rotation in the same direction by means of the electric motor M5 continues while the winding reel 60 stops rotating counter-clockwise after this.

As a result, as shown in FIG. 63(E), the winding roller J5 rotates clockwise on the paper, resisting the load of the force for pressing and opening the above described V-shaped arms V1 and V2, that is to say, the load applied to the front bar F2, and thus, the winding operation of the projected corner canvas G1 around the winding roller J5 is started, and the winding operation of the rectangular canvas P1 around the winding roller 30 is started in sync with this.

At the initial stage of this winding, as shown in FIG. 63(E), the rotational stopper 611 is wound together with the projected corner canvas G1 in such a state as to make close contact with the rear end portion of the main body of the roller 11, and after that, as shown in FIG. 63(F), the operation of winding the projected corner canvas G1 is carried out.

In the case of the complex device SQII1b shown in FIG. 62, naturally the electric motor M2 for the rectangular canvas P1 starts rotating in sync with the start of winding around the winding roller J5 and, as shown in FIGS. 62(B) to 62(D), the V-shaped arms V1 and V2 are folded in two against the force for pressing and opening the arms V1 and V2 while the projected corner canvas G1 is wound around the winding roller J5 and the rectangular canvas P1 is wound around the winding roller 30, and thus, the two canvases G1 and P1 are wound so as to be stored.

Concerning Process Through which Projected Corner Canvas is Unwound and Spread and Process Through which Canvas is Slid Forward to Corner Space Portion

In order to spread the projected corner canvas G1 and the rectangular canvas P1 that have been wound and stored as described above, the electric motor M5 is rotated in the direction opposite to that above, and the winding roller J5 and the winding reel 60 are rotated relative to each other, so that the winding roller J5 rotates counter-clockwise on the paper (winding reel 60 rotates clockwise on paper), as shown in FIG. 64(G).

At this time, force for pressing and opening the V-shaped arms V1 and V2 to the front is applied to the winding roller J5, and the rotational torque works counter-clockwise on the paper, due to the force for spreading and tensing the front bar F2 and the projected corner canvas G1.

At this point in time, the wire for forward movement 562 and the wire for backward movement 561 are in such a state as not to work as a load for preventing rotation of the winding reel 60, which is clockwise on the paper, or as torque for accelerating the rotation.

In the case where the winding roller J5 and the winding reel 60 are rotated relative to each other in this state, as shown in FIGS. 64(G) to 64(H), the winding reel 60 stays still, and only the winding roller J5 starts rotating, counter-clockwise on the paper, and the winding roller 30 for the rectangular canvas P1 starts the operation of unwinding in sync with this, so that the two synergize for the operation of spreading the projected corner canvas G1 and the rectangular canvas P1 to the front.

In addition, as shown in FIG. 64(H), when the spreading operation of the projected corner canvas G1 to the front nears completion so that only the last cycle is left, the rotational stopper 611 that is pressed down by the projected corner canvas G1 is released and pressed up, and the front end portion thereof is engaged with the protrusion 135 guided by the casing K1 at the stage of FIG. 64(I), and as a result, counter-clockwise rotation of the winding roller J5 is prevented, and thus, the operation of spreading the projected corner canvas G1 and the rectangular canvas P1 is completed.

The electric motor M5 still continues rotation, and the following moment, the winding reel 60 starts rotating clockwise on the paper, as shown in FIG. 64(J).

Then, the wire for forward movement 562 is wound around the rear reel 602 and the wire for backward movement 561 is unwound around the front reel 601, and as a result, the front bar F2 is transversely slid in the forward direction, so that the projected corner canvas G1 is spread toward the corner space portion.

Here, though in the case of the above, operation process in the case where the winding rollers J4 and J5 in the fourth and fifth embodiments are drive devices in the complex device SQII1b shown in FIG. 58(A) is described, they may be adopted as drive devices for the single devices S1a to S1c or the complex devices in the second to fourth groups, in addition to the above. Here, the operation process for these is the same as in the case of the above, and therefore, description thereof is omitted.

Concerning Winding Roller in Sixth Example of Projected Corner Canvas

The winding roller J6 in the sixth example, in which the differential gear mechanism shown in FIGS. 65(A) and 66 is incorporated, is described below. 70 is a gear with outer cogs (hereinafter referred to as sun gear) formed in a location in the main body portion close to the front end of the electric motor M6, which is engaged in this portion so as to be fixed, or the gear with outer cogs 70 is integrally formed in the main body portion of the motor. 71 is a gear with inner cogs formed on the inner peripheral surface of the rear reel 602 in the winding reel 60a, 72 is approximately four small gears (hereinafter referred to as planetary gears) which engage with the gear with inner cogs 71 and the sun gear 70, and the support axis 721 is piled into the end cap 156, which is engaged with the front end portion of the main body of the roller 11.

Accordingly, in the case of this winding reel 60a, protrusions 604 formed on the above described winding reel 60 become unnecessary, and trench 592 created in the main body portion of the electric motor M6 also becomes unnecessary. 283 and 284 are a bearing socket for supporting the rear end portion of the electric motor M6 and a hole through which the socket penetrates. Thus, the rear end portion of the main body of the electric motor M6 is inserted through the front end portion of the main body of the roller 11, and the rear end portion of the motor is inserted into the bearing socket 283, which is engaged with the main body of the roller 11 so as to be supported.

Next, the end cap 156 provided with the protruding planetary gears 72 is engaged in the front end portion of the main body of the roller 11, and the planter gears 72 are engaged with the sun gear 70.

Then, the winding reel 60a is engaged in the front end portion of the electric motor M6 and the gear with inner cogs 71 is engaged with the planetary gears 72 so that a differential gear column is formed.

In addition, the support axis 591 for fixing the front end portion of the electric motor M6 is engaged in the oblong hole in the bearing portion 147 of the end cap 146 so as to be fixed.

Other parts of the configuration are the same as in the winding roller J5 in the fifth example shown in FIG. 61, and therefore, the same symbols are attached in the drawings, and description thereof is omitted.

In this case, when the operation of one of the winding roller J6 and the winding reel 60a is restricted so that the rotation stops, as in the above described winding roller J5 in the fifth example, the other rotates in reverse in the structure.

Accordingly, when the electric motor M6 is driven and rotated, and then the winding reel 60b is restricted from rotating, the winding roller J6 reduces the speed of rotation in the same direction as the electric motor M6 and winds the projected corner canvas G1, so that the canvas is wound and stored, or unwinds the canvas, so that the canvas is spread to the front through the operation.

In addition, when the rotation of the winding roller J6 is restricted, the winding reel 60b rotates in reverse at the same speed and pulls out the projected corner canvas G1 to the corner space portion, or operates in such a manner as to pull back the canvas to the rear.

In the case of the above described differential gear column, the speed of rotation of the winding reel 60b becomes twice that of the winding roller J6, and therefore, the operation for sliding the front bar F2 having a small load transversely works through high-speed rotation with low torque, and the operation of winding the canvas with a large load is carried out through low-speed rotation with high torque, and thus, the operation is carried out efficiently.

Here, in the process through which the projected corner canvases G1 and G2 slide backward due to the drive of the electric motor M6 and in the process through which the canvases are wound around the winding roller J6 so as to be stored, the canvases are wound and stored in the process shown in FIGS. 63(B) to 63(F), as in the winding device having the above described electric motor M5.

In addition, in the process through which the projected corner canvases are unwound and spread, and in the process through which the canvases are slid forward into the corner space portion, the canvases are projected in the corner space portion through the process shown in FIGS. 64(G) to 64(K).

Concerning Winding Roller in Seventh Example of Projected Corner Canvas

The winding roller J7 in the seventh example, in which the differential gear mechanism shown in FIGS. 65(B) and 67 is incorporated, is described below. 73 is a drive axis, and a sun gear 70 is engaged in a portion close to the middle thereof so as to be fixed, and the drive axis 73 is formed so as to be rotated forward and backward by means of a manually operable device formed in the front end portion of the axis.

Thus, the bearing socket 283 is engaged inside the main body of the roller 11, and after that, the end cap 156 provided with protruding planetary gears 72 is engaged in the front end portion of the main body of the roller 11.

Next, the rear half of the main body of the drive axis 73, in which the sun gear 70 is engaged, penetrates through the through hole 158 in the end cap 156 inside the main body of the roller 11 so that the rear end portion of the drive axis 73 penetrates through the through hole 285 of the bearing socket 283 so as to be supported, and the planetary gears 72 and the sun gear 70 are engaged with each other. In addition, the winding reel 60b is engaged in the drive axis 73 and the gear with inner cogs 71 formed on the inner periphery portion of the rear reel 602 is engaged with the above described planetary gears 72, and thus, a differential gear column is formed.

In addition, a worm gear 161 is engaged with a portion close to the end of the drive axis 73, and the roller 163 in which a worm gear 162 which engages the gear 161 is engaged is supported with a bearing so as to be perpendicular to the end gap 146, and in addition, the front end portion of the drive axis 73 is supported by the bearing portion 143 of the axial end cap 146 in such a manner so as to be freely rotatable.

Other parts of the configuration are the same as in the case of the winding roller J in the sixth example shown in FIG. 66, and therefore, the same symbols are attached in the drawings, and description thereof is omitted.

In this case, a manually drivable device for rotating the drive axis 73 forward and backward through manual operation is used instead of the electric motor M6 for driving the winding roller J6 in the sixth example. The process for operating this is the same as in the case of the sixth example, and therefore, description thereof is omitted.

### 3. Concerning Lateral Arm Type Complex Awning Device

This is a complex case where the awning device S1 for a projected corner according to the present invention is organically incorporated in the base of a lateral arm type movable awning device where the front bar R2 of the rectangular canvas P1 is supported by foldable arms which freely extend upward in the vertical direction, or by an expandable link having a pantograph structure, and this is mainly incorporated in the projected corner portion N1 of shops located at the corner of a building.

### Concerning First Embodiment

In the complex device SQL1 shown in FIGS. 68 to 70, Z1 and Z2 are foldable arms which support the two end portions of the front bar R2 and freely extend (hereinafter referred to as extendable arms) where the inner pipe 651 and the outer pipe 652 are supportedly inserted so as to be freely slidable so that the two pipes are fixed with a thumb screw 653 or a ring nut (not shown). 641 is a bracket fixed to pillars H1 and H2 or a gate type frame or a longitudinal wall portion in portions on the two sides of the shop, and the lower end portion of the above described inner pipe 651 is supported around a pin. The upper end portion of the outer pipe 652 is attached to the two end portions of the front bar R2.

654 is a reinforcing rod for the extendable arms Z1 and Z2 which is diagonally fixed to a portion where the outer pipe 652 and the front bar R2 are put in the corner.

Next, a configuration where a movement conveying rope 66 for operating and sliding the front bar F2 is provided is described. 671 and 672 are engaging portions which are attached to the bottom of the front end and the bottom in the vicinity of the middle of the front bar F2, and 673 and 674 are engaging portions which are attached to the upper and lower two end portions of the outer pipe 652, and one movement conveying rope 66 runs around these engaging portions 671 to 674.

One front end portion of the movement conveying rope 66 is tied to the engaging portion 671 at the front end of the front bar F2, and the other is pulled along the front bar F2 to the vicinity of the middle of the front bar so as to penetrate through the engaging portion 673 at the upper end of the outer pipe 652 and bend downward, pulled downward along the outer pipe 652, penetrates through the engaging portion 674 at the lower end, returns, and after that is pulled up, again penetrates through the engaging portion 673 at the upper end, and is bent to the rear, and then the rear end portion of this rope is tied to the engaging portion 672 in the middle of the front bar F2.

Here, engaging portions 241 which are operated manually are also formed in the vicinity of the rear portion and the middle portion of the front bar F2.

Thus, as shown in FIGS. 68(A) and 69(A), in order to operate and slide the projected corner canvas G1 which is projected in the corner space portion, first an operation rod (not shown) is hooked onto the engaging portion 241 from beneath so as to be pulled to the rear, and thus transversely slid.

Alternatively, in the case where the movement conveying rope 66 for manual operation is provided as described above, as shown in the upper portion of FIG. 68(B), one of the double loop movement conveying ropes 66 that returns is pulled down toward the lower side of the outer pipe 652 through the operation.

Then, the pulling force is conveyed in the direction of the arrow in the drawing so that the front bar F2 of the projected corner canvas G1 is transversely slid along the front bar R2 of the rectangular canvas P1, and the slider 12 to which the top hem of the projected corner canvas G1 is fixed is transversely slid in parallel to the rear along the slide trench 111 of the main body of the roller 11 and the slide path 112, and thus, the projected corner canvas G1 overlaps with the rectangular canvas P1 in the up-down direction.

Next, the thumb screw 653 or the ring nut is loosened, before the operation of winding the two canvases G1 and P1 in sync, and after that, the front bars F2 and R2 are pulled down, as shown in FIG. 69(B), and then, the outer pipe 652 is slid and contained in the inner pipe 651, as shown in FIGS. 69(C) and 70(C), and thus, the extendable arms Z1 and Z2 are drawn in close to the wall side.

Next, when the winding roller J1 to J3 for the projected corner canvas G1 and the winding roller 30 for the rectangular canvas P1 are wound in sync, as shown in FIGS. 69(D) and 70(D), the two canvases G1 and P1 are wound around the respective winding rollers J1 to J3 and 30, and at the same time, the extendable arms Z1 and Z2 are pulled up in the vertical direction, and thus compactly stored in the wall portion in a raised position.

In contrast, the two canvases G1 and P1 are unwound, and thus, the two canvases are spread to the front in a relatively steeply inclined state, as shown in FIGS. 70(D) and 70(C), that is to say, in such a state that the front is quite low.

Next, as shown in FIGS. 70(C) and 70(B), the front bars F2 and R2 are pushed up to the front so that the drawn-in extendable arms Z1 and Z2 extend, and these are bound with a thumb screw 653 or a ring nut so as to be fixed.

Then, an operation rod (not shown) is engaged with the engaging portion 241 from beneath and pulled toward the corner space portion, and thus, the projected corner canvas G1 is transversely slid so as to protrude in the corner space portion.

Alternatively, as shown in the upper portion of FIG. 68(B), the other double loop movement conveying ropes 66 that returns is pulled down toward the lower side of the outer pipe 652 through operation.

Then, the pulling force is conveyed in the direction opposite to the arrow in the figure, and the front bar F2 of the projected corner canvas G1 is transversely slid along the front bar R2 for the rectangular canvas P1, and the slider 12 in the top hem of the projected corner canvas G1 is transversely slid in parallel along the slide trench 111 of the main body of the roller 11 and the slide path 112 so that the corner projected canvas G1 is projected in the corner space portion.

Though in the case of the above, a case of extendable arms Z1 and Z2 for raising the foldable arms in the vertical direction through operation is described, the front bar R2 may be pushed up by supporting arms (not shown) having a constant length so that the projected corner canvas G1 and the rectangular canvas P1 which are spread to the front are supported in a tense state.

### Concerning Second Embodiment

In the complex device SQL2 shown in FIG. 71, Z3 and Z4 are foldable arms having a pantograph structure formed of links that are freely expandable (hereinafter referred to as expandable links) where several pairs of links 691 and 692 having the same length are connected in X shape and the base portions are attached to the bracket 681, which is secured to the upper portion of the support pillars H1 and H2 in such a manner so as to be rotatable.

682 is a long guide hole which is longitudinally provided in an upper portion of the bracket 681, and the rear end portion of the link 691 in the rear portion is provided in the long guide hole. In addition, a rising link 693 which is appropriately bent is formed in the front end portion of the other link 692 in the front portion, and the front bar R2 of the long rectangular canvas P2 is attached to this front end portion.

In this case, the front bars F2 and R2 are held with both hands and pulled to the front so that the expandable links Z3 and Z4 extend through operation, and thus, the projected corner canvas G1 and the rectangular canvas P2 are spread to the front, and in contrast, they are pushed to the rear so that the two canvases G1 and P1 can be wound and stored in the wall.

Though in the case of the above, the front bars F2 and R2 are pulled out or pushed in through manual operation, the above described expandable links Z3 and Z4 can be operated so as to extend or be drawn in by means of an electrically-driven device (not shown).

Other parts of the configuration are the same as in the above described complex device SQL1, and therefore, the same symbols are attached in the drawings, and description thereof is omitted.

Incidentally, in the case of the above described various types of complex devices, two casings K1 and K2 where the winding roller J1 to J7 is stored are attached in such a manner as to overlap with the outside wall W1 and W1 potion in the up-down direction, while the front bars F2, F3, R2 and R3 for supporting the bottom hems 2, 2a and 6 of the respective canvases G1, G2 and P1 to P4 are usually inclined at an appropriate angle and spread to the front with the front lowered. Therefore, the force of tension on the two canvases when spread is set approximately the same, it is assumed that as opposed to the above, the canvas on the upper side is finally wound in a slack state, for example, approximately several cm to 10 cm is left relative to the canvas on the lower side when the two canvases are wound in sync so as to be stored.

In order to solve this problem, it is effective to deal with the problem by incorporating coil springs 471 and 411 inside the rollers as the winding roller J3 shown in FIG. 29 and the winding roller 30 shown in FIG. 30, but other simple compensatory means are possible, as in the examples shown in FIGS. 72 and 73.

Concerning Instrument for Supporting Canvas in Tense State, that is to Say, Instrument for Preventing Canvas from Becoming Loose when Stored

In FIG. 72, 62 is an elastic fluctuating flap, and the base portion thereof is attached to the rear end of the upper plate portion 342 of the front bar F2 of the projected corner canvas G1 or G2 and, as shown in FIG. 72(A), the front end portion of the fluctuating flap 62 is pressed, so that the bottom hem 2 of the projected corner canvas G1 or G2 is pressed from the bottom to the top.

Accordingly, as the projected corner canvases G1 and G2 of the complex devices SQII1 to 4 and SQII7·9 are wound, the front end portion of the flap is gradually pressed and rises, as shown in FIG. 72(B), and when the canvases are finally wound and stored, the front end portion stands, as shown in FIG. 72(C), so as to push up the bottom hem 2 of the wound canvas and support it in a tense state.

As a result, the projected corner canvases G1 and G2 can be prevented from becoming loose when the canvas is wound and stored, and thus, the force for tensing the canvas can be maintained so as to provide a good appearance.

Though in the case of the above, the upper portion side is the projected corner canvases G1 and G2 and the lower portion side is the rectangular canvases P1 and P2 (recessed corner canvases P3 and P4 are also possible) in the combination, in the case of the complex devices SQII5·6·8, where the above described canvases are upside-down, in terms of the layout, the bottom hem 6 of the rectangular canvases P1 and P2 on the upper portion side is pressed and pushed up by the fluctuation flap 62, which is attached to the rear upper end portion of the front bar R3 on the outer side.

In summary, the canvases G1, G2, P1 and P2 on the upper portion side and on the lower portion side are wound in sync so that the bottom hem 2 and 6 of the upper portion side canvas are pressed and pushed up by the fluctuation flap 62, and thus, the upper portion side canvas can be wound and stored in such a state so as to have appropriate tenseness.

Concerning Device for Supporting Canvas in Tense State, that is to Say, Device for Absorbing Slack Canvas at Time of Storage

In FIG. 73, 631 is an expandable net made of rubber for supporting the projected corner canvases G1 and G2 in a tense state, and provided on the rear surface of the projected corner canvases G1 and G2 close to the bottom hem 2.

633 is a flat ring string attached to the rear portion in the vicinity of the bottom hem 2 with a space, and a rod 632 penetrates through this ring string 633 and a rubber string which is freely extendable crosses in zigzag form between the rod 632 and the rear end portion of the upper plate portion 342 of the front bar F2, and thus, the expandable net 631 is created.

Accordingly, as shown in FIG. 73(B), the elastic force resulting from the expandable net 631 is effectively applied when the projected corner canvas G1 or G2 in the complex devices SQII1 to 4 and SQII7 is spread to the front to the maximum, and thus, the projected corner canvas G1 or G2 is kept in a tense state.

In contrast, when the projected corner canvas G1 or G2 is wound and stored, as shown in FIG. 73(C), the expandable net 631 contracts and force with appropriate tenseness is maintained, while extra hem 2 of the canvas is bent so as to be layered, and thus, the portion which becomes loose when wound is absorbed so as to provide a good appearance.

In this case also, an expandable net 631 which is the same as in the above is spanned on the rear surface of the rectangular canvas P1 or P2 on the upper portion side close to the bottom hem 6, and thus, the canvas on the upper portion side is tensed when the canvas is spread, and in addition, the portion of the canvas on the upper portion side which becomes loose is absorbed so as to provide a good appearance when the canvas is wound and stored in the case of the complex devices SQII5·6·8, where the canvases G1, G2, P1 and P2 on the upper portion side and the lower portion side are combined upside-down, in the same manner as in the case of the embodiment using the above described fluctuating flap 62.

Incidentally, in the above described complex devices SQII1 to 9, the projected corner canvas G1 or G2 is wound from beneath and the rectangular canvas P1 or P2 is wound from above (recessed corner canvas P3 or P4 is also possible) or, in contrast, the rectangular canvas P1 or P2 is wound from beneath and the projected corner canvas G1 or G2 is rolled from above, and thus, it is taken into consideration that the gap between the top hems 1 of the canvases after being spread and the step in the vicinity of the border between the projected corner canvas G1 or G2 and the rectangular canvas P1 or P2 becomes inconspicuous. The distance between the axes of the winding roller J1 to J7 for the projected corner canvas G1 or G2 and the winding roller 30 or 30a for the rectangular canvas P1 or P2 is constant, however, and it is difficult to prevent the gap between the top hems 1 of the canvases after being unwound and spread from becoming great as a result, in comparison with when the respective canvases G1, G2, P1 and P2 are wound and stored.

Therefore, FIGS. 74(A) to 74(E) disclose a process through which the gap between the top hems 1 of the canvases after the two canvases G1 and P1 are spread is narrowed.

Concerning Device for Narrowing Gap Between Top Hems of Canvases

In FIGS. 74, 961 and 971 are fluctuating flaps for the projected corner canvas G1 and the rectangular canvas P1 which are respectively incorporated in the casings K1 and K2, and the axial portions 962 and 972, which are formed in the respective base portions, are supportedly inserted into the bearing portion 136 formed in a portion on the inner wall directly above the opening through which the canvas is drawn out 131 in the upper portion side casing K1, and the bearing portion 137 formed on the inner wall directly beneath the opening through which the canvas is drawn out 132 of the casing K2 on the lower portion side.

981 and 982 are plate springs in a reverse V shape for respectively pressing and supporting the fluctuating flaps 961 and 971 which are respectively sandwiched between the rear surface of the front plate of the casings K1 and K2 and the fluctuating flaps 961 and 971.

In the case of the fluctuating flap 961 for the projected corner canvas G1, from among the above, a spring is provided so that the fluctuation flap 961 is pressed against the front surface of the canvas that has been wound around the winding roller J1 to J7, and in addition, in the case of the fluctuating flap 971 for the rectangular canvas P1, a spring is provided so that the fluctuation flap 971 is pressed against the surface of the canvas that has been wound around the winding roller 30 or 30a.

991 and 992 are protrusions provided on the inner surface side in a portion close to the top hem 1 of the projected corner canvas G1 and on the inner surface side in a portion close to the top hem 5 of the rectangular canvas P1, respectively, and the remaining canvases G1 and P1 have such a positional relationship as to be exposed at the stage when pulled out, as shown in FIG. 72(C) by approximately ¼ of the length of the outer periphery of the respective winding rollers J1 to J7 and 30 or 30a. Accordingly, the front end portions of the fluctuating flaps 961 and 971 are engaged with the protrusions 991 and 992, respectively, and in addition, the fluctuating flaps 961 and 971 are pressed down or pulled up as shown in FIG. 72(D) against the pressing force of the plate springs 981 and 982 as the two canvases G1 and P1 are further drawn out.

As a result, the fluctuation flaps function so that when the canvases are pulled out and spread to the maximum, the height of the gap X shown in FIG. 72(E) is respectively narrowed in the vicinity of the opening through which the upper portion side is drawn out 131 and in the vicinity of the opening through which the lower portion side is drawn out 132, and an appropriate force for tension is applied to the two spread canvases G1 and P1.

Though in the case of the above, the fluctuating flaps 961 and 971 are engaged with the protrusions 991 and 992, the front end portions of these flaps 961 and 971 can be formed in an undulated form or an uneven form, or protrusions can be formed so as to engage with engaging holes (not shown) created at a distance from each other in locations close to the top hems of the two canvases G1 and P1.

Though a case where fluctuating flaps 961 and 971 are incorporated in top-down symmetry in the casings K1 and K2 of the two canvases G1 and P1 is described above, these may be incorporated in one of the casings K1 and K2 so as to deal with the problem.

In addition, in the case where the winding rollers J1 to J7 and 30 or 30a are incorporated in one casing K3 as shown in FIGS. 44(A) and 44(B), the fluctuating flaps 961 and 971 are pressed and supported in top-down symmetry in portions on the inner wall above and beneath the opening through which the canvas is drawn out 133, and thus, the gap between the canvases can be further narrowed.

Incidentally, though in the case of the above, a so-called inner slider structure where slider 12 or 12a which slides transversely in the direction of the axial line incorporated in the winding roller J1 to J7 for the projected corner canvas G1 or G2 is provided, the winding roller J8 in the eighth example having the same function as the inner slider structure where the configuration is simplified is described in reference to FIGS. 75 and 76.

Concerning Eighth Example of Winding Roller

In FIGS. 75(A) and 75(B), 114 is a slide guide path which is provided as a recess with a cross section in Ω form created inside the main body of the roller 11b of the winding roller J8 in the direction of the axial line. 115 is a thin cover cap having a cross section in Ω form lining the inner wall surface of the above described guide path 114 from the end of the opening of the slide guide trench 111.

12b is a slide cap which is engaged in the top hem 1 of the projected corner canvas G1 or G2, and is engaged in a movable state on the inside of the lining cover cap 115.

Thus, the slide cap 12b is engaged in the top hem 1 of the projected corner canvas G1 or G2, and an attachment wire 183 penetrates through the top hem 1 of the above described canvas so that it cannot be pulled out, and is engaged in a movable state on the inside of the cover cap 115 which lines the slide guide path 114.

Here, in the case of the above, the cover cap 115 reduces the sliding resistance when the slide cap 12b which is engaged in the top hem 1 of the canvas slides transversely, and in addition, prevents the slide guide path 114 and the slide cap 12b from making direct contact, and thus, makes it easy to slide.

As a result, the winding roller has the same function as the winding roller J1 to J7 having the above described slider 12 or 12a structure and contributes to simplification of the configuration.

Concerning Front Bar Having Moving Structure

Though in the case of the above described complex devices SQII1 to 9, the front bar F2 on the outer side is mainly formed so as to be freely slidable and guided along the front bar R2 on the inner side, the relationship between the two is replaced with the front bar having a movable structure, and thus, the sliding resistance can be greatly reduced when the front bar F2 moves forward and backward, and the smoothness of the operation can be enhanced.

The concrete means for this are disclosed in FIGS. 59(A) to 61(C) for the “complex awning device” of the above described International Patent Application 2, and the description thereof is omitted here.

Here, though according to the present invention, the outside of a building including projected corner portions and recessed corner portions is covered with complex devices in the first to forth groups so as to provide a good appearance, in the case where the linear section around the outside of the building is long, a single movable awning device Q of which the length varies for winding or unwinding a rectangular canvas P1 is incorporated, as shown in the rear half of the device in FIGS. 18(A) to 18(C).

In addition, in the case of a simple recessed corner portion or in the case where the distance between two recessed corner portions is relatively short, a single movable awning device for winding or unwinding either a recessed corner canvas in a reverse trapezoid form with right angles or a recessed corner canvas in a reverse trapezoid form is incorporated, as disclosed in FIGS. 69 and 70 showing a “complex awning device” in the above described International Patent Application 2.

Accordingly, single devices and complex devices according to the present invention can be lain out freely in accordance with the appearance of the building, and thus, the outside of various types of buildings including a projected corner portion and a recessed corner portion can be made uniform so as to provide a good design and a good appearance, and in addition, an awning system which can be freely built for a gallery can be provided in the industry.

### INDUSTRIAL APPLICABILITY

The present invention provides novel and original single type and complex type movable awning devices which are technically rich and useful, as described above, and winding rollers for projected corner canvases which form a main portion of the movable awning devices, and therefore, the appearance in the corner space portion in the projected corner portion of various types of buildings and on the outside of a building having a projected corner portion or a recessed corner portion including a space portion that can be greatly enhanced, and thus, the invention greatly contributes to progress and development in the industry.

1. A movable awning device, characterized in that
a slider 12 or 12a for allowing a spread projected corner canvas G1 or G2 to freely and transversely slide in the direction of the axial line is supportedly inserted into a winding roller J1 to J7 for winding or unwinding a projected corner canvas G1 or G2, and
a front bar F1 of said projected corner canvas G1 or G2 is supportedly inserted into a transverse guide rail R1 so that the guide rail R1 is formed so as to move in parallel by means of foldable arms V1 and V2, Y1 and Y2 or I1 and I2.

2. The movable awning device according to claim 1, wherein the projected corner canvas G1 or G2 that has been wound around the winding roller J1 to J7 is unwound so as to spread, and after that transversely slide along the winding roller J1 to J7 and the transverse guide rail R1 so as to be projected in a corner space portion.

3. The movable awning device according to claim 1, wherein the projected corner canvas G1 or G2 that has been projected in a corner space portion is transversely slid to the rear along the winding roller J1 to J7 and the transverse guide rail R1 while keeping the projected corner canvas in a spread state, and after that winding around the winding roller J1 to J7.

4. The movable awning device according to claim 1, wherein
the foldable arms are V-shaped arms V1 and V2 which have such connections so as to be freely foldable in two,
base portions of the arms V1 and V2 are attached to lower portions in the vicinity of the front end and in the vicinity of the middle of the winding roller J1 to J7, and
the front end portions of the arms are attached to portions in the vicinity of the two ends, front and rear, of the transverse guide rail R1 (S1a).

5. The movable awning device according to claim 4, wherein
a synchronizing belt 391 runs between a front end portion of the winding roller J1 to J7 and a front end portion of the transverse guide rail R1, and
the synchronizing belt 391 and the projected corner canvas G1 or G2 are wound or unwound around said winding roller J1 to J7 (S1b).

6. The movable awning device according to claim 1, wherein
the foldable arms are Y-shaped arms Y1 and Y2 which are formed in a main link 291 and a sub-link 292 linked in a reverse y shape,
front end portions of said sub-links 292 are attached to portions in the vicinity of the two ends, front and rear, of the transverse guide rail R1, and
the front end portions of the main links 291 are supported in such a manner so as to be able to freely slide along the guide rail R1 (S1c).

7. The movable awning device according to claim 4, wherein
a V-shaped arm V1 in the front end portion of the device, from among the V-shaped arms V1 and V2, is replaced with a Y-shape arm Y1 formed in a main link 291 and a sub-link 292 linked in a reverse y shape,
a front end portion of said sub-link 292 is attached to a portion in the vicinity of the front end of the traverse guide rail R1, and
a front end portion of the main link 291 is supported in such a manner as to be able to freely slide along the guide rail R1 (S1c).

8. The movable awning device according to claim 1, wherein
the foldable arms are I-shaped arms I1 and I2 in a straight line form which are formed so as to be parallel at a distance from each other,
a base portion of one I-shaped arm I1 is attached to a portion in the vicinity of the corner of a projected corner portion N1,
a front end portion of the I-shaped arm I1 is attached to a portion in the vicinity of the middle of the transverse guide rail R1,
a base portion of the other I-shaped arm I2 is attached to a portion in the vicinity of the middle at a certain distance from a portion in the vicinity of the said corner,
a front end portion of the I-shaped arm I2 is attached to a portion in the vicinity of a rear portion of the transverse guide rail R1, and
the transverse guide rail R1 is formed so as to freely move in parallel in the diagonal direction by means of the I-shaped arms I1 and I2 (S1d).

9. The movable awning device according to claim 1, wherein the front bar F1 of the projected corner canvas G1 or G2 is supportedly inserted into the transverse guide rail R1 so as to be able to freely rotate.

10. The movable awning device according to claim 9, wherein
the transverse guide rail R1 is formed on the rear surface plate portion 231 and a rail portion 232 which protrudes to the front of the rear surface plate portion, and
small wheels 234 and 235 are attached to the upper and lower portions of the rail portion 232 at a distance from each other.

11-12. (canceled)

13. A movable awning device, wherein a movable awning device Q comprising a winding roller 30 for winding or unwinding a rectangular canvas P1, a front bar 31 to which a bottom hem 6 of the rectangular canvas P1 is attached, and the foldable arms V3 and V4 which support the front bar 31 in such a manner that the front bar 31 moves in parallel, is combined with the movable awning device S1a to S1b according to claim 1, characterized in that a front half portion of the winding roller 30 for the rectangular canvas P1 overlaps with a rear half portion of the winding roller J1 to J7 for the projected corner canvas G1 or G2 at a distance from each other in an up-down direction.

14-15. (canceled)

16. A movable awning device, wherein an awning device S1 or S2 for a projected corner that is provided with a winding device for winding or unwinding a projected corner canvas G1 or G2 is combined with a rectangular awning device Q1 or Q2 having a winding device for winding or unwinding a rectangular canvas P1 or P2, characterized in that
said awning device for a projected corner S1 or S2 is provided with a winding roller J1 to J7 for the projected corner canvas G1 or G2 and a front bar F2 or F3,
a slider 12 for allowing the spread projected corner canvas G1 or G2 to be able to freely and transversely slide in the direction of the axial line is supportedly inserted into the winding roller J1 to J7,
of said rectangular awning device Q1 or Q2 is provided with a winding roller 30 or 30a for the rectangular canvas P1 or P2 and a front bar R2 or R3, and
the front bar R2 or R3 is supported by the foldable arms V1 and V2, Y1 and Y2, Z1 and Z2 or Z3 and Z4, and the front bar F2 or F3 of said projected corner canvas G1 or G2 is supportedly inserted into the front bar R2 or R3.

17. The movable awning device according to claim 16, wherein
the projected corner canvas G1 or G2 and the rectangular canvas P1 or P2 that have been wound around the winding roller J1 to J7 for the projected corner canvas G1 or G2 and the winding roller 30 or 30a for the rectangular canvas P1 or P2, respectively, are unwound in sync so as to spread, and
the spread projected corner canvas G1 or G2 is transversely slid along the winding roller J1 to J7 and the front bar R2 or R3 so as to be projected in a corner space portion.

18. The movable awning device according to claim 16, wherein the projected corner canvas G1 or G2 and the rectangular canvas P1 or P2 are wound around the respective winding rollers J1 to J7 and 30 or 30a in sync so as to be stored.

19. The movable awning device according to claim 16, wherein
a rear half portion of the winding roller J1 to J7 for the projected corner canvas G1 or G2 and a front half portion of the winding roller 30 for the rectangular canvas P1 are supported in such a manner as to overlap at a distance from each other,
the front bar R2 or R3 of the rectangular canvas P1 is formed so as to have approximately the same length as the distance between a portion in the vicinity of the front end of one winding roller J1 to J7 and a portion in the vicinity of the rear end of the other winding roller 30,
base portions of the V-shaped arm V1 and V2 have such a connection as to be freely foldable in two are attached to portions in the vicinity of the front end of said winding roller J1 to J7 and in the vicinity of the rear end of the winding roller 30, and
front end portions of the V-shaped arms V1 and V2 are attached to portions in the vicinity of the two ends, front, rear, and of said front bar R2 or R3 (SQII1·2·5).

20. The movable awning device according to claim 19, wherein
a synchronizing belt 391 runs between a front end portion of the winding roller J1 to J7 and a front end portion of the front bar R2 or R3, and
the synchronizing belt 391 and the projected corner canvas G1 or G2 are wound or unwound around said winding roller J1 to J7 (SQII2).

21. The movable awning device according to claim 19, wherein
the winding roller for the rectangular canvas P1 is a long winding roller 30a which extends from a rear portion of the device to a portion in the vicinity of the front end of the winding roller J1 to J7,
a synchronizing belt 393 runs between a front end portion of the winding roller 30a and a front end portion of the front bar R2 or R3 of the rectangular canvas P1, and
the synchronizing belt 393 is wound or unwound around a front end portion of the winding roller 30a (SQII3).

22. The movable awning device according to claim 16, wherein
the winding roller J1 to J7 for the projected corner canvas G1 or G2 and the winding roller 30a for the rectangular canvas P2 which extends to a portion in the vicinity of the front end of the winding roller J1 to J7 are supported in such a manner as to overlap at a distance from each other in the up-down direction,
the front bar R2 or R3 of the rectangular canvas P2 is formed so as to have approximately the same length as the distance between a portion in the vicinity of the front end of one winding roller J1 to J7 and a portion in the vicinity of the rear end of the other winding roller 30a,
a long rectangular canvas P2 runs between said long winding roller 30a and the front bar R2 or R3,
base portions of V-shaped arms V1 and V2 having such connections as to be freely foldable in two are attached to portions in the vicinity of the front end of said winding roller J1 to J7 and in the vicinity of the rear end of the winding roller 30a, and
front end portions of the arms V1 and V2 are attached to portions in the vicinity of the two ends, front and rear, of said front bar R2 or R3 (SQII4·SQII6 to 8).

23. The movable awning device according to claim 16, wherein
the foldable arms are Y-shaped arms Y1 and Y2 formed of a main link 291 and a sub-link 292 linked in a reverse y shape,
front end portions of said sub-links 292 are attached to portions in the vicinity of the two ends, front and rear, of the front bar R2 or R3, and
front end portions of said main links 291 are supported in such a manner as to be able to freely slide along the front bar R2 or R3 (SQII9).

24. The movable awning device according to claim 19, wherein
a V-shaped arm V1 in a front end portion of the device from among the V-shaped arms V1 and V2 is replaced with a Y-shaped arm Y1 formed of a main link 291 and a sub-link 292 linked in a reverse y shape,
front end portions of said sub-links 292 are attached to portions in the vicinity of the two ends, front and rear, of the front bar R2 or R3, and
front end portions of said main links 291 are supported in such a manner as to be able to freely slide along the front bar R2 or R3 (SQII1 to 8).

25. The movable awning device according to claim 16, wherein the foldable arms for supporting the front bar R2 or R3 of the rectangular canvas P1 or P2 are expandable arms Z1 and Z2 which rise in a vertical direction, lower the arms, or extend the arms (SQL1).

26. The movable awning device according to claim 16, wherein the foldable arms for supporting the front bar R2 or R3 of the rectangular canvas P1 or P2 are expandable links Z3 and Z4 having a pantograph structure which are pulled out to the front or pressed down to the rear (SQL2).

27. A movable awning device, wherein the rectangular awning device Q1 or Q2 according to claim 16 is replaced with an awning device U1 or U2 for a recessed corner that is provided with a winding device for winding or unwinding a recessed corner canvas P3 or P4, characterized in that
the awning device U1 or U2 for a recessed corner is provided with a winding roller 30 or 30a for a recessed corner canvas P3 or P4 and a front bar R2 or R3, and
the front bar R2 or R3 is supported in such a manner so as to be able to freely move in parallel by means of foldable arms V1 and V2 or Y1 and Y2, and the front bar F2 or F3 of the projected corner G1 or G2 is supportedly inserted onto the front bar R2 or R3.

28. The movable awning device according to claim 27, wherein
the projected corner canvas G1 or G2 and the recessed corner canvas P3 or P4 that have been respectively wound around the winding roller J1 to J7 for the projected corner canvas G1 or G2 and the winding roller 30 or 30a for the recessed corner canvas P3 or P4 are unwound in sync so as to spread, and
the spread projected corner canvas G1 or G2 is transversely slid along the winding roller J1 to J7 and the front bar R2, R3 or R5 so as to be projected in a corner space portion of a projected corner portion N1.

29. The movable awning device according to claim 27, wherein
the projected corner canvas G1 or G2 which is projected in the corner space portion of the projected corner portion N1, is transversely slid to the rear along the winding roller J1 to J7 and the front bar R2 or R3 while keeping the projected corner canvas in a spread state, and after that
the projected corner canvas G1 or G2 and the recessed corner canvas P3 or P4 are wound around the respective winding rollers J1 to J7 and 30 or 30a in sync so as to be stored.

30. The movable awning device according to claim 27, wherein
the rear half portion of the winding roller J1 to J7 for the projected corner canvas G1 or G2 and a front half portion of the winding roller 30 for a recessed corner canvas P3 are supported in such a manner so as to overlap at a distance from each other in the up-down direction,
the front bar R2 or R3 of the recessed corner canvas P3 is formed so as to have approximately the same length as the distance between a portion in the vicinity of the front end of one winding roller J1 to J7 and a portion in the vicinity of the middle of the other winding roller 30,
base portions of the V-shaped arms V1 and V2 have such connections such as to be freely foldable in two are attached to portions in the vicinity of the front end of said winding roller J1 to J7 and in the vicinity of the middle of the winding roller 30, and
front end portions of the arms V1 and V2 are attached to portions in the vicinity of the two ends, front and rear, of said front bar R2 or R3 (SUII1).

31. The movable awning device according to claim 27, wherein
the winding roller J1 to J7 for the projected corner canvas G1 or G2 and the winding roller 30a for the recessed corner canvas P4 which extends to a portion in the vicinity of the front end of the winding roller J1 to J7 are supported in such a manner as to overlap at a distance from each other in the up-down direction,
the front bar R2 or R3 of the recessed corner canvas P3 is formed so as to have approximately the same length as the distance between a portion in the vicinity of the front end of one winding roller J1 to J7 and a portion in the vicinity of the middle of the other winding roller 30a,
a long recessed corner canvas P2 runs between said winding roller 30a and the front bar R2 or R3,
base portions of the V-shaped arms V1 and V2 having such connections such as to be freely foldable in two are attached to portions in the vicinity of the front end of said winding roller J1 to J7 and in the vicinity of the middle of the winding roller 30, and
front end portions of the arms V1 and V2 are attached to portions in the vicinity of the two ends, front and rear, of said front bar R2 or R3 (SUII2).

32. A movable awning device, wherein a rectangular awning device Q1 or Q2 having a winding device for winding or unwinding a rectangular canvas P1 or P2 and two awning devices S1 or S2 and S11 for a projected corner that are provided with a winding device for winding or unwinding a projected corner canvas G1 or G2 are combined in front-rear symmetry so that the awning devices for a projected corner are located on both sides, front and rear, of the rectangular awning device, characterized in that
said awning devices S1 or S2 and S11 for a projected corner are provided with respective winding rollers J1 to J7 for the projected corner canvas G1 or G2 and front bars F2 or F3,
a slider 12 or 12a which allows the spread projected corner canvas G1 or G2 to freely and transversely slide in the direction of the axial line is supportedly inserted into the winding rollers J1 to J7,
said rectangular awning device Q1 or Q2 is provided with a winding roller 30 or 30a for a rectangular canvas P1 or P2 and a front bar R2 or R3, and
the front bar R2 or R3 is supported in such a manner as to freely move in parallel in the front-rear direction by means of foldable arms V1 Ito V4 or Y1 and Y4, and the front bar F2 or F3 of the projected corner canvas G1 or G2 is supportedly inserted into the front bar R2 or R3 in locations on both sides, front and rear, of the front bar.

33. The movable awning device according to claim 32, wherein the projected corner canvases G1 and G2 and the rectangular canvas P1 or P2 that have been wound around the winding rollers J1 to J7 for the projected corner canvases G1 and G2 and the winding roller 30 or 30a for the rectangular canvas P1 or P2, respectively, are unwound in sync so as to spread to the front, and
the spread projected corner canvases G1 and G2 are transversely slid along the winding roller J1 to J7 and the front bar R2 or R3 so as to be projected in a corner space portion of two projected corner portions N1 and N2.

34. The movable awning device according to claim 32, wherein
the projected corner canvases G1 and G2 that have been projected in the corner space portions of the two projected corner portions N1 and N2 are transversely slid to a portion in the vicinity of the center of the device along the winding roller J1 to J7 and the front bar R2 or R3 while keeping the projected canvas in a spread state, and after that
the two projected corner canvases G1 and G2 in the front and the rear and the rectangular canvas P1 or P2 are wound around the respective winding rollers J1 to J7 and 30 or 30a in sync so as to be stored.

35. The movable awning device according to claim 32, wherein
winding rollers J1 to J7 for projected corner canvases G1 and G2 are attached in a location close to the corner of one projected corner portion N1 and a location close to the corner of the other projected corner portion N2 so that the rear of the winding rollers face each other,
the two winding rollers J1 to J7 in the front and rear and a winding roller 30 or 30a for a rectangular canvas P1 or P2 are supported in such a manner as to overlap at a distance from each other,
base portions of V-shaped arms V1 to V4 having such connections as to be freely foldable in two are attached to portions in the vicinity of the front end and the middle of one winding roller J1 to J7 and in the vicinity of the middle and the rear end of the other winding roller J1 to J7, respectively, and
front end portions of the arms V1 to V4 are attached to portions corresponding to portions in the vicinity of the two ends, front and rear, of said front bar R2 or R3 and in the vicinity of the middle of said winding rollers J1 to J7 (SQSIV1·2).

36. The movable awning device according to claim 35, wherein
at least V-shaped arms V1 and V4 in the vicinity of the two ends, front and rear, from among V-shaped arms V1 to V4, are replaced with Y-shaped arms Y1 and Y4 formed of a main link 291 and a sub-link 292 linked in a reverse y shape,
front end portions of the respective sub-links 292 are attached to portions in the vicinity of the two ends, front and rear, of the front bar R2 or R3 of the rectangular canvas P1 or P2, and
front end portions of the respective main links 291 are attached to the front bar F2 or F3 of the two projected corner canvases G1 and G2 so as to be able to freely slide.

37. A movable awning device, wherein two awning devices S1 and S11 for a projected corner that is provided with a winding device for winding or unwinding a projected corner canvas G1 are combined in front-rear symmetry, characterized in that
the respective awning devices S1 and S11 for a projected corner are provided with a winding roller J1 to J7 for a projected corner canvas G1 and a front bar F2 or F3,
a slider 12 or 12a for allowing a spread projected corner canvas G1 or G2 to be able to freely and transversely slide in the direction of the axial line is supportedly inserted into the winding rollers J1 to J7,
two respective front bars F2 and F3 of said projected corner canvases G1 are supportedly inserted into a transverse guide rail R4 so as to be able to freely slide relative to the transverse guide rail, and
the guide rail R4 is formed so as to move in parallel in the front-rear direction by means of foldable arms V1 and V2 or Y1 and Y2.

38. The movable awning device according to claim 37, wherein
the projected corner canvas G1 that have been wound around the winding roller J1 to J7 are unwound in sync so as to be spread to the front, and
the spread projected corner canvases S1 are respectively slid transversely in the two directions, front and rear, along the winding rollers J1 to J7 and the transverse guide rail R4 so as to be projected in a corner space portion of the two projected corner portions N1 and N2.

39. The movable awning device according to claim 37, wherein
the projected corner canvases G1 that have been projected in the corner space portion of the two projected corner portion N1 and N2 are transversely slid in different directions along the winding rollers J1 to J7 and the transverse guide rail R4 while keeping the projected corner canvases in a spread state, and after that
wound around the respective winding rollers J1 to J7 in sync so as to be stored.

40. The movable awning device according to claim 37, wherein
the two winding rollers J1 to J7 for a projected corner canvas G1 are supported in front-rear symmetry by the two projected corner portions N1 and N2 in such a manner as to overlap at a distance from each other in the up-down direction, and
base portions of V-shaped arms V1 and V2 having such connections as to be freely foldable in two are attached to portions in the vicinity of the front end of one winding roller J1 to J7 and in the vicinity of the rear end of the other winding roller J1 to J7, and
front end portions of the arms V1 to V4 are attached to portions in the vicinity of the two ends, front and rear, of the transverse guide rail R4 (SSII).

41. A movable awning device, wherein a sliding guide trench b 111 and a sliding guide path 112 are created in the direction of the axial line of the winding roller J1 to J7 according to claim 1 and a slider 12 or 12a is supportedly inserted into the guide trench 111 and the guide path 112.

42. The movable awning device according to claim 41, wherein
a canvas engaging trench 121 to which a top hem 1 of a projected corner canvas G1 or G2 is attached is created in the central protrusion of the slider 12 or 12a having a cross section in protruding form, and
wing plate portions 123 which protrude from the two sides of the slider 12 or 12a are inserted into sidewall portions of the sliding guide path 112.

43. The movable awning device according to claim 42, wherein wing plate portions 123 with a slit trench 122 are projected from the two sides of the slider 12 or 12a,
small wheels 124 with certain intervals are combined with the slit trenches 122 in such a manner as to be able to freely rotate, and
the small wheels 124 are engaged in a rail trench 113 created in a sidewall of the sliding guide path 112.

44. A movable awning apparatus, wherein
the projected corner canvas G1 according to claim 1 is formed so as to have a spread form in a trapezoid form with approximate right angles made up of a main body portion of the canvas in rectangular form X1 and a projected portion of the canvas X2 which is projected to one side of the main body portion,
a top hem 1 of the projected corner canvas G1 is attached to a slider 12, and
a bottom hem 2 of the canvas is attached to a front bar F1 to F3.

45. (canceled)

46. A movable awning device, wherein
the projected corner canvas G2 according to claim 16 is formed so as to have a spread state in approximately triangular form,
a connection wire 541 or 542 is inserted through a diagonal portion 3a or 3b of the triangular canvas G2,
a base portion of the wire is attached to two end portions, front and rear, of a relatively short slider 12a, and
a front end portion of the wire is attached to a front bar F2 or F3 in the vicinity of the two ends, front and rear, of a bottom hem 2a of the canvas.

47. A movable awning device, wherein the slider 12 or 12a according to claim 1 is replaced with a slide cap 12b which is engaged with a top hem 1 of the projected corner canvas G1 or G2.

48. The movable awning device according to claim 47, wherein a sliding guide trench 111 and a sliding guide path 114 are created in the winding roller J8 in which a slide cap 12b is incorporated in the direction of the axial line, and a slide cap 12b is supportedly inserted in the guide trench 111 and the guide path 114.

49-50. (canceled)

51. The movable awning device according to claim 1, wherein a volume increasing member for the main body of a roller 11 is attached to the winding roller J1 to J8 of the projected corner canvas G1 or G2.

52. The movable awning device according to claim 51, wherein the volume increasing member is a volume increasing ring 331 in helix form, and the outer diameter of the ring increases step by step toward a front end portion of the roller or two end portions, front and rear, from the vicinity of the middle of the winding roller J1 to J8.

53. (canceled)

54. The movable awning device according to claim 41, wherein a manually operable device or an electrically-driven device for winding or unwinding the projected corner canvas G1 or G2 is incorporated in an end portion of the axis of the winding roller J1 into which the slider 12 or 12a is incorporated.

55. The movable awning device according to claim 41, wherein an electric power motor M1 for winding or unwinding the projected corner canvas G1 or G2 is incorporated inside the winding roller J2 into which the slider 12 or 12a is incorporated.

56. (canceled)

57. The movable awning device according to claim 41, wherein a coil spring 471 for storing or releasing elastic energy for the force of the forward and backward rotation of the winding roller J3 is incorporated inside the winding roller J3 into which the slider 12 or 12a is incorporated.

58-67. (canceled)

68. The movable awning device according to claim 1, wherein movement conveying members 561, 562 and 66 including a rope and a wire for transversely sliding the front bar F1 to F3 run between one set of foldable arms V1, Y1, I1 or Z1 and the front bar F1 to F3 of the projected corner canvas G1 or G2.

69. The movable awning device according to claim 68, wherein one of the movement conveying members 561 and 562 is for backward movement and the other for forward movement, and the movement conveying members are hung from portions in the vicinity of base portions of the foldable arms V1, Y1 and I1.

70. The movable awning device according to claim 1, wherein
a winding reel 60, 60a or 60b of the movement conveying wire 561 or 562 is incorporated into a front end portion of the winding roller J4 to J7, and
the winding reel 60, 60a or 60b rotates forward or backward, and thus, the spread projected corner canvas G1 or G2 is transversely slid.

71. The movable awning device according to claim 70, wherein
movement conveying wires 561 and 562 for backward movement and forward movement which slide the front bar F1 to F3 transversely run between one set of foldable arms V1, Y1 or I1 and the front bar F1 to F3 of the projected corner canvas G1 or G2, and
a winding reel 60, 60a or 60b which winds one of the movement conveying wires 561 and 562 and unwinds the other is assembled at a front end portion of the winding roller J4 to J7.

72. The movable awning device according to claim 70, wherein an electric motor M4 for rotating forward and backward a winding reel 60 which winds one of the movement conveying wires 561 and 562 and unwinds the other and an electric motor M1 for rotating forward and backward a winding roller J4 which winds and unwinds the projected corner canvas G1 or G2 are incorporated in the winding roller J4.

73. (canceled)

74. The movable awning device according to claim 70, wherein
one electric motor M5 or M6 or a drive axis 73 for rotating the winding roller J5 to J7 and the winding reel 60, 60a or 60b forward and backward is incorporated in the winding roller J5 to J7, and
when the movement of either said winding roller J5 to J7 or the winding reel 60, 60a or 60b is restricted from the outside, and thus the rotation is slowed down, the other winding roller J5 to J7 or the winding reel 60, 60a or 60b recoils or rotates backward.

75-76. (canceled)

77. The movable awning device according to claim 74, wherein
a sun gear 70 is engaged in the main body portion of the electric motor M6 or a drive axis 73 which is manually rotated,
an internal gear 71 is created in the winding reel 60a or 60b, and
a planetary gear 72 which engages with said sun gear 70 and the internal gear 71 is attached to a front end portion of the winding roller J6 or J7.

78-90. (canceled)

91. The movable awning device according to claim 16, wherein the winding roller J1 to J8 for the projected corner canvas G1 or G2 and the winding roller 30 or 30a for the rectangular canvas P1 or P2 or the recessed corner canvas P3 or P4 are incorporated on the upper portion side and on the lower portion side of one casing K3.

92-106. (canceled)
